(19) United States
(12) Patent Application Publication
(10) Pub. No.: US 2026/0309013 A1
(43) Pub. Date: Oct. 8, 2026

(54) METHODS AND SYSTEMS FOR PERFORMING HYDRAULIC FRACTURING OPERATIONS

(71) Applicant: ExxonMobil Technology and Engineering Company, Spring, TX (US)

(72) Inventors: Jack Tze-Yeung CHOW, Katy, TX (US); Ian Edward LANDGRAF, The Woodlands, TX (US); Steven Bruce LONNES, Spring, TX (US); Clifton Hopkins PEYTON, Montgomery, TX (US); Travis Charles-Allen BAKER, Houston, TX (US); Mei Yan LEE, Kajang (MY); Shawn Shu Jie GOH, Kuala Lumpur (MY); Jonathan Hendry VIETH, Wichita Falls, TX (US); Fuping ZHOU, Sugar Land, TX (US)

(21) Appl. No.: 19/640,148

(22) Filed: Apr. 6, 2026

Related U.S. Application Data
(60) Provisional application No. 63/784,187, filed on Apr. 6, 2025.
(60) Provisional application No. 63/784,193, filed on Apr. 6, 2025.

(51) Int. Cl. E21B 43/26; E21B 33/068; E21B 34/14; E21B 43/267

(52) U.S. Cl. CPC E21B 43/2607; E21B 33/068; E21B 34/142; E21B 43/267; E21B 2200/06

(57) ABSTRACT

A method for performing automated hydraulic fracturing operation to a subsurface formation includes providing one or more wells in the subsurface formation, each well comprising a plurality of sleeves, and providing a hydraulic fracturing system comprising a first processor. An isolation device designated for a target sleeve among the plurality of sleeves in a designated well among the one or more wells is provided to a launch location in proximity to a wellhead of the designated well. After providing the isolation device, the first processor and/or a third processor causes delivery of the isolation device into the designated well. After delivery, a fluid is pumped into the well after the isolation device, thereby conveying the isolation device to the designated sleeve in the designated well.

### CROSS-REFERENCE TO RELATED APPLICATIONS

This application claims the benefit of and priority to U.S. Provisional Patent Application No. 63/784,193, titled “Method and System for Performing Simultaneous Hydraulic Fracturing Operation,” filed Apr. 6, 2025 and U.S. Provisional Patent Application No. 63/784,187, titled “Method and System for Simultaneously Fracturing Multiple Wells,” filed Apr. 6, 2025, the contents of both of which are hereby incorporated by reference in their entirety.

### FIELD

The present disclosure relates generally to the field of hydraulic fracturing of subsurface formations. Specifically, this disclosure relates to methods and systems for performing automated hydraulic fracturing operation to a subsurface formation via one or more wells, particularly those equipped with fracturing sleeves, and more particularly using isolation devices.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Hydraulic fracturing is a stimulation treatment routinely performed on oil and gas wells in low-permeability reservoirs. Specially engineered fracturing fluids are pumped at high pressure and flow rate into a reservoir to be treated, creating fractures in the reservoir. The wings of the fracture desirably extend away from the wellbore in opposing directions according to the natural stresses within the formation. Proppant particles, such as grains of sand of a particular size, may be included in certain fracturing fluids to keep the fracture open when the treatment is complete and pressure is relieved. Hydraulic fracturing thus stimulates the reservoir, allowing hydrocarbon products to flow from the reservoir into the production casing string of the well and then to the wellhead during the production phase.

Hydraulic fracturing operations may require coordination of multiple process steps and equipment sub-systems. Managing these process steps and equipment sub-systems may be time-consuming and prone to error as conducted by conventional hydraulic fracturing technology with heavy human intervention, particularly when operations involve multiple wells or require real-time adjustments based on changing downhole conditions. Improved methods and systems for automating the control of hydraulic fracturing operations would be desirable.

### SUMMARY

A first aspect of the disclosure relates to a method for performing automated hydraulic fracturing operation to a subsurface formation. The method includes providing one or more wells in the subsurface formation, each well comprising a plurality of sleeves. The method includes providing a hydraulic fracturing system (“HFS”) comprising a first processor. The method includes providing an isolation device designated for a target sleeve among the plurality of sleeves in a designated well among the one or more wells to a launch location in proximity to a wellhead of the designated well. After providing the isolation device, the method includes causing, by the first processor and/or a third processor, delivery of the isolation device into the designated well. After delivery of the isolation device, the method includes pumping a fluid into the well after the isolation device, thereby conveying the isolation device to the designated sleeve in the designated well.

Another aspect of this disclosure relates to a method for performing automated hydraulic fracturing operation(s) to a subsurface formation. The method includes providing one or more wells in the subsurface formation, each well comprising a plurality of sleeves. The method includes providing a hydraulic fracturing system (“HFS”) comprising a first processor. After providing the HFS, the method includes causing, by the first processor, a first pressure barrier device associated with a designated well among the one or more wells to open to allow loading of an isolation device into a pressure equalization chamber associated with the designated well. After opening the first pressure barrier device, the method includes detecting, by a sensor associated with the pressure equalization chamber, the presence of the isolation device. After detecting the presence of the isolation device, the method includes causing, by the first processor, a second pressure barrier device associated with the designated well to open to launch the isolation device into the designated well.

Another aspect of this disclosure relates to a method for performing automated hydraulic fracturing operation(s) to a subsurface formation. The method includes providing one or more wells in the subsurface formation, each well comprising a plurality of sleeves. The method includes providing a hydraulic fracturing system (“HFS”) comprising a first processor. The method includes providing an isolation device designated for a target sleeve among the plurality of sleeves in a designated well among the one or more wells to a launch location in proximity to a wellhead of the designated well. After providing the isolation device, the method includes causing, by the first processor, a first pressure barrier device associated with the designated well to open to allow loading of the isolation device into a pressure equalization chamber associated with the designated well. After opening the first pressure barrier device, the method includes causing, by the first processor, the first pressure barrier device associated with the designated well to close, while maintaining a second pressure barrier device downhole of the pressure equalization chamber in closed position. The method includes equalizing a pressure in the pressure equalization chamber with a pressure in the wellhead below the second pressure barrier device. After equalizing the pressure, the method includes causing, by the first processor, the second pressure barrier device in the wellhead associated with the designated well to open to launch the isolation device into the designated well.

Another aspect of this disclosure relates to a method for performing hydraulic fracturing operation(s) to a subsurface formation via a well comprising a vertical segment, a heel downhole of the vertical segment, and a lateral segment downhole of the heel, the lateral segment comprising a plurality of sleeves. The method includes launching an isolation device into a wellhead of the well. After launching the isolation device, the method includes pumping a fluid into the wellhead at a first flow rate (“Rf-1”), thereby carrying the isolation device downhole through the vertical segment. After the isolation device passes the heel, the method includes pumping the fluid into the wellhead at a second flow rate (“Rf-2”). When the isolation device approaches a target sleeve among the plurality of sleeves, the method includes pumping the fluid into the wellhead at a third flow rate (“Rf-3”), wherein Rf-3 is less than or equal to Rf-2. The method includes engaging the isolation device with the target sleeve.

Another aspect of this disclosure relates to a method for autonomously hydraulically fracturing a subsurface formation. The method includes causing, by one or more processors, an isolation device to be retrieved and to be configured for a designated sleeve. The method includes causing, by the one or more processors, the isolation device to be launched into a well. The method includes receiving, by the one or more processors, real-time data from one or more sensors. The method includes dynamically determining, by the one or more processors, whether the real-time data fall outside of one or more thresholds. Responsive to determining that the real-time data fall outside of the one or more thresholds, the method includes dynamically changing, by the one or more processors, a ramp-rate of one or more pumps.

These and other features and attributes of the disclosed embodiments of this disclosure and their advantageous applications and/or uses will be apparent from the detailed description that follows.

### BRIEF DESCRIPTION OF FIGURES

The methods and systems of this further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A is a perspective view of a plug-and-perf fracturing configuration within a reservoir, for which embodiments of the methods and systems of this disclosure may be used;

FIG. 1B is a perspective view of a single-point-fracturing configuration within a reservoir, for which embodiments of the methods and systems of this disclosure may be used;

FIG. 2A is a schematic diagram of a fracturing system for performing hydraulic fracturing operations in a subsurface formation, in accordance with an embodiment of this disclosure;

FIG. 2B is a perspective view of a wellhead assembly configured for deploying an isolation device into a well, in accordance with an embodiment of this disclosure;

FIG. 3A is a schematic diagram of a fracturing fluid supply system configured to supply fracturing fluids to one or more wells, in accordance with an embodiment of this disclosure;

FIG. 3B is a schematic diagram of a fracturing fluid supply system configured to supply fracturing fluids to one or more wells, in accordance with an embodiment of this disclosure;

FIG. 3C is a schematic diagram of a fracturing fluid supply system configured to supply fracturing fluids to one or more wells, in accordance with an embodiment of this disclosure;

FIG. 4A is a schematic diagram of a pipe-valve system connecting fluid supply conduits to a pump inlet, in accordance with an embodiment of this disclosure;

FIG. 4B is a schematic diagram of a pipe-valve system connecting fluid supply conduits to a pump inlet using T-valves, in accordance with an embodiment of this disclosure;

FIG. 5A is a schematic diagram of an isolation device in an un-activated state, in accordance with an embodiment of this disclosure;

FIG. 5B is a schematic diagram of an isolation device in an activated state, in accordance with an embodiment of this disclosure;

FIGS. 6A-6B are cross-sectional schematic diagrams of a sleeve assembly in closed and open configurations, in accordance with an embodiment of this disclosure;

FIGS. 6C-6D are cross-sectional schematic diagrams of a sleeve assembly with an activated isolation device engaged therewith, in accordance with an embodiment of this disclosure;

FIG. 7 is a process flow diagram of a method for pumping hydraulic fracturing fluids to a designated well, in accordance with an embodiment of this disclosure;

FIG. 8 is a process flow diagram of a method for performing automated hydraulic fracturing operations with sensor detection, in accordance with an embodiment of this disclosure;

FIG. 9 is a process flow diagram of a method for performing automated hydraulic fracturing operations with pressure equalization, in accordance with an embodiment of this disclosure;

FIG. 10 is a process flow diagram of a method for performing hydraulic fracturing operations with variable flow rate control, in accordance with an embodiment of this disclosure;

FIG. 11 is a process flow diagram of a method for autonomously hydraulically fracturing a subsurface formation, in accordance with an embodiment of this disclosure;

FIG. 12 is a block diagram of a master control system, in accordance with an embodiment of this disclosure; and

FIG. 13 is a block diagram of a system for performing hydraulic fracturing operations, in accordance with an embodiment of this disclosure.

It should be noted that the figures are merely examples of this disclosure and are not intended to impose limitations on the scope of this disclosure. Further, the figures are generally not drawn to scale, but are drafted for purposes of convenience and clarity in illustrating various aspects of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The methods, devices, systems, and other features discussed below may be embodied in various different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the terms “example,” exemplary,” and “embodiment,” when used with reference to one or more components, features, structures, or methods according to this disclosure, are intended to convey that the described component, feature, structure, or method is an illustrative, non-exclusive example of components, features, structures, or methods according to this disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of this disclosure.

The term “propped fracture” (or “propped hydraulic fracture”) refers to a fracture that has been retained opened by proppant particles contained within a proppant-laden fracturing fluid.

The term “unpropped fracture” (or “unpropped hydraulic fracture”) refers to a fracture that has not been retained opened by proppant particles. In certain embodiments “unpropped fracture” and “fracture” may be used interchangeably.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include well production rates (how much water, oil, or gas is extracted over time), well injection rates (how much water or carbon dioxide is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

The term “substantially free” or “essentially free” when used with reference to a component of a composition, interchangeably means that the composition comprises the component at a concentration of ≤10 wt %, ≤5 wt %, ≤3 wt %, ≤1 wt %, or 0 wt %, based on the total weight of the composition, depending on the details of the particular implementation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, a “pad” refers to the area surrounding a well including pump equipment and other devices used to perform hydraulic fracturing.

As used herein, “downhole” means closer to the toe of the production casing string. “Downhole direction” means a direction toward the toe of the production casing string. Thus, a location in the production casing string downhole to a sleeve means a location in the production casing string closer to the toe of the production casing string relative to the sleeve. The production casing string downhole to a sleeve means the segment of the production casing string closer to the toe of the production casing string relative to the sleeve downstream of the sleeve in the downhole direction.

As used herein, “uphole” means farther away from the toe of the production casing string. “uphole direction” means a direction away from the toe of the production casing string. Thus, a location in the production casing string uphole to a sleeve means a location in the production casing string farther to the toe of the production casing string relative to the sleeve. The production casing string uphole to a sleeve means the segment of the production casing string that is farther to the toe of the production casing string relative to the sleeve downstream of the sleeve in the uphole direction.

As used herein, a “processor,” such as a “first processor,” a “second processor,” a “third processor,” a “fourth processor,” a “fifth processor,” and the like, may be a single processing device in a single computer, multiple processing devices operating in a coordinated fashion within a single computer, or multiple processing devices distributed across multiple computers and operating in a coordinated fashion. Non-limiting examples of processors include a central processing unit (“CPU”), a graphics processing unit (“GPU”), a microprocessor, a microcontroller, a digital signal processor (“DSP”), a field-programmable gate array (“FPGA”), an application-specific integrated circuit (“ASIC”), a system-on-a-chip (“SoC”), a reduced instruction set computer (“RISC”) processor, a complex instruction set computer (“CISC”) processor, a tensor processing unit (“TPU”), a neural processing unit (“NPU”), and any combination thereof. A processor may execute instructions stored in memory, firmware, or other computer-readable media. A processor may be located in an enclosure of a computer, in a room or facility housing one or more computers, in multiple facilities housing multiple computers, or in a computing network such as a cloud computing environment. A processor may be part of a server, a workstation, a desktop computer, a laptop computer, a tablet computer, a smartphone, an embedded system, a programmable logic controller (“PLC”), an edge computing device, or any other type of computing device. In some cases, a processor may be a virtual processor executing within a virtual machine or a cloud computing environment. In some cases, two or more processors referenced herein may be implemented on the same physical hardware, on separate physical hardware, or on a combination thereof. In some cases, a single physical processor may implement the functions of two or more processors referenced herein through time-sharing, multi-threading, or virtualization. In some cases, a processor may communicate with other processors or devices via wired connections, wireless connections, or a combination thereof, including communication via local area networks, wide area networks, the Internet, or other communication networks.

As used herein, the term “memory” refers to one or more data storage devices or components capable of storing data, instructions, or other information for access by a processor or other computing components. Memory may be volatile or non-volatile. Volatile memory loses its stored data when power is removed, while non-volatile memory retains its stored data even when power is removed. Non-limiting examples of volatile memory include random access memory (“RAM”), dynamic random access memory (“DRAM”), static random access memory (“SRAM”), and synchronous dynamic random access memory (“SDRAM”). Non-limiting examples of non-volatile memory include read-only memory (“ROM”), programmable read-only memory (“PROM”), erasable programmable read-only memory (“EPROM”), electrically erasable programmable read-only memory (“EEPROM”), flash memory, solid-state drives (“SSD”), hard disk drives (“HDD”), magnetic tape, optical discs, and any combination thereof. Memory may also include cache memory, registers, or other high-speed storage closely associated with a processor. In some cases, memory may be integrated within a processor or located on a separate chip or module. In some cases, memory may be distributed across multiple physical devices or locations, including local storage, network-attached storage, or cloud-based storage. Memory may store operating systems, application programs, data files, configuration parameters, or any other type of digital information. In some cases, two or more memories referenced herein may be implemented on the same physical hardware, on separate physical hardware, or on a combination thereof.

In this disclosure, a method is described as comprising at least one “step.” It should be understood that each step is an action or operation that may be carried out once or multiple times in the method, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

If there is any conflict in the usages of a word or term in this specification and one or more patent or other documents that may be incorporated herein by reference, the definitions that are consistent with this specification should be adopted for the purposes of understanding this disclosure.

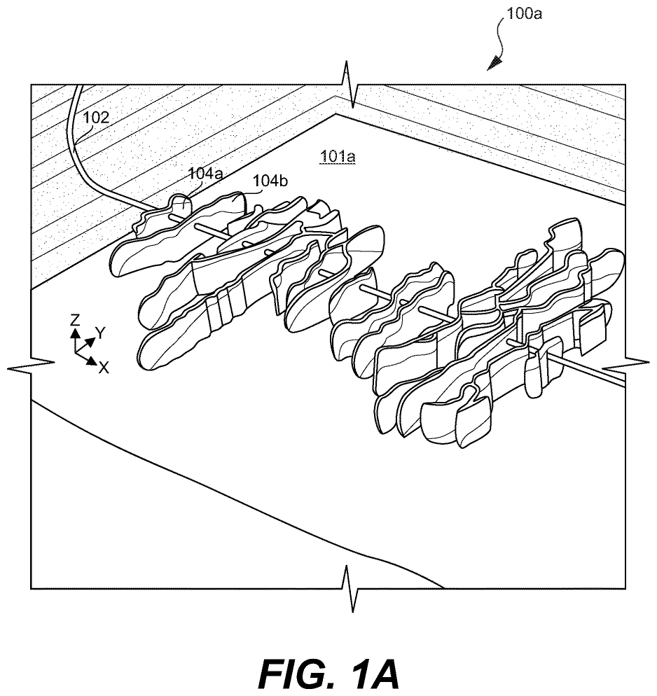

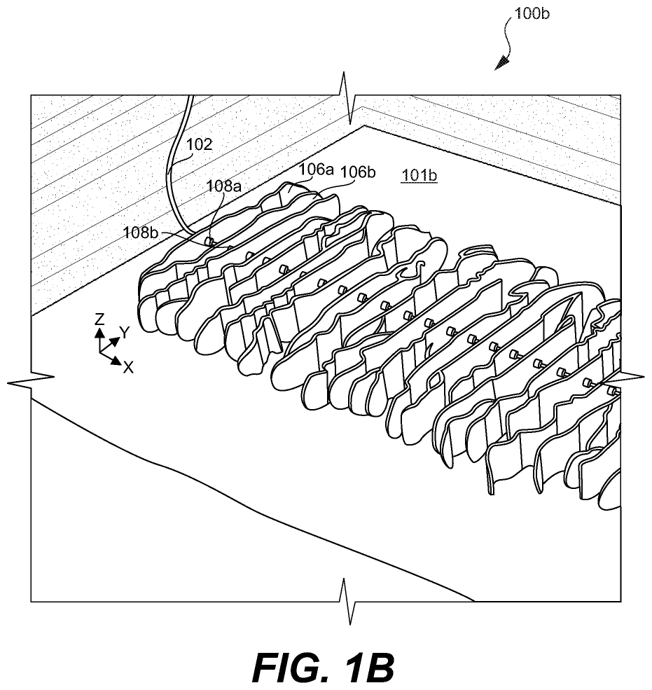

Referring to FIG. 1A, a plug-and-perf fracturing configuration 100a is shown positioned within a first reservoir 101a. The plug-and-perf fracturing configuration 100a includes a wellbore casing 102 extending through a subsurface formation. The wellbore casing 102 is positioned within the first reservoir 101a, which may include layered geological strata. A first fracture 104a and a second fracture 104b extend outward from the wellbore casing 102 into the surrounding formation. The first fracture 104a and the second fracture 104b propagate away from the wellbore casing 102 in opposing directions and along the X-axis, Y-axis, and Z-axis. The first fracture 104a is positioned uphole relative to the second fracture 104b along the wellbore casing 102. In the plug-and-perf fracturing configuration 100a, the first fracture 104a and the second fracture 104b may exhibit irregular, branching structures that extend into the first reservoir 101a. In some cases, the irregular fractures 104a and 104b may leave portions of the first reservoir 101a inaccessible for hydrocarbon recovery because the fractures 104a and 104b do not extend to those portions.

With reference to FIG. 1B, a single-point-fracturing configuration 100b is shown positioned within a second reservoir 101b. The single-point-fracturing configuration 100b includes a wellbore casing 102 extending through the subsurface formation. The wellbore casing 102 houses a plurality of sleeves, including a first sleeve 108a and a second sleeve 108b, positioned along a lateral section of the wellbore. The first sleeve 108a and the second sleeve 108b may be opened to allow fracturing fluid to enter the surrounding reservoir formation. A third fracture 106a and a fourth fracture 106b extend outward from the wellbore casing 102 into the second reservoir 101b in opposing directions and along the X-axis, Y-axis, and Z-axis. The third fracture 106a is associated with the first sleeve 108a, and the fourth fracture 106b is associated with the second sleeve 108b. The third fracture 106a and the fourth fracture 106b propagate through the formation according to natural stresses within the second reservoir 101b.

As further shown in FIG. 1B, the single-point-fracturing configuration 100b enables targeted stimulation of specific zones within the second reservoir 101b through sequential or selective opening of sleeves 108a, 108b, 108c, 108d, 108e along the wellbore casing 102. In some cases, the third fracture 106a and the fourth fracture 106b may exhibit longer, more regular fracture geometries compared to the first fracture 104a and the second fracture 104b of the plug-and-perf fracturing configuration 100a shown in FIG. 1A. The longer, more regular fractures 106a and 106b may extend to more portions of the second reservoir 101b than the irregular fractures 104a and 104b extend to within the first reservoir 101a. In some cases, the single-point-fracturing configuration 100b may enable greater hydrocarbon production from the second reservoir 101b compared to the plug-and-perf fracturing configuration 100a from the first reservoir 101a.

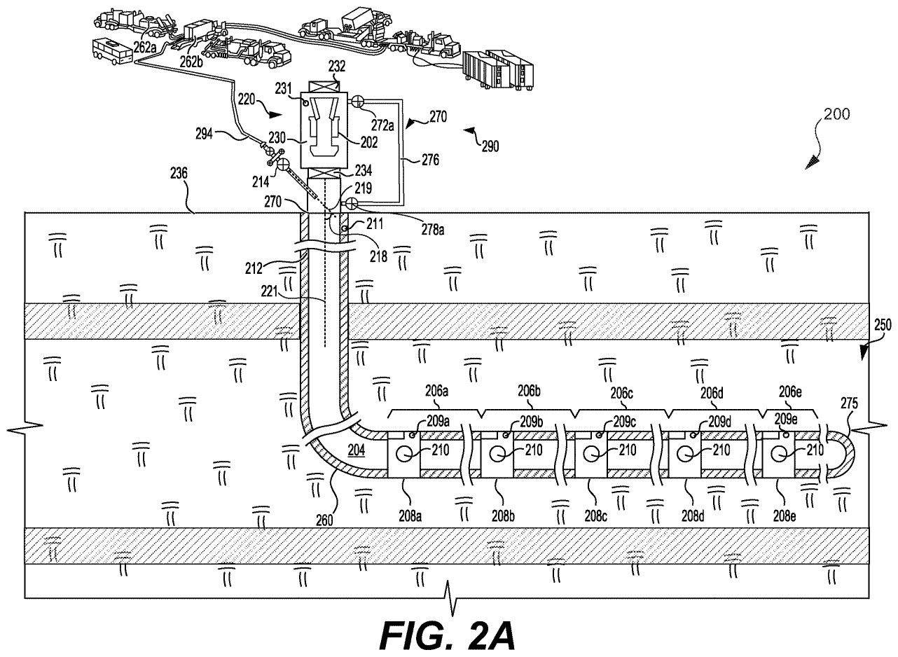

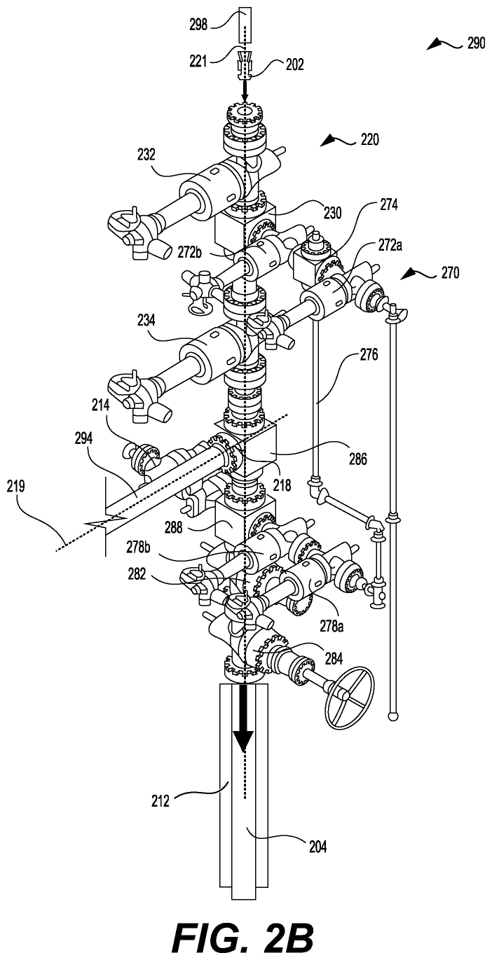

Referring to FIG. 2A, a fracturing system 200 (e.g., a single point fracturing system) for performing hydraulic fracturing operations in a subsurface formation is shown. The fracturing system 200 includes an isolation device 202 that may be deployed into a well 204 extending from a surface 236 into a reservoir 250. The well 204 includes a casing 212 that lines the wellbore and provides structural integrity to the well 204.

The well 204 transitions from a vertical orientation near the surface 236 to a lateral orientation through a heel 260, extending toward a toe 275 at a distal end of the lateral section. The lateral section of the well 204 is divided into multiple stages including a first stage 206a, a second stage 206b, a third stage 206c, a fourth stage 206d, and a fifth stage 206e. Each stage corresponds to a respective sleeve positioned along the casing 212, including a first sleeve 208a, a second sleeve 208b, a third sleeve 208c, a fourth sleeve 208d, and a fifth sleeve 208e. Each sleeve includes a fracturing fluid port 210 that, when opened, allows fracturing fluid to be injected into the reservoir 250.

With continued reference to FIG. 2A, the fracturing system 200 (which can be a single point fracturing system) includes sensors positioned along the lateral section of the well 204. A first sensor 209a is associated with the first stage 206a, a second sensor 209b is associated with the second stage 206b, a third sensor 209c is associated with the third stage 206c, a fourth sensor 209d is associated with the fourth stage 206d, and a fifth sensor 209e is associated with the fifth stage 206e. The first sensor 209a, the second sensor 209b, the third sensor 209c, the fourth sensor 209d, and the fifth sensor 209e may provide data regarding conditions within the respective stages during hydraulic fracturing operations. In some cases, the sensors 209a-209e may include pressure sensors, optical sensors, acoustic sensors, radio frequency sensor, optical sensor, temperature sensors, or combinations thereof.

At the surface 236, the fracturing system 200 includes surface equipment for controlling the fracturing operation. A fracturing fluid valve 214 controls the flow of fracturing fluid into the well 204. An isolation device delivery device 220 is positioned at a wellhead assembly 290 to facilitate deployment of the isolation device 202 into the well 204. A pump 262a and a pump 262b are provided to supply fracturing fluid and other fluids to the well 204 at controlled flow rates and pressures.

As further shown in FIG. 2A, the wellhead assembly 290 includes a pressure equalization system 270 comprising a pressure equalization chamber 230 positioned between a first pressure barrier device 232 and a second pressure barrier device 234. The first pressure barrier device 232, the second pressure barrier device, or both may each include a gate valve, a ball valve, a flapper valve, a blind ram barrier, a shear ram barrier, or a pressure barrier component (e.g., a screw conveyor or a hydraulic push rod driven conveyor) inside an isolation conveyor apparatus used to inject the isolation device into the well, a sealable and un-sealable pressure barrier chamber enclosure (e.g., a lubricator or side-entry access pressure vessel). In some embodiments, the first pressure barrier device 232 may include an upper crown valve and the second pressure barrier device 234 may include a lower crown valve. In some embodiments, the first pressure barrier device 232, the second pressure barrier device 234, or both are free of an actuator, and opens with force from a passing isolation device 202 and closes via spring tension and/or well pressure/flow. In other words, the first pressure barrier device 232, the second pressure barrier device 234, or both may include a spring-loaded flapper valve.

A chamber sensor 231 is associated with the pressure equalization chamber 230 and may be configured to detect the presence of the isolation device 202 within the pressure equalization chamber 230 or conditions preceding launch of the isolation device 202. In some cases, the chamber sensor 231 may employ magnetic sensor technology, laser adapted sensor technology, radioactive marker technology, mechanical technology, acoustic sensor technology, radio frequency sensor, optical sensor, or combinations thereof to detect the presence of the isolation device 202. The first pressure barrier device 232 may open to allow loading of the isolation device 202 into the pressure equalization chamber 230. After the first pressure barrier device 232 closes and pressure is equalized within the pressure equalization chamber 230, the second pressure barrier device 234 may open to launch the isolation device 202 into the well 204 downhole. The pressure equalization system 270 further includes a valve 272a and a valve 278a positioned within the pressure equalization system 270 to control fluid flow and pressure conditions during isolation device deployment operations. A pressure equalization pipe 276 is connected to the pressure equalization system 270 to facilitate pressure equalization operations.

A vertical sensor 211 is positioned in a vertical segment of the well 204 between the surface 236 and the heel 260. The vertical sensor 211 may monitor conditions within the vertical segment as the isolation device 202 traverses downhole. In some cases, one or more vertical sensors 211 may include pressure sensors, optical sensors, acoustic sensors, temperature sensors, or combinations thereof.

With continued reference to FIG. 2A, the fracturing system 200 includes a fluid inlet configuration where fluid is pumped into the wellhead assembly 290 through a fluid inlet pipe 294 having a fluid inlet pipe axis 219. The fluid inlet pipe axis 219 intersects with a wellhead pipe axis 221 below the second pressure barrier device 234 to form an angle (Θ) 218. In some cases, the angle 218 may range from 15° to 75° (e.g., 15°, 20°, 25°, 30°, 35°, 40°, 45°, 50°, 55°, 60°, 65°, 70°, 75°, preferably from 30° to 60°, more preferably about 45°). The angular configuration of the fluid inlet pipe axis 219 relative to the wellhead pipe axis 221 may facilitate the flow of fluid into the wellhead assembly 290 and may assist in conveying the isolation device 202 downhole. A fracturing fluid valve 214 is positioned along the fluid inlet pipe 294 to control the flow of fracturing fluid into the well 204.

The isolation device 202 may be pumped downhole through the casing 212, past the heel 260, and through the lateral section toward a target sleeve where the isolation device 202 engages with a designated sleeve to open the corresponding fracturing fluid port 210 for fracturing operations in the reservoir 250. In some cases, the isolation device 202 may be programmed to pair with a target sleeve (e.g., sleeve 206e) before arriving at the wellhead assembly 290, at the wellhead assembly 290, or after entering the wellhead assembly 290.

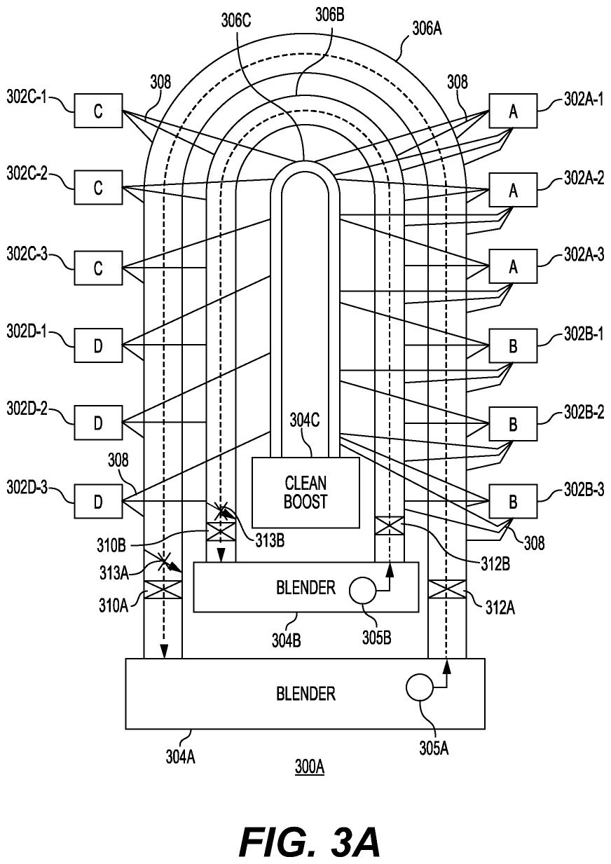

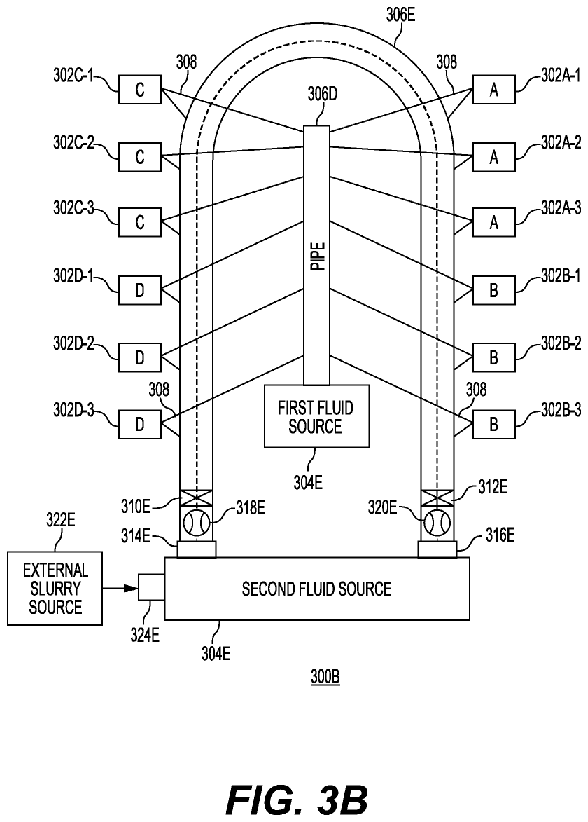

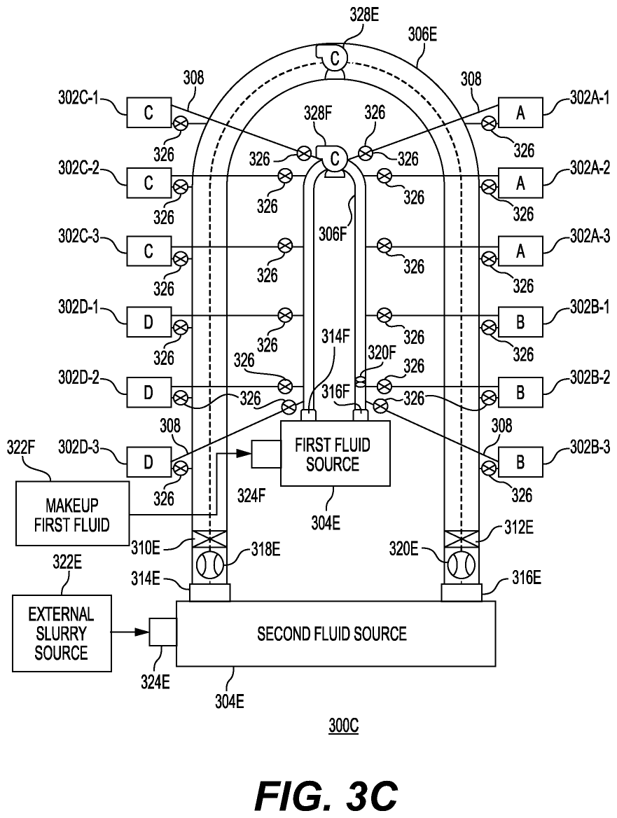

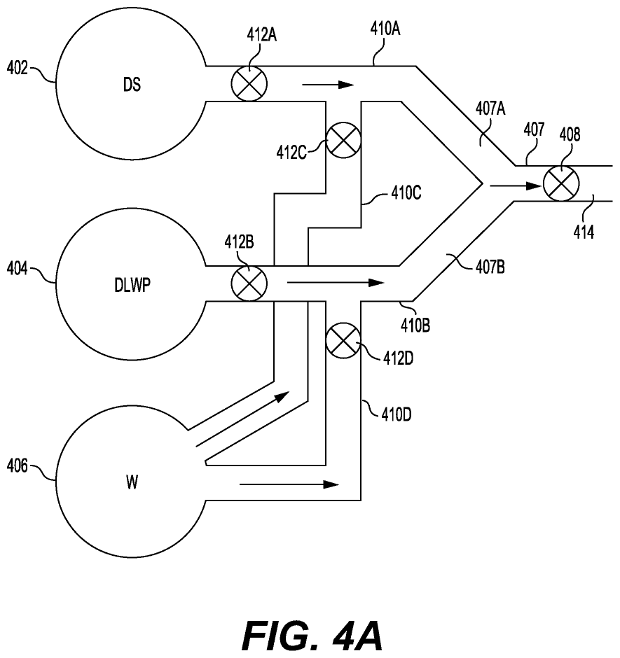

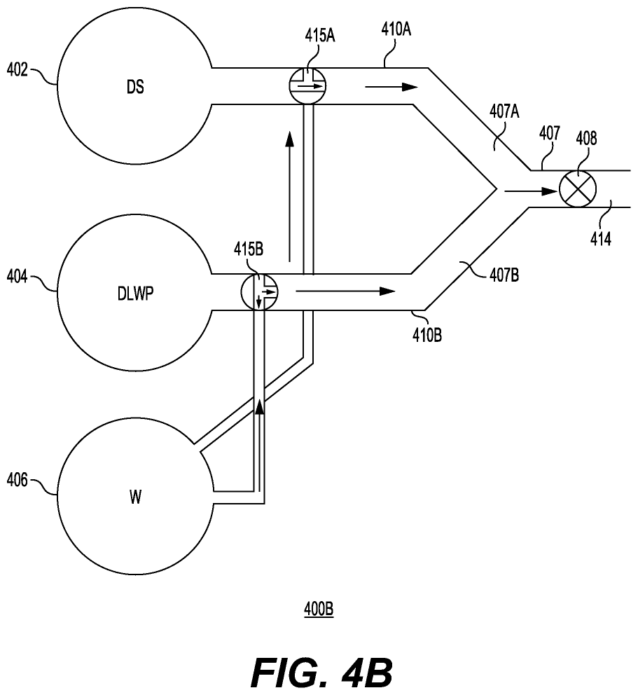

The fracturing system 200 shown in FIG. 2A may be supplied with fracturing fluids from a fracturing fluid supply system as described with reference to FIGS. 3A-3C and FIGS. 4A-4B. The pump 262a and the pump 262b shown in FIG. 2A may receive fracturing fluids from one or more fluid cycling conduits and fluid supply conduits as described in FIGS. 3A-3C. The pipe-valve systems shown in FIGS. 4A and 4B may connect the fluid cycling conduits to pump inlets of the pump 262a and the pump 262b, enabling selective supply of different fracturing fluids to the well 204. In some cases, the fracturing fluid supply systems 300A, 300B, and 300C may supply clean fluids substantially free of proppant particles, slurried fluids comprising sand proppant particulates, slurried fluids comprising lightweight proppant particulates, or combinations thereof to the fracturing system 200 for injection into the reservoir 250 through the fracturing fluid port 210 of a designated sleeve.

Referring to FIG. 2B, a perspective view of a wellhead assembly 290 configured for deploying an isolation device 202 into a well 204 is shown. The wellhead assembly 290 includes a pressure equalization system 270 positioned at an upper portion of the wellhead assembly 290.

The pressure equalization system 270 includes a optional lubricator 298 positioned at a top of the wellhead assembly 290. The lubricator 298 may be attachable and detachable to a valve assembly before a first pressure barrier device 232, or the lubricator 298 may be connected permanently to the valve assembly and/or to an isolation device delivery device 220. Below the lubricator 298, an isolation device delivery device 220 may be configured to receive and position the isolation device 202 for deployment into the well 204. The first pressure barrier device 232 may be positioned below the isolation device delivery device 220 to control access to a pressure equalization chamber 230. The pressure equalization chamber 230 may be located between the first pressure barrier device 232 and a second pressure barrier device 234. The first pressure barrier device 232 may open to allow loading of the isolation device 202 into the pressure equalization chamber 230, and the second pressure barrier device 234 may open to launch the isolation device 202 into the well 204 after pressure equalization.

With continued reference to FIG. 2B, the pressure equalization chamber 230 may serve to equalize pressure before launching the isolation device 202. In some cases, pressure equalization in the pressure equalization chamber 230 may include increasing pressure to equal a pressure below the second pressure barrier device 234 after the isolation device 202 enters the pressure equalization chamber 230 and the first pressure barrier device 232 closes. In some cases, pressure equalization may include bleeding off pressure in the pressure equalization chamber 230 after the isolation device 202 has descended through the second pressure barrier device 234 into wellhead piping and the second pressure barrier device 234 closes, after which the first pressure barrier device 232 may open to receive a next isolation device into the pressure equalization chamber 230.

As further shown in FIG. 2B, at least one of the first pressure barrier device 232 and the second pressure barrier device 234 may be actuated by one or more actuators. In some cases, the actuators of the first pressure barrier device 232 and the second pressure barrier device 234 may be remotely controllable electrically and/or hydraulically. The first pressure barrier device 232, the second pressure barrier device 234, the pressure equalization chamber 230, and associated piping may include one or more sensors (e.g., sensor 231) for sensing pressure, temperature, flow rate, presence or absence of the isolation device 202, or combinations thereof.

Referring to FIG. 2B, the wellhead assembly 290 includes a valve 272a positioned below the second pressure barrier device 234. A pipe converter 274 may be connected below the valve 272a, transitioning a flow path configuration. A valve 272b may be positioned adjacent to the pipe converter 274. The wellhead assembly 290 may further include a valve 278a and a valve 278b positioned on opposite sides of the wellhead assembly 290, providing additional flow control capabilities.

With continued reference to FIG. 2B, a fluid inlet pipe 294 extends laterally from the wellhead assembly 290 and connects to the wellhead assembly 290 via a fluid inlet pipe connection 286. The fluid inlet pipe 294 has a fluid inlet pipe axis 219 that intersects with a wellhead pipe axis 221 to form an angle 218. In some cases, the angle 218 may be perpendicular. In some cases, the angle 218 may range from 15° to 120° (e.g., 15°, 20°, 25°, 30°, 35°, 40°, 45°, 50°, 55°, 60°, 65°, 70°, 75°, 85°, 90°, 95°, 100°, 105°, 110°, 115°, 120°). In some cases, the angle 218 may range from 15° to 75° or 30° to 60°. In some cases, the angle 218 may be about 45°.

As further shown in FIG. 2B, while a perpendicular arrangement of the fluid inlet pipe 294 relative to the wellhead pipe axis 221 may be used when a flow rate of fracturing fluid is relatively low, at a high flow rate, the isolation device 202 passing through wellhead piping adjacent to an end of the fluid inlet pipe 294 may be subject to overly high impact from incoming fracturing fluid. In some cases, high impact from incoming fracturing fluid may damage the isolation device 202, particularly sensitive components therein such as electronic devices housed inside the isolation device 202. To reduce such undesirable impact, the fluid inlet pipe 294 may be configured to form the angle 218 from 15° to 75° between the fluid inlet pipe axis 219 and the wellhead pipe axis 221.

Referring to FIG. 2B, a fracturing fluid valve 214 may be positioned along the fluid inlet pipe 294 to control flow of fracturing fluid into the well 204. A lateral pipe connection 288 may extend from the wellhead assembly 290 in a direction opposite to the fluid inlet pipe 294.

With continued reference to FIG. 2B, the wellhead assembly 290 includes a pressure equalization pipe 276 extending from the pressure equalization system 270. A valve 282 may be positioned along the pressure equalization pipe 276 to control pressure equalization operations. A valve 284 may be positioned on a vertical support structure extending from the wellhead assembly 290.

As further shown in FIG. 2B, a casing 212 extends downward from the wellhead assembly 290 into the well 204. The casing 212 provides structural integrity to the well 204 and defines a flow path for the isolation device 202 and fracturing fluids to travel downhole toward designated sleeves within the well 204. The casing 212 may be connected to the wellhead assembly 290 below the valve 272a and the pipe converter 274, establishing fluid communication between the surface equipment of the wellhead assembly 290 and the downhole components of the well 204.

Referring to FIG. 3A, a fracturing fluid supply system 300A configured to supply three different fracturing fluids to one or more wells is shown. The fracturing fluid supply system 300A includes four groups of pumps arranged on left and right sides of the system. A first pump group on the right side comprises a pump 302A-1, a pump 302A-2, and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

The fracturing fluid supply system 300A includes three fluid sources. A LWP blender 304A is positioned at a bottom left portion of the fracturing fluid supply system 300A and supplies a third fracturing fluid comprising lightweight proppant (“LWP”) particulates to a third fluid cycling conduit 306A. A dirty blender 304B is positioned at a bottom center portion of the fracturing fluid supply system 300A and supplies a second fracturing fluid comprising sand proppant particulates to a second fluid cycling conduit 306B. A clean boost tank 304C is positioned at a center portion of the fracturing fluid supply system 300A and supplies a first fracturing fluid to a first fluid cycling conduit 306C. In some cases, the first fracturing fluid may be substantially free of proppant particles. In some cases, the first fracturing fluid may include water, produced water, treated produced water, slickwater, or combinations thereof. In some cases, the first fracturing fluid may include additives such as a biocide, a scale inhibitor, a viscosity modifier, a friction reducer, or combinations thereof.

With continued reference to FIG. 3A, the LWP blender 304A includes a pump 305A, and the dirty blender 304B includes a pump 305B for supplying the respective fluids into the respective fluid cycling conduits. The third fluid cycling conduit 306A forms an outermost loop connecting to the LWP blender 304A. The second fluid cycling conduit 306B forms a middle loop connecting to the dirty blender 304B. The first fluid cycling conduit 306C forms an innermost loop connecting to the clean boost tank 304C. Each of the third fluid cycling conduit 306A, the second fluid cycling conduit 306B, and the first fluid cycling conduit 306C is fluidly connected with the pump groups 302A, 302B, 302C, and 302D via the piping 308.

As further shown in FIG. 3A, the fracturing fluid supply system 300A includes instrumentation for monitoring fluid properties. An input densometer 310A is associated with the third fluid cycling conduit 306A and is located in proximity to a fluid inlet of the LWP blender 304A to measure a density of fluids returning to the LWP blender 304A. An input densometer 310B is associated with the second fluid cycling conduit 306B and is located in proximity to a fluid inlet of the dirty blender 304B to measure a density of fluids returning to the dirty blender 304B. An output densometer 312A is associated with the third fluid cycling conduit 306A and is located in proximity to a fluid outlet of the LWP blender 304A to measure a density of fluids entering the third fluid cycling conduit 306A. An output densometer 312B is associated with the second fluid cycling conduit 306B and is located in proximity to a fluid outlet of the dirty blender 304B to measure a density of fluids entering the second fluid cycling conduit 306B.

Referring to FIG. 3A, the fracturing fluid supply system 300A further includes a pressure regulator 313A positioned upstream of the input densometer 310A and downstream of the piping 308 from the fourth pump group. A pressure regulator 313B is positioned upstream of the input densometer 310B and downstream of the piping 308 from the fourth pump group. The pressure regulator 313A and the pressure regulator 313B may maintain pressures in the fluid cycling conduits within desirable ranges to feed a suction side of each of the pump groups 302A, 302B, 302C, and 302D. In some cases, the pressure regulator 313A and the pressure regulator 313B may be choke valves. In some cases, the pressure regulator 313A and the pressure regulator 313B may be adjustable choke valves that open and close based on a feedback loop of an automation system controlled by a controller.

With continued reference to FIG. 3A, the fluid cycling conduits 306A, 306B, and 306C may continuously supply each of the different fluids on a low-pressure side of the fracturing fluid supply system 300A to feed pump inlets of the pumps in the pump groups 302A, 302B, 302C, and 302D through valves. In some cases, the valves may be remotely switchable valves. The continuous flow of fluids comprising proppant particles may maintain a substantially homogeneous distribution of proppant particles in the fracturing fluids along a length of the fluid cycling conduits, preventing the proppant particles from settling out and clogging the conduits, valves, and meters.

As further shown in FIG. 3A, the measured densities by the input densometer 310A, the input densometer 310B, the output densometer 312A, and the output densometer 312B may be used by a controller to control an amount and/or a flow rate of various materials to be supplied into the LWP blender 304A and the dirty blender 304B. In some cases, the LWP blender 304A or the dirty blender 304B may mix a slurry to a pre-prescribed density as designed. In some cases, the pre-prescribed density may follow a continuous concentration principle. Based on readings from the input densometer 310A and the input densometer 310B, a supply of proppant particles and/or precursor fluids to the LWP blender 304A and the dirty blender 304B may be adjusted to ensure that a density of the fluid at a blender outlet stays substantially constant.

Referring to FIG. 3B, a fracturing fluid supply system 300B configured to supply fracturing fluids to one or more wells is shown. The fracturing fluid supply system 300B includes four groups of pumps arranged on left and right sides of the system. A first pump group on the right side comprises a pump 302A-1 and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

With continued reference to FIG. 3B, the fracturing fluid supply system 300B includes a first fluid supply subsystem comprising a first fluid supply conduit 306D positioned in a center portion of the fracturing fluid supply system 300B. The first fluid supply conduit 306D is fluidly connected with the piping 308 to supply a first fluid to the pump groups. In some cases, the first fluid from the first fluid supply conduit 306D may be substantially free of proppant particles.

As further shown in FIG. 3B, the fracturing fluid supply system 300B further includes a second fluid supply subsystem comprising a second fluid source 304E positioned at a bottom portion of the fracturing fluid supply system 300B. The second fluid source 304E is in fluid communication with a second fluid cycling conduit 306E via a second fluid inlet 314E and a second fluid outlet 316E. The second fluid inlet 314E and the second fluid outlet 316E are in fluid communication with the second fluid cycling conduit 306E forming a second fluid supply loop. The second fluid outlet 316E is configured to supply a second fluid to the second fluid cycling conduit 306E. The second fluid inlet 314E is configured to receive a returning second fluid from the second fluid cycling conduit 306E.

Referring to FIG. 3B, the fracturing fluid supply system 300B includes instrumentation for monitoring fluid properties. A first density meter 310E is associated with the second fluid cycling conduit 306E and is located in proximity to the second fluid inlet 314E to measure a density or flow rate of the returning second fluid entering the second fluid inlet 314E. A flow meter 318E is positioned upstream of the first density meter 310E to measure a flow rate of the returning second fluid. A second density meter 312E is associated with the second fluid cycling conduit 306E and is located in proximity to the second fluid outlet 316E to measure a density or flow rate of the second fluid exiting the second fluid outlet 316E. A flow rate meter 320E is positioned upstream of the second density meter 312E to measure a flow rate of the second fluid exiting the second fluid outlet 316E.

With continued reference to FIG. 3B, the second fluid source 304E is connected to an external slurry source 322E via a precursor second fluid inlet 324E. The external slurry source 322E may supply a precursor second fluid to the second fluid source 304E. In some cases, the precursor second fluid may be a slurry received from the external slurry source 322E. In some cases, the precursor second fluid may be a carrier fluid such as water, produced water, treated produced water, slickwater, with or without additional additives such as a scale inhibitor, a viscosity modifier, a biocide, a friction reducer, or combinations thereof. The second fluid source 304E may comprise a vessel configured to receive the precursor second fluid and blend materials to form a second fluid with a desirable composition and proppant particle distribution exiting the second fluid outlet 316E. In some cases, the second fluid source 304E may comprise a vessel and a stirrer inside the vessel, which during operation agitates materials inside the vessel to obtain a second fluid with a desirable composition and a substantially homogeneous distribution of proppant particles.

Referring to FIG. 3C, a fracturing fluid supply system 300C configured to supply two different fracturing fluids to one or more wells is shown. The fracturing fluid supply system 300C includes four groups of pumps arranged on left and right sides of the system. A first pump group on the right side comprises a pump 302A-1, a pump 302A-2, and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

With continued reference to FIG. 3C, the fracturing fluid supply system 300C includes a first fluid supply subsystem comprising a first fluid source 304F positioned at a bottom left portion of the fracturing fluid supply system 300C. The first fluid source 304F is in fluid communication with a first fluid cycling conduit 306F via a first fluid inlet 314F and a first fluid outlet 316F. The first fluid inlet 314F and the first fluid outlet 316F are in fluid communication with the first fluid cycling conduit 306F forming a first fluid supply loop. The first fluid outlet 316F is configured to supply a first fluid to the first fluid cycling conduit 306F. The first fluid inlet 314F is configured to receive a returning first fluid from the first fluid cycling conduit 306F. The first fluid source 304F receives makeup first fluid 322F via a precursor first fluid inlet 324F.

As further shown in FIG. 3C, the fracturing fluid supply system 300C further includes a second fluid supply subsystem comprising a second fluid source 304E positioned at a bottom center portion of the fracturing fluid supply system 300C. The second fluid source 304E is in fluid communication with a second fluid cycling conduit 306E via a second fluid inlet 314E and a second fluid outlet 316E. The second fluid inlet 314E and the second fluid outlet 316E are in fluid communication with the second fluid cycling conduit 306E forming a second fluid supply loop. The second fluid outlet 316E is configured to supply a second fluid to the second fluid cycling conduit 306E. The second fluid inlet 314E is configured to receive a returning second fluid from the second fluid cycling conduit 306E. The second fluid source 304E is connected to an external slurry source 322E via a precursor second fluid inlet 324E.

Referring to FIG. 3C, the fracturing fluid supply system 300C includes instrumentation for monitoring fluid properties. A first density meter 310E is associated with the second fluid cycling conduit 306E and is located in proximity to the second fluid inlet 314E to measure a density or flow rate of the returning second fluid entering the second fluid inlet 314E. A flow meter 318E is positioned to measure a flow rate of the returning second fluid. A second density meter 312E is associated with the second fluid cycling conduit 306E and is located in proximity to the second fluid outlet 316E to measure a density or flow rate of the second fluid exiting the second fluid outlet 316E. A flow rate meter 320E is positioned to measure a flow rate of the second fluid exiting the second fluid outlet 316E. A flow rate meter 320F is associated with the first fluid cycling conduit 306F.

With continued reference to FIG. 3C, the fracturing fluid supply system 300C includes valves 326 positioned at the piping 308 between the pump groups and the first fluid cycling conduit 306F and the second fluid cycling conduit 306E. The second fluid cycling conduit 306E is fluidly connected with each of the valves 326 for the second fluid. The first fluid cycling conduit 306F is fluidly connected with each of the valves 326 for the first fluid. The valves 326 are switchable between an open position and a closed position to selectively supply the fracturing fluids to pump inlets of designated pumps.

As further shown in FIG. 3C, a fluid cycling conduit 328E extends from the second fluid cycling conduit 306E and connects to the pump groups via the piping 308. A fluid cycling conduit 328F extends from the first fluid cycling conduit 306F and connects to the pump groups via the piping 308. The fluid cycling conduit 328E and the fluid cycling conduit 328F provide fluid communication pathways between the respective fluid sources and the pump groups for supplying fracturing fluids to one or more wells.

Referring to FIG. 4A, a pipe-valve system 400A connecting a first fluid supply conduit 406, a second fluid cycling conduit 402, and a third fluid cycling conduit 404 to a pump inlet 414 of a pump supplying fracturing fluid to a designated well is shown. The first fluid supply conduit 406 may supply a first fluid that is substantially free of proppant particles. The second fluid cycling conduit 402 may supply a second fluid comprising sand proppant particulates. The third fluid cycling conduit 404 may supply a third fluid comprising lightweight proppant particulates.

With continued reference to FIG. 4A, the pipe-valve system 400A includes the second fluid cycling conduit 402 positioned at a top portion of the pipe-valve system 400A, the third fluid cycling conduit 404 positioned in a middle portion, and the first fluid supply conduit 406 positioned at a bottom portion. The pump inlet 414 is fluidly connected via a valve 408 to a common supply pipe 407 which splits into two branch pipes. A branch pipe 407A extends from the common supply pipe 407 and is connected to a pipe 410A and a pipe 410C. A branch pipe 407B extends from the common supply pipe 407 and is connected to a pipe 410B and a pipe 410D.

As further shown in FIG. 4A, the branch pipe 407A is fluidly connected to the second fluid cycling conduit 402 via a dirty loop valve 412A and the pipe 410A. The branch pipe 407A is a lso fluidly connected to the first fluid supply conduit 406 via a dirty purge valve 412C and the pipe 410C. The branch pipe 407B is fluidly connected to the third fluid cycling conduit 404 via a LWP loop valve 412B and the pipe 410B. The branch pipe 407B is also fluidly connected to the first fluid supply conduit 406 via a clean loop valve 412D and the pipe 410D.

Referring to FIG. 4A, the dirty loop valve 412A, the LWP loop valve 412B, the dirty purge valve 412C, and the clean loop valve 412D are each switchable between an open position and a closed position. The dirty loop valve 412A is positioned in close proximity to the second fluid cycling conduit 402. The LWP loop valve 412B is positioned in close proximity to the third fluid cycling conduit 404. The dirty purge valve 412C is positioned in close proximity to the branch pipe 407A. The clean loop valve 412D is positioned in close proximity to the branch pipe 407B.

With continued reference to FIG. 4A, the valve 408 is positioned between the common supply pipe 407 and the pump inlet 414. When the valve 408 is closed, none of the first fluid, the second fluid, and the third fluid is supplied to the pump inlet 414. The arrangement of the dirty loop valve 412A and the LWP loop valve 412B in close proximity to the second fluid cycling conduit 402 and the third fluid cycling conduit 404 respectively may prevent significant settling of proppant particles immediately upstream of the dirty loop valve 412A and the LWP loop valve 412B. The positioning of the dirty purge valve 412C and the clean loop valve 412D in close proximity to the branch pipe 407A and the branch pipe 407B respectively may reduce proppant particle buildup at an end of the pipe 410C and the pipe 410D downstream of the dirty purge valve 412C and the clean loop valve 412D.

Referring to FIG. 4B, a pipe-valve system 400B connecting a first fluid supply conduit 406, a second fluid cycling conduit 402, and a third fluid cycling conduit 404 to a pump inlet 414B of a pump supplying fracturing fluid to a designated well is shown. The pipe-valve system 400B includes the second fluid cycling conduit 402 positioned at a top portion of the pipe-valve system 400B, the third fluid cycling conduit 404 positioned in a middle portion, and the first fluid supply conduit 406 positioned at a bottom portion.

With continued reference to FIG. 4B, the pump inlet 414B is fluidly connected via a valve 408 to a common supply pipe 407 which splits into two branch pipes. A branch pipe 407A extends from the common supply pipe 407 and is connected to a pipe 410A. A branch pipe 407B extends from the common supply pipe 407 and is connected to a pipe 410B.

As further shown in FIG. 4B, the pipe-valve system 400B includes a T-valve 415A positioned at a junction between the second fluid cycling conduit 402, the first fluid supply conduit 406, and the branch pipe 407A. The T-valve 415A receives a first fluid from the first fluid supply conduit 406 and a second fluid from the second fluid cycling conduit 402 through two separate inlets. The T-valve 415A is connected to the branch pipe 407A via the pipe 410A. The T-valve 415A may be adjusted to allow only the first fluid, only the second fluid, both the first fluid and the second fluid, or neither of the first fluid and the second fluid to enter the branch pipe 407A.

Referring to FIG. 4B, the pipe-valve system 400B further includes a T-valve 415B positioned at a junction between the third fluid cycling conduit 404, the first fluid supply conduit 406, and the branch pipe 407B. The T-valve 415B receives the first fluid from the first fluid supply conduit 406 and a third fluid from the third fluid cycling conduit 404 through two separate inlets. The T-valve 415B is connected to the branch pipe 407B via the pipe 410B. The T-valve 415B may be adjusted to allow only the first fluid, only the third fluid, both the first fluid and the third fluid, or neither of the first fluid and the third fluid to enter the branch pipe 407B.

With continued reference to FIG. 4B, the valve 408 is positioned between the common supply pipe 407 and the pump inlet 414B. When the valve 408 is closed, none of the first fluid, the second fluid, and the third fluid is supplied to the pump inlet 414B. Compared to configurations using separate valves, the pipe-valve system 400B uses fewer valves by incorporating the T-valve 415A and the T-valve 415B, which may reduce a number of operations and may improve reliability.

The proppant particulates used in the fracturing fluids may include various types and sizes. In some cases, the proppant particulates may include sand proppant particulates. The sand proppant particulates may include various mesh sizes such as 40 mesh, 70 mesh, 40/70 mesh, 40/140 mesh, or other mesh sizes. In some cases, the proppant particulates may include lightweight proppant (“LWP”) particulates. The LWP particulates may have a density lower than sand proppant particulates. In some cases, the LWP particulates may include petroleum coke proppant particulates. In some cases, at least two differing types of proppant particulates may be used in a hydraulic fracturing operation performed via one or more wells.

A concentration of proppant particulates in the fracturing fluids may be specified in various units. In some cases, the concentration of proppant particulates may be specified in units of pounds per gallon (“PPG”). In some cases, the concentration of proppant particulates may be specified in units of pounds per thousand gallons (“PPT”). In some cases, the concentration of proppant particulates may be specified in units of pounds added (“PPA”). A master control system 1220 may send commands specifying a first type of proppant particulates for a first sub-stage and a second type of proppant particulates for a second sub-stage. In some cases, the master control system 1220 may specify a distinct amount of mass of proppant particulates for each sub-stage or stage. A proppant particulate retrieval sub-system 1316 may use weights and metering to supply a specified mass of proppant particulates.

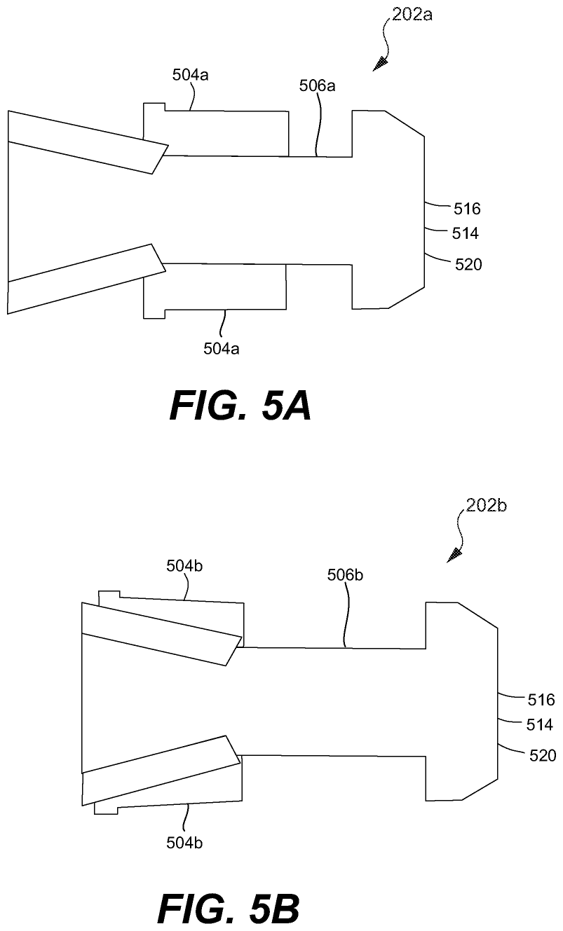

Referring to FIG. 5A, an un-activated isolation device 202a is shown. The un-activated isolation device 202a includes an un-activated landing portion 504a. The un-activated isolation device 202a further includes a processor 514, a configuration transceiver 516, and a memory 520 positioned within the un-activated isolation device 202a. In an embodiment, the un-activated landing portion 504a is located close to one end of the un-activated isolation device 202a. In the un-activated state, the un-activated landing portion 504a and the un-activated landing cavity 506a is in a retracted or compact configuration, allowing the isolation device 202a to pass sleeves uphole of the target sleeve the isolation device is programmed to engage with. Before being launched into the wellbore, the un-activated isolation device 504a may be automatically programmed via the transceiver 516 (e.g., at an automated isolation device retrieval sub-system (“IDRS”) by a configuration device) to enable it to engage with a target sleeve in the wellbore. In a preferred embodiment, the configuration transceiver 516 is provided for wireless communication, enabling two-way data exchange including writing configuration parameters such as target sleeve information and receiving acknowledgments, health data, or status data. The un-activated isolation device 202b also includes a memory 520 coupled to the processor 514 for storing configuration data and operational parameters. Once launched into the wellhead of a well through a wellhead access sub-system (“WASS”), the isolation device traverses through the well casing string toward the target sleeve. As it passes by each uphole sleeve before approaching the target sleeve, the isolation device preferably counts the sleeves. Once the processor 514 determines the isolation device is approaching the target sleeve, the processor can send a signal to the activation mechanism (not shown) in the isolation device, thereby triggering the deployment of the activation mechanism, changing the isolation device into the activated state, enabling the isolation device to land in the target sleeve and engage with the target sleeve to form a plug isolating the downhole portion of the well from the uphold portion.

With reference to FIG. 5B, an activated isolation device 202b is shown. The activated isolation device 202b includes an activated landing portion 504b. Upon deployment of the activation mechanism described above, the activated landing portion 504b moves even closer to one end of the activated isolation device 202b along a upward ramp, thereby enlarging dimension of the landing portion. The activated, enlarged landing portion 504b is configured to interface with and engage with a target sleeve of the wellbore to form a plug as described above.. A configuration transceiver 516 is provided for wireless communication, enabling two-way data exchange including writing configuration parameters such as target sleeve information and receiving acknowledgments, health data, or status data. The activated isolation device 202b also includes a memory 520 coupled to the processor 514 for storing configuration data and operational parameters.

The arrangement of the processor 514, the configuration transceiver 516, and the memory 520 enables the isolation device 202 to be programmed to pair with a designated sleeve, count sleeves during transit through the production casing string, and engage with the target sleeve at an appropriate location within the wellbore.

The isolation device 202 may take various forms and configurations. In some cases, the isolation device 202 may be a dart having an elongated body with a longitudinal axis and an external surface profile having a circular cross-section when intercepted by a plane perpendicular to the longitudinal axis of the dart, such as one illustrated in FIGS. 5A and 5B an described above. In some cases, the isolation device 202 may be a ball having a substantially spherical external surface profile. In some cases, the isolation device 202 may include a combination of a keyed collet having a mating profile to the designated sleeve and a separate sealing device driving the keyed collet downhole.

The isolation device 202 may be made from various types of materials. In some cases, the isolation device 202 may be made from metal, plastics, rubber, or combinations thereof. In some cases, the isolation device 202 may be at least partially dissolvable under conditions in the production casing string after performance of a hydraulic fracturing operation. At least part of outer components of the isolation device 202 may be made of a dissolvable material, such as a metal alloy that may react with fluid the isolation device 202 is exposed to. In some cases, at least 50% (e.g., 50%, 60%, 70%, 75%, 80%, 85%, 90%, 95%, 100%) of the total weight of the isolation device 202 may be dissolvable. The dissolution of at least a portion of the isolation device 202 may reduce or eliminate the need of drilling or retrieving the isolation device 202 or parts thereof before production begins from the reservoir 250.

The isolation device 202 may be programmable. A register or a memory device inside the isolation device 202 may be configured to store information relating to the designated sleeve the isolation device 202 is intended to reach and engage. The stored information may be used by the isolation device 202 to guide travel through the production casing, counting any number of intermediate sleeves the isolation device 202 has passed, until the isolation device 202 reaches and pairs with the designated sleeve. The programming of the isolation device 202 may occur at various locations, including a storage site of isolation devices, en route to the wellhead 270 when the isolation device 202 is transported from the storage site to the wellhead 270, in the vicinity of the wellhead 270 before being deployed into the wellhead 270, or inside the wellhead 270 once the isolation device 202 is launched into the piping.

The isolation device 202 may be transported from an isolation device storage location to the wellhead 270 of a designated well using various transport methods. In some cases, the isolation device 202 may be transported using a drone. In some cases, the isolation device 202 may be transported using a conveyor belt. In some cases, the isolation device 202 may be transported by a human. In some cases, the isolation device 202 may be auto-programmed wirelessly with two-way communications, including writing configuration parameters and receiving acknowledgments and health or status data.

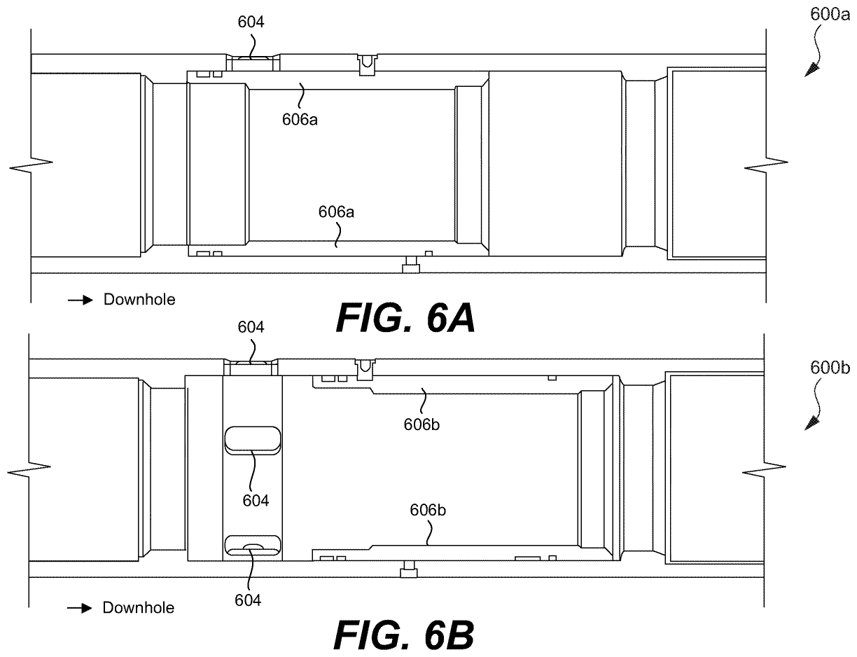

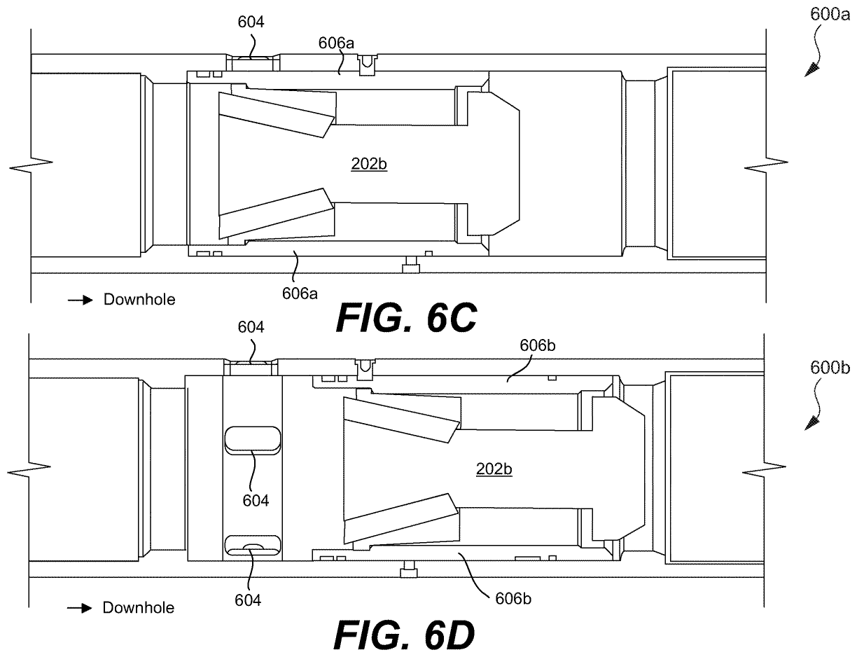

Referring to FIGS. 6A and 6B, cross-sectional views of a sleeve assembly in two different operational states are shown. FIG. 6A depicts a closed sleeve 600a configuration, and FIG. 6B depicts an open sleeve 600b configuration. Both views are oriented with a downhole direction indicated by an arrow pointing to the right.

In FIG. 6A, the closed sleeve 600a includes a closed inner sleeve 606a positioned within the sleeve assembly. The closed inner sleeve 606a is shown in a first position where fracturing ports (or flow ports, or injection ports) 604 are blocked or covered, preventing fluid communication between an interior of the production casing string and a surrounding reservoir. The fracturing ports 604 may be visible as openings in an outer wall of the sleeve assembly, but in the closed configuration, the closed inner sleeve 606a obstructs the fracturing ports 604.

With reference to FIG. 6B, the open sleeve 600b is depicted after actuation has occurred. An open inner sleeve 606b has shifted from the first position to a second position, thereby exposing the fracturing ports 604. In the open configuration, the fracturing ports 604 provide fluid communication pathways that allow fracturing fluid to exit the production casing string and enter an adjacent reservoir formation. The open inner sleeve 606b is shown displaced relative to the position of the closed inner sleeve 606a in FIG. 6A, creating exposed flow paths through the fracturing ports 604.

As further shown in FIGS. 6A and 6B, the sleeve assembly structure includes an outer housing with internal features designed to accommodate movement of the inner sleeve between the closed and open positions. The fracturing ports 604 are arranged along the sleeve assembly and become functional conduits for fracturing fluid injection when the inner sleeve shifts to the open position. In some cases, each sleeve may include 2, 3, 4, 5, 6, 7, 8, 9, 10, or more fracturing ports 604. In some cases, the fracturing ports 604 on a designated sleeve may have substantially uniform dimensions and shapes.

Referring to FIGS. 6C and 6D, cross-sectional views of the closed sleeve 600a and the open sleeve 600b are shown with an activated isolation device 202b engaged with the sleeve assembly. Both views are oriented with an arrow indicating the downhole direction.

FIG. 6C depicts the closed sleeve 600a in a cross-sectional view. The closed sleeve 600a includes the closed inner sleeve 606a positioned within the sleeve body. In the closed configuration, the closed inner sleeve 606a is positioned such that the fracturing ports 604 are blocked, preventing fluid communication between the interior of the production casing string and the surrounding reservoir. The activated isolation device 202b is shown engaged with the closed sleeve 600a, positioned within the sleeve structure. The activated isolation device 202b engaged with the inner sleeve 606a forms a plug isolating the downhole portion of the wellbore from the uphole portion. As a fluid exerts pressure on the plug, the inner sleeve shifts from a first closed position to a second, open position, as shown in FIG. 6D.

With continued reference to FIG. 6D, the open sleeve 600b is depicted in a cross-sectional view. The open sleeve 600b includes the open inner sleeve 606b that has shifted position relative to the closed configuration shown in FIG. 6C. The activated isolation device 202b remains engaged with the sleeve structure to form a plug. In the open configuration, the open inner sleeve 606b has moved to expose the fracturing ports 604, establishing fluid communication between the interior of the production casing string and the surrounding formation. The fracturing ports 604 are aligned to permit fracturing fluid to exit the production casing string and enter the reservoir for hydraulic fracturing operations.

As further shown in FIGS. 6C and 6D, the transition from the closed sleeve 600a configuration to the open sleeve 600b configuration occurs when the activated isolation device 202b engages with the designated sleeve, causing the inner sleeve to shift from the closed inner sleeve 606a position to the open inner sleeve 606b position. The shifting action may occur due to continued force exerted on the activated isolation device 202b by fluid behind the activated isolation device 202b. The shifting action exposes the fracturing ports 604, allowing fracturing fluid to be injected into the subsurface formation while the activated isolation device 202b isolates the open sleeve 600b from the production casing string downhole of the open sleeve 600b.

The isolation device 202 may include a coding device for pairing the isolation device 202 with a designated sleeve. In some cases, the coding device may be used to count sleeves that the isolation device 202 passes or reaches during transit through the production casing string. The counting may be performed inside the isolation device 202 by an electrical or mechanical device embedded in the isolation device 202. In some cases, if the isolation device 202 needs to pass a given number of sleeves before reaching the designated sleeve, the isolation device 202 may count the number of sleeves passed en route and stop counting when the number indicates the isolation device 202 has reached the designated sleeve.

In some cases, the coding device in the isolation device 202 may include a magnetic sensing component. The magnetic sensing component may be used by the coding device to sense a magnetic signature produced by the sleeves to count sleeves that are passed or reached. In some cases, the magnetic sensing component may include a conductive wire coil, and each of the sleeves may include a magnet. The conductive wire coil may produce an electric response to the magnet when in proximity to the magnet, and the electric response may be used for counting the sleeves.

In some cases, the coding device may include an accelerometer that provides a signal when the isolation device 202 is in proximity to a sleeve. The signal may be used for counting the sleeves. The signal may be produced by contact between a sleeve and the isolation device 202 differing from contact between the isolation device 202 and sections of the production casing string other than the sleeves.

In some cases, each sleeve may include a radioactive marker. The isolation device 202 may be equipped with a reader that detects the radioactive marker, and the detection of sleeves may be used for counting the sleeves and/or identifying individual sleeves. In some cases, the radioactive marker may include a Pipeline Inspection Point (PIP) tag.

In some cases, the coding device may include an RFID tag, and each of the sleeves may include an RFID reader. The RFID reader may communicate with the RFID tag to effect the pairing. In some cases, the coding device may include an RFID reader, and each of the sleeves may include an RFID tag. The RFID reader may communicate with the RFID tag to effect the pairing. The RFID/reader interaction may be used for counting the sleeves or identifying individual sleeves.

In some cases, the coding device may include a mechanical counting component. The mechanical counting component may be used when counting sleeves.

In some cases, the isolation device 202 may include a combination of a keyed collet having a mating profile to the designated sleeve and a separate sealing device driving the keyed collet downhole. The separate sealing device may include a ball. Engaging the isolation device 202 with the designated sleeve may include mating the designated sleeve with the keyed collet.

In some cases, the isolation device 202 and/or each of the sleeves may include an actuator (or an activation mechanism). Once the isolation device 202 reaches and pairs with the designated sleeve, the actuator may be activated, thereby engaging the isolation device 202 with the designated sleeve. In some cases where a coding device is used for counting the sleeves, the isolation device 202 may be programmed to reach the designated sleeve after the isolation device 202 has passed a given number of sleeves. While the isolation device 202 is pumped down, the coding device may count each sleeve the isolation device 202 passes and reaches en route and may register the total number of sleeves the isolation device 202 has passed. Once the registered number reaches the given number, the isolation device 202 may be paired with the designated sleeve.

In some cases, the isolation device 202 may pair with the designated sleeve without counting sleeves the isolation device 202 passes and reaches, by using RFID/RFID reader, radioactive markers/readers, keyed collet, or other electrical, magnetic, or mechanical means. The isolation device 202 may communicate with the designated sleeve around the time of pairing. The pairing may activate the actuator in the isolation device 202 and/or the actuator in the sleeve, causing the isolation device 202 and the sleeve to engage. The engagement may cause the sleeve to shift to open, exposing the fracturing ports 604, stopping the isolation device 202 from moving further downhole beyond the designated sleeve.

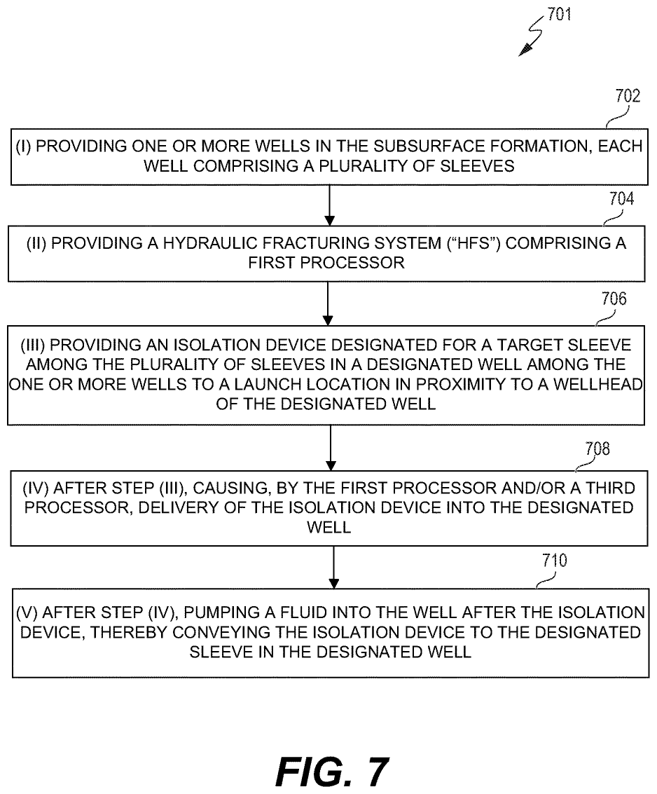

Referring to FIG. 7, a method 701 for pumping hydraulic fracturing fluids to a designated well using a fracturing fluid supply system to effect fracturing of a given stage in a designated well is shown. The method 701 provides a sequence of operations for automated hydraulic fracturing operations, where a first processor can be used to coordinate the conveyance of isolation devices, launching the isolation devices into the well (e.g., using valve systems), and pump management to deliver fracturing fluids to designated sleeves in a well.

At a step 702, one or more wells are provided in a subsurface formation, each well comprising a plurality of sleeves. The wells may include a casing 212 that lines the wellbore and provides structural integrity. Each well may transition from a vertical orientation near a surface 236 to a lateral orientation through a heel 260, extending toward a toe 275 at a distal end of the lateral section. The plurality of sleeves may be positioned along the lateral section of each well, and each sleeve may include a fracturing fluid port 210 that, when opened, allows fracturing fluid to be injected into a reservoir 250.

With continued reference to FIG. 7, at a step 704, a hydraulic fracturing system (“HFS”) comprising a first processor is provided. The first processor may be part of a master control system 1220 that coordinates and controls various sub-systems within the hydraulic fracturing system 1306. The master control system 1220 may bring control of equipment from multiple vendors on a hydraulic fracturing site into a single system that sends commands and controls equipment related to hydraulic fracturing operations. The first processor may communicate with sub-systems including a valve management sub-system 1322, an isolation device delivery sub-system 1340, an isolation device retrieval sub-system 1328, and a pump management sub-system 1346 via a local network 1314.

At a step 706, an isolation device 202 designated for a target sleeve among the plurality of sleeves in a designated well among the one or more wells is provided to a launch location in proximity to a wellhead 270 of the designated well. In some cases, the first processor causes the isolation device 202 to be conveyed to the launch location. In some cases, the HFS may comprise an automated isolation device delivery sub-system 1340 (“IDDS”). The IDDS may include a second processor 1342 and a memory 1344. Step 706 may include sending, by the first processor 1210, a first communication to the second processor 1342. Responsive to the first communication, the second processor 1342 may cause the isolation device 202 to be conveyed to the launch location of the designated well. In some cases, the first communication may include timing of the arrival of the isolation device 202 at the launch location.

As further shown in FIG. 7, the HFS may comprise an automated isolation device retrieval sub-system 1328 (“IDRS”). The IDRS may include afifth processor 1330 and a memory 1332. Step 706 may further include sending, by the first processor 1210, a second communication to the fifth processor 1330. Responsive to the second communication, the fourth processor 1330 may cause the isolation device 202 to be retrieved from a storage location and conveyed to the IDDS. In some cases, the second communication may include timing of the arrival of the isolation device 202 at the IDDS.

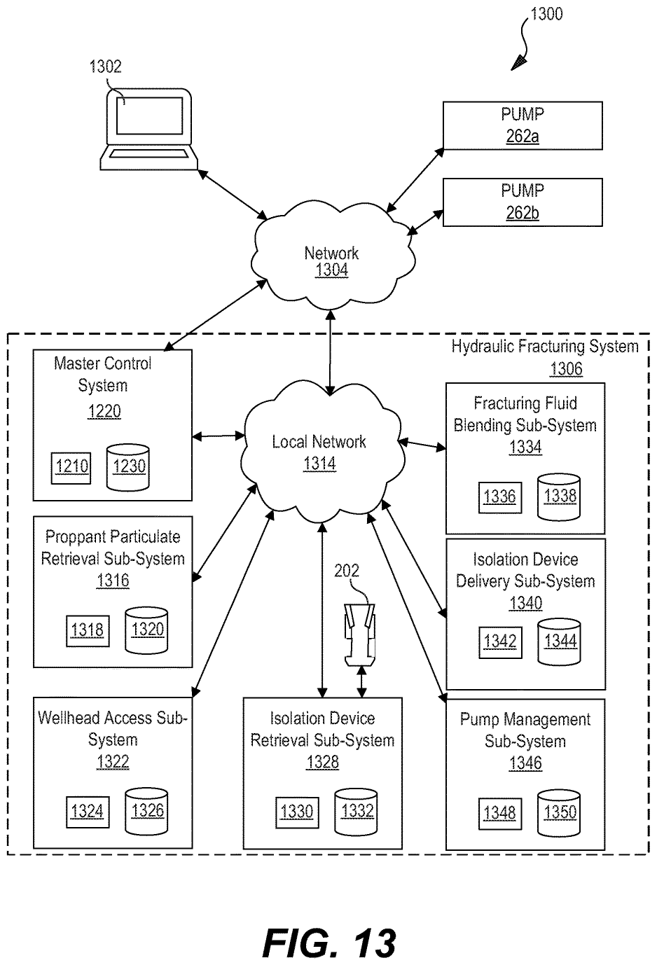

Referring to FIG. 7 and FIG. 13, the fifth processor 1330, at the direction of the first processor 1210, may cause the isolation device 202 to be configured to engage with the target sleeve. The configuration of the isolation device 202 may include specifying the target sleeve to be paired with the isolation device 202. In some cases, the configuration may be performed at the storage location before the isolation device 202 is conveyed to the wellhead 270. In some cases, the configuration may be performed en route to the wellhead 270, in the vicinity of the wellhead 270, or inside the wellhead 270 once the isolation device 202 is launched into the piping. In some cases, the isolation device 202 may be auto-programmed wirelessly with two-way communications, including writing configuration parameters and receiving acknowledgments and health or status data. In some cases, the second processor 1342 and the fifth processor 1330 may be one and the same.

With continued reference to FIG. 7, at a step 708, after step 706, the first processor and/or a third processor causes delivery of the isolation device 202 into the designated well. In some cases, the HFS may comprise an automated wellhead access sub-system 1322 (“WASS”). The WASS may include a fifth processor 1324 and a memory 1326. In some cases, the WASS may comprise a first pressure barrier device 232, a pressure equalization chamber 230, and a second pressure barrier device 234. In some cases, the WASS may include an isolation device conveyor apparatus used to inject the isolation device into the well. The isolation device conveyor apparatus may include, without limitation, a screw conveyor or a hydraulic push rod driven conveyor. The screw conveyor may use a rotating helical screw blade to advance the isolation device through a pressure barrier and into the wellhead piping. The hydraulic push rod driven conveyor may use a hydraulically actuated push rod to advance the isolation device through a pressure barrier and into the wellhead piping. In some cases, the isolation device conveyor apparatus may include a pressure barrier component that seals around the isolation device during conveyance, maintaining pressure integrity between the atmospheric side and the wellbore pressure side. In some cases, the WASS may comprise a sealable and un-sealable pressure barrier chamber enclosure, such as a lubricator or a side-entry access pressure vessel, that can be sealed to contain wellbore pressure during isolation device loading and unsealed to allow access for loading the isolation device. In some cases, the lubricator may be optionally pressurizable.

Step 708 may include causing, by the first processor 1210 and/or the third processor 1324, the first pressure barrier device 232 of the wellhead 270 associated with the designated well to open to allow loading of the isolation device 202 into the pressure equalization chamber 230 associated with the designated well. The isolation device 202 may be dropped or conveyed into the pressure equalization chamber 230 after the first pressure barrier device 232 opens. Step 708 may further include causing, by the first processor 1210 and/or the third processor 1324, the second pressure barrier device 234 in the wellhead 270 associated with the designated well to open to launch the isolation device 202 into the designated well. In some cases, step 708 may include sending, by the first processor 1210, a third communication to the third processor 1324. The third communication may include timing of opening the first pressure barrier device 232. Responsive to the third communication, the third processor 1324 may cause the first pressure barrier device 232 to open. In some cases, step 708 may further include sending, by the first processor 1210, a fourth communication to the third processor 1324. The fourth communication may include timing of opening the second pressure barrier device 234. Responsive to the fourth communication, the third processor 1324 may cause the second pressure barrier device 234 to open. In some cases, the master control system 1220 may track how much fluid is intended to be pumped ahead of the next stage start and may send the command to open the second pressure barrier device 234 at the time that the stage design has been pumped to completion.

Referring to FIG. 7, at a step 710, after step 708, a fluid is pumped into the well after the isolation device 202, thereby conveying the isolation device 202 to the designated sleeve in the designated well. In some cases, the first processor and/or a fourth processor causes one or more pumps 262a and 262b to pump the fluid into the well. The HFS may comprise a pump management sub-system 1346 (“PMSS”). The PMSS may include a fourth processor 1348 and a memory 1350. Step 710 may include sending, by the first processor 1210, a fifth communication to the fourth processor 1348. The fifth communication may include one or more of: a target flow rate of the fluid, a target pressure of the fluid, a timing of reaching the target flow rate and/or target pressure, and a ramp rate of the flow rate and/or pressure of the fluid. Responsive to the fifth communication, the fourth processor 1348 may cause the pump 262a and/or the pump 262b to pump the fluid into the well at the specified flow rate and/or pressure.

With continued reference to FIG. 7, the isolation device 202 may be pumped downhole through the casing 212, past the heel 260, and through the lateral section toward the target sleeve where the isolation device 202 engages with the designated sleeve to open the corresponding fracturing fluid port 210 for fracturing operations in the reservoir 250. The engagement of the isolation device 202 with the designated sleeve may cause the designated sleeve to shift to expose open ports on the designated sleeve, the isolation device 202 to stop moving downhole and stay engaged with the designated sleeve, and the production casing string downhole to the designated sleeve to be isolated from the production casing string uphole to the designated sleeve.

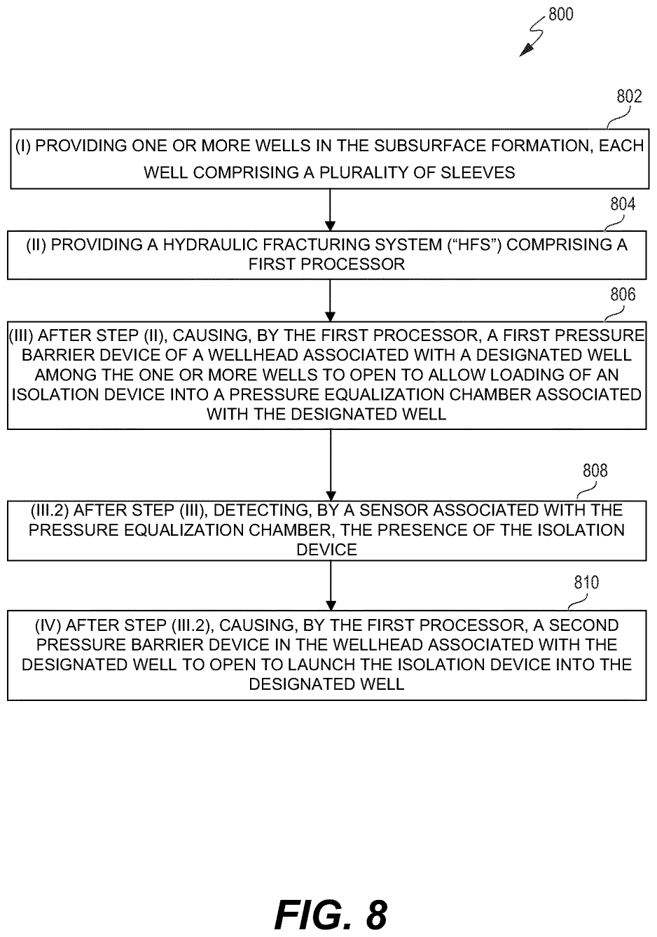

Referring to FIG. 8, a method 800 for performing automated hydraulic fracturing operations with sensor detection is shown. The method 800 provides a sequence of operations for loading and launching an isolation device 202 into a designated well using sensor-based detection to confirm the presence of the isolation device 202 in a pressure equalization chamber 230 before launching.

At a step 802, one or more wells are provided in a subsurface formation, each well comprising a plurality of sleeves 208a, 208b, 208c, 208d, and 208e. The wells may include a casing 212 that lines the wellbore and provides structural integrity. Each well may transition from a vertical orientation near a surface 236 to a lateral orientation through a heel 260, extending toward a toe 275 at a distal end of the lateral section. The plurality of sleeves may be positioned along the lateral section of each well, and each sleeve may include a fracturing fluid port 210 that, when opened, allows fracturing fluid to be injected into a reservoir 250.

At a step 804, a hydraulic fracturing system (“HFS”) comprising a first processor is provided. The first processor may be part of a master control system 1220 that coordinates and controls various sub-systems within the hydraulic fracturing system 1306. The first processor may communicate with sub-systems including a wellhead access sub-system 1322, an isolation device delivery sub-system 1340, and a pump management sub-system 1346 via a local network 1314.

With continued reference to FIG. 8, at a step 806, the first processor causes a first pressure barrier device 232 of a wellhead 270 associated with a designated well among the one or more wells to open to allow loading of an isolation device 202 into a pressure equalization chamber 230 associated with the designated well. The pressure equalization chamber 230 may be positioned between the first pressure barrier device 232 and a second pressure barrier device 234. The isolation device 202 may be dropped or conveyed into the pressure equalization chamber 230 after the first pressure barrier device 232 opens. In some cases, the first pressure barrier device 232 may be closed after the isolation device 202 enters the pressure equalization chamber 230, thereby sealing the pressure equalization chamber 230.

At a step 808, a sensor associated with the pressure equalization chamber 230 detects the presence of the isolation device 202. A chamber sensor 231 may be associated with the pressure equalization chamber 230 and may be configured to detect the presence of the isolation device 202 within the pressure equalization chamber 230. In some cases, the chamber sensor 231 may further determine when the isolation device 202 has been successfully launched from the pressure equalization chamber 230. In some cases, the chamber sensor 231 may determine a time for the isolation device 202 to reach a target sleeve with which the isolation device 202 is intended to be paired.

As further shown in FIGS. 2A and 8, the chamber sensor 231 may employ various sensor technologies depending on design characteristics of the fracturing system 200. In some cases, the chamber sensor 231 may employ magnetic sensor technology. Magnetic sensor technology may detect a magnetic signature or magnetic field associated with the isolation device 202 as the isolation device 202 enters or exits the pressure equalization chamber 230. In some cases, the chamber sensor 231 may employ laser adapted sensor technology. Laser adapted sensor technology may use laser beams to detect the presence, position, or movement of the isolation device 202 within the pressure equalization chamber 230. In some cases, the chamber sensor 231 may employ radioactive marker technology. Radioactive marker technology may detect a radioactive marker associated with the isolation device 202. In some cases, the radioactive marker may include a Pipeline Inspection Point (PIP) tag. In some cases, the chamber sensor 231 may employ mechanical technology. Mechanical technology may use physical contact or displacement mechanisms to detect the presence of the isolation device 202. In some cases, the chamber sensor 231 may employ acoustic sensor technology. Acoustic sensor technology may detect acoustic signals or vibrations associated with the isolation device 202 entering, residing in, or exiting the pressure equalization chamber 230. In some cases, the chamber sensor 231 may employ combinations of magnetic sensor technology, laser adapted sensor technology, radioactive marker technology, mechanical technology, acoustic sensor technology, radio frequency sensor and optical sensor.

With continued reference to FIG. 8, at a step 810, the first processor causes the second pressure barrier device 234 in the wellhead 270 associated with the designated well to open to launch the isolation device 202 into the designated well. In some cases, before step 810, a pressure in the pressure equalization chamber 230 may be equalized with a pressure in the wellhead 270 below the second pressure barrier device 234. The pressure equalization may occur via a snubbing loop or a test/equalization pump. After the pressure has been equalized in the pressure equalization chamber 230 to the same pressure below the second pressure barrier device 234 and in the wellbore, the second pressure barrier device 234 may be opened and the isolation device 202 may be launched into the wellbore. The isolation device 202 may then be pumped downhole through the casing 212, past the heel 260, and through the lateral section toward a target sleeve where the isolation device 202 engages with a designated sleeve to open the corresponding fracturing fluid port 210 for fracturing operations in the reservoir 250.

The detection of the isolation device 202 in step 808 may provide confirmation that the isolation device 202 has been properly loaded into the pressure equalization chamber 230 before the second pressure barrier device 234 is opened in step 810. In some cases, the detection result from the chamber sensor 231 may be transmitted to the first processor. The first processor may use the detection result to determine timing for opening the second pressure barrier device 234 and for subsequent pumping operations to convey the isolation device 202 to the target sleeve.

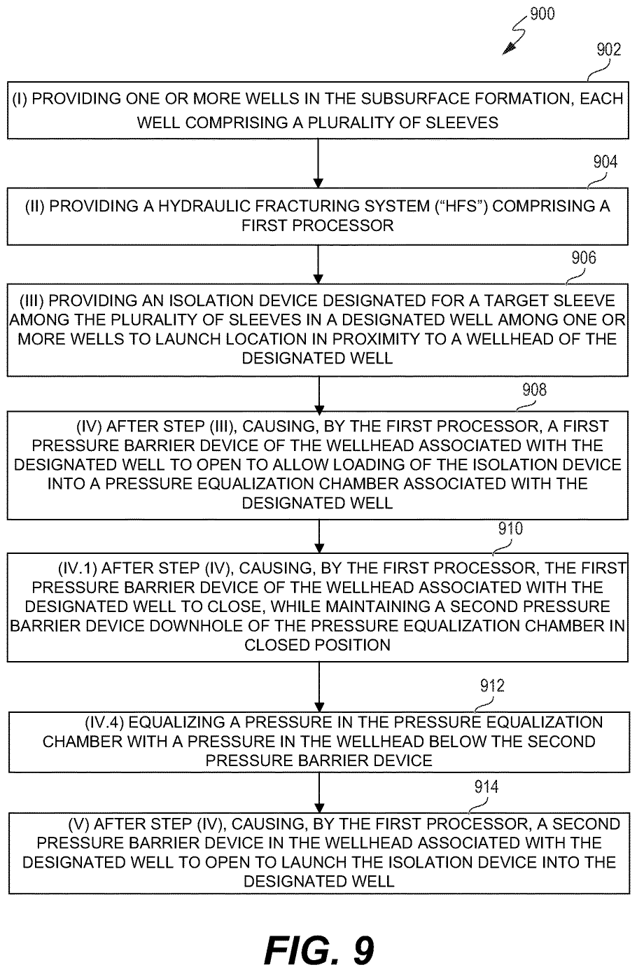

Referring to FIG. 9, a method 900 for performing automated hydraulic fracturing operations with pressure equalization is shown. The method 900 provides a sequence of operations for loading and launching an isolation device 202 into a designated well using pressure equalization to safely deploy the isolation device 202 into a pressurized wellbore.

At a step 902, one or more wells are provided in a subsurface formation, each well comprising a plurality of sleeves. The wells may include a casing 212 that lines the wellbore and provides structural integrity. Each well may transition from a vertical orientation near a surface 236 to a lateral orientation through a heel 260, extending toward a toe 275 at a distal end of the lateral section. The plurality of sleeves may be positioned along the lateral section of each well, and each sleeve may include a fracturing fluid port 210 that, when opened, allows fracturing fluid to be injected into a reservoir 250.

At a step 904, a hydraulic fracturing system (“HFS”) comprising a first processor is provided. The first processor may be part of a master control system 1220 that coordinates and controls various sub-systems within the hydraulic fracturing system 1306. The first processor may communicate with sub-systems including a wellhead access sub-system 1322, an isolation device delivery sub-system 1340, an isolation device retrieval sub-system 1328, and a pump management sub-system 1346 via a local network 1314.

With continued reference to FIG. 9, at a step 906, the first processor causes an isolation device 202 for a target sleeve among the plurality of sleeves in a designated well among the one or more wells to be conveyed to a wellhead of the designated well. In some cases, the isolation device 202 may be retrieved from an isolation device storage location and transported to the wellhead using a drone, a conveyor belt, or by a human. In some cases, the isolation device 202 may be configured to engage with the target sleeve before arriving at the wellhead, at the wellhead, or after entering the wellhead. The configuration may include specifying the target sleeve to be paired with the isolation device 202.

At a step 908, the first processor causes a first pressure barrier device 232 of the wellhead associated with the designated well to open to allow loading of the isolation device 202 into a pressure equalization chamber 230 associated with the designated well. The pressure equalization chamber 230 may be positioned between the first pressure barrier device 232 and a second pressure barrier device 234. The isolation device 202 may be dropped or conveyed into the pressure equalization chamber 230 after the first pressure barrier device 232 opens. In some cases, the pressure equalization chamber 230 may start at atmospheric pressure when the isolation device 202 is loaded.

As further shown in FIG. 9, at a step 910, the first processor causes the first pressure barrier device 232 of the wellhead associated with the designated well to close, while maintaining the second pressure barrier device 234 downhole of the pressure equalization chamber 230 in a closed position. The closing of the first pressure barrier device 232 seals the pressure equalization chamber 230 with the isolation device 202 inside. In some cases, a chamber sensor 231 associated with the pressure equalization chamber 230 may detect the presence of the isolation device 202 within the pressure equalization chamber 230 before or after the first pressure barrier device 232 closes.

At a step 912, a pressure in the pressure equalization chamber 230 is equalized with a pressure in the wellhead below the second pressure barrier device 234. In some cases, the pressure equalization may occur via a snubbing loop or a test/equalization pump. The pressure equalization chamber 230 may be equalized to a treating pressure that the well 204 is exposed to. The pressure equalization allows the isolation device 202 to be safely launched into the pressurized wellbore without a sudden pressure differential that could damage the isolation device 202 or cause uncontrolled movement of the isolation device 202.

With continued reference to FIG. 9, at a step 914, the first processor causes the second pressure barrier device 234 in the wellhead associated with the designated well to open to launch the isolation device 202 into the designated well. After the pressure has been equalized in the pressure equalization chamber 230 to the same pressure below the second pressure barrier device 234 and in the wellbore, the second pressure barrier device 234 may be opened and the isolation device 202 may be launched into the wellbore. The isolation device 202 may then be pumped downhole through the casing 212, past the heel 260, and through the lateral section toward the target sleeve where the isolation device 202 engages with the target sleeve to open the corresponding fracturing fluid port 210 for fracturing operations in the reservoir 250.

In some cases, after step 914, the first processor may cause one or more pumps 262a and 262b to pump a fluid into the wellhead after the isolation device 202, thereby conveying the isolation device 202 to the target sleeve in the designated well. In some cases, the first processor may cause the flow rate and/or pressure of the fluid to be temporarily decreased when the isolation device 202 is in proximity to the target sleeve to facilitate engagement of the isolation device 202 with the target sleeve.

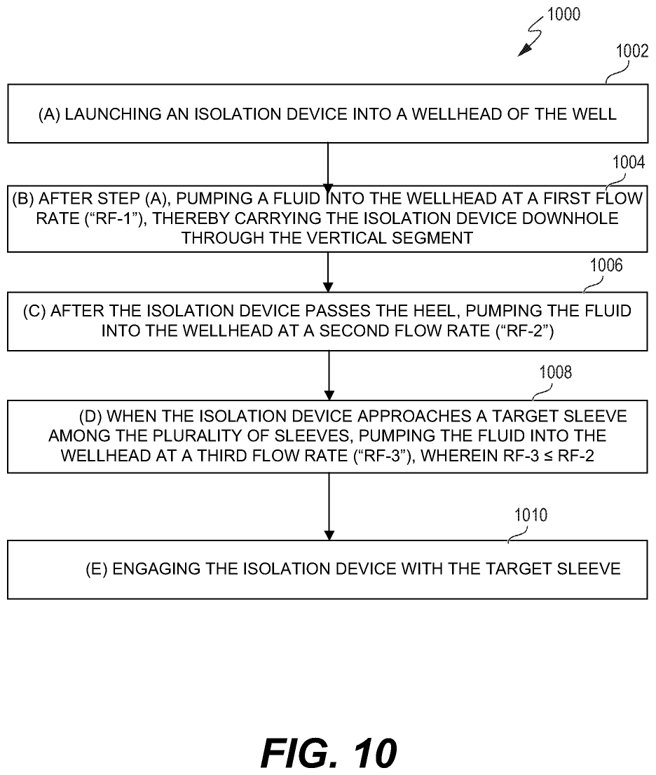

Referring to FIG. 10, a method 1000 for performing hydraulic fracturing operation to a subsurface formation via a well comprising a vertical segment, a heel downhole of the vertical segment, and a lateral segment downhole of the heel is shown. The lateral segment may include a plurality of sleeves. The method 1000 provides a sequence of operations for controlling flow rates during transit of an isolation device 202 through different sections of the well 204 to facilitate engagement of the isolation device 202 with a target sleeve.

At a step 1002, an isolation device 202 is launched into a wellhead 270 of the well 204 In some cases, before step 1002, the isolation device 202 may be programmed for engaging with a target sleeve among the plurality of sleeves. The programming may include specifying the target sleeve to be paired with the isolation device 202. In some cases, the programming may be performed manually by a human, automatically at a location separate from the wellhead 270, automatically enroute to the wellhead 270, or automatically at or within the wellhead 270. In some cases, the programming of the isolation device 202 may be caused by a processor 1210 of a master control system 1220.

With continued reference to FIG. 10, at a step 1004, a fluid is pumped into the wellhead 270 at a first flow rate (“Rf-1”), thereby carrying the isolation device 202 downhole through the vertical segment of the well 204 between the surface 236 and the heel 260. The first flow rate Rf-1 may be selected to convey the isolation device 202 through the vertical segment at a velocity suitable for traversing the vertical segment. In some cases, during the course of step 1002, the fluid may be pumped into the wellhead 270 at a fifth flow rate (“Rf-5”), wherein Rf-5 is less than or equal to Rf-1. The fifth flow rate Rf-5 may be used during the launching of the isolation device 202 to facilitate controlled entry of the isolation device 202 into the wellhead 270. Rf-5/Rf-1 may range from, e.g., 0.1, 0.2, 0.3, 0.4, 0.5, to 0.6, 0.7, 0.8, 0.9, 1. In some cases Rf-1=Rf-2=Rf-3=Rf-4=Rf-5.

In some cases, the first processor may determine a fifth timing (“T5”) of the isolation device 202 entering into the wellhead 270. The first processor may cause a pump management sub-system 1346 to decrease a flow rate of the fluid at a fourth ramp rate until Rf-5 is reached. The determination of the fifth timing T5 may be based on signals from the chamber sensor 231 indicating that the isolation device 202 has exited the pressure equalization chamber 230, or based on signals from sensors positioned in the wellhead piping below the second pressure barrier device 234. In some cases, the fifth timing T5 may be calculated based on a known time delay after the second pressure barrier device 234 opens. The fourth ramp rate may be selected to provide a gradual reduction in flow rate that prevents abrupt pressure changes in the wellhead 270 during the launching phase. In some cases, the fourth ramp rate may range from 0.1 barrels per minute per second to 2.0 barrels per minute per second. The reduction to the fifth flow rate Rf-5 during launching may reduce impact forces on the isolation device 202 as the isolation device 202 enters the wellhead piping and encounters the incoming fracturing fluid stream from the fluid inlet pipe 294. In some cases, the fifth flow rate Rf-5 may be maintained for a predetermined duration after the isolation device 202 enters the wellhead 270, after which the first processor may cause the pump management sub-system 1346 to increase the flow rate at a fifth ramp rate until the first flow rate Rf-1 is reached for transit through the vertical segment. The coordination of flow rate adjustments during the launching phase may protect electronic components within the isolation device 202, such as the processor 514, the configuration transceiver 516, and the memory 520, from damage due to hydraulic shock or excessive acceleration forces.

As further shown in FIG. 10, at a step 1006, after the isolation device 202 passes the heel 260, the fluid is pumped into the wellhead 270 at a second flow rate (“Rf-2”). In some cases, Rf-2 is less than Rf-1. The reduction in flow rate from Rf-1 to Rf-2 may cause the isolation device 202 to traverse at a lower velocity than before passing the heel 260. In some cases, a first processor may determine a first timing (“T1”) of the isolation device 202 passing the heel 260. The first processor may cause a pump management sub-system 1346 to reduce the flow rate of the fluid prior to T1 at a first ramp rate until Rf-2 is reached at about T1. Having a Rf-2 less than Rf-1 can allow the isolation device to traverse the lateral section of the wellbore at a lower velocity than in the vertical section, permitting the isolation device to communicate effectively and reliably with each sleeve it passes en route to the target sleeve. Such effective and reliable communication enables the isolation device to count the sleeves properly, and therefore activate at the right time when approaching the target sleeve. In some cases the ratio of Rf-2/Rf-1 can range from 0.1, 0.2, 0.3, 0.4, to 0.5, 0.6, 0.7, 0.8, 0.9. In some cases, the first processor may cause a pump management sub-system 1346 to control the transition from the first flow rate Rf-1 to the second flow rate Rf-2. The pump management sub-system 1346 may include a processor 1348 and a memory 1350. The processor 1210 may send a communication to the processor 1348 specifying the second flow rate Rf-2 and a ramp rate for the transition.

Referring to FIG. 10, at a step 1008, when the isolation device 202 approaches the target sleeve among the plurality of sleeves, the fluid is pumped into the wellhead 270 at a third flow rate (“Rf-3”), wherein Rf-3 is less than or equal to Rf-2. The reduction in flow rate from Rf-2 to Rf-3 when the isolation device 202 approaches the target sleeve may reduce the velocity of the isolation device 202 to facilitate engagement of the isolation device 202 with the target sleeve. In some cases, the first processor may determine a second timing (“T2”) of the isolation device 202 approaching the target sleeve. The first processor may cause the pump management sub-system 1346 to reduce the flow rate of the fluid prior to T2 at a second ramp rate until Rf-3 is reached at T2. The reduced velocity of the isolation device when engaging with the sleeve can reduce hard impact and water hammer effect at the engagement, which can cause damage to the structure and function of the isolation device and the sleeve, compromising the plugging effect of the isolation device and subsequent hydraulic fracturing operation. In some cases, the ratio of Rf-3/Rf-2 can range from 0.1, 0.2, 0.3, 0.4, to 0.5, 0.6, 0.7, 0.8, 0.9, 1. In some cases, Rf-1=Rf-2=Rf-3.

With continued reference to FIG. 10, at a step 1010, the isolation device 202 engages with the target sleeve. The engagement of the isolation device 202 with the target sleeve may cause the target sleeve to shift from a closed position to an open position, thereby exposing a fracturing port 604 in the target sleeve. In some cases, after step 1010, a fracturing fluid may be pumped into the wellhead 270 through the well 204 and through the injection port into the subsurface formation, thereby creating fractures in the subsurface formation. In some cases, the fracturing fluid may be pumped at a fourth flow rate (“Rf-4”), wherein Rf-4 is greater than Rf-3. In some cases, the first processor may determine that a fracture has been initiated in the subsurface formation (e.g., based on downhole pressure change or sensor data) and may cause the pump management sub-system 1346 to increase the flow rate of the fracturing fluid at a third ramp rate until Rf-4 is reached. In some cases, the ratio of Rf-4/Rf-3 can range from, e.g., 1.0, 1.5, 2.0, 2.5, 3.0, 3.5, 4.0, to 4.5, 5.0, 5.5, 6.0, 6.5, 7.0, 7.5, 8.0.

As further shown in FIGS. 2A and 10, the method 1000 may include counting the sleeves the isolation device 202 passes as the isolation device 202 traverses through the lateral segment. The counting may be performed by the isolation device 202 using a coding device embedded in the isolation device 202. In some cases, the coding device may include a magnetic sensing component that senses a magnetic signature produced by the sleeves to count sleeves that are passed or reached. In some cases, the coding device may include an accelerometer that provides a signal when the isolation device 202 is in proximity to a sleeve, and the signal may be used for counting the sleeves. In some cases, the coding device may include an RFID tag or an RFID reader that communicates with corresponding RFID readers or RFID tags on the sleeves to count the sleeves or identify individual sleeves. In some cases, the coding device may include a mechanical counting component for counting the sleeves.

Referring to FIG. 2A, the sequential reduction in flow rates as the isolation device 202 progresses through different sections of the well 204 may facilitate controlled transit of the isolation device 202 from the wellhead 270 to the target sleeve. The higher flow rate Rf-1 during transit through the vertical segment may convey the isolation device 202 at a higher velocity. The intermediate flow rate Rf-2 after passing the heel 260 may reduce the velocity of the isolation device 202 as the isolation device 202 enters the lateral segment. The lower flow rate Rf-3 when approaching the target sleeve may further reduce the velocity of the isolation device 202 to facilitate engagement with the target sleeve. The ramp rate control by the first processor may provide smooth transitions between the different flow rates at the appropriate timings T1 and T2.

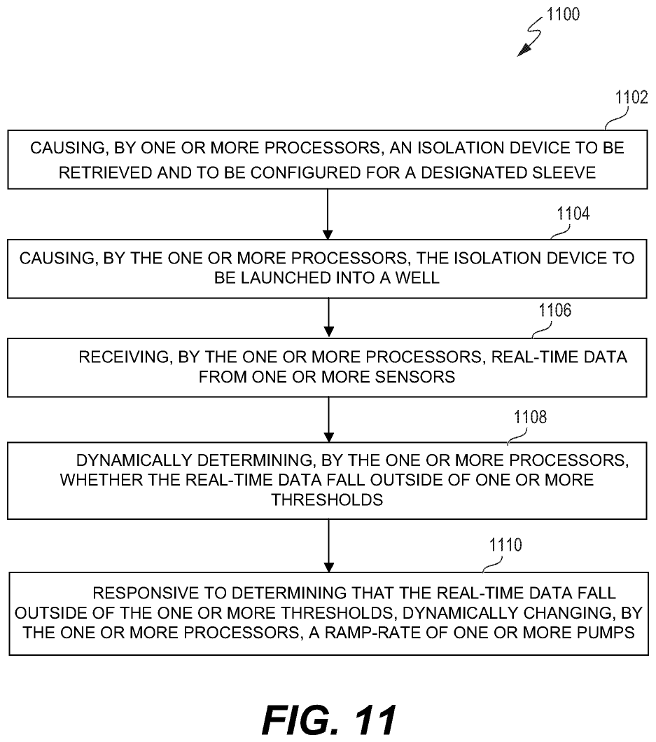

Referring to FIG. 11, a method 1100 for autonomously hydraulically fracturing a subsurface formation is shown. The method 1100 provides a sequence of operations for performing hydraulic fracturing with dynamic adjustments based on real-time sensor data and threshold-based ramp-rate modulation.

At a step 1102, one or more processors cause an isolation device 202 to be retrieved and to be configured for a designated sleeve. In some cases, the one or more processors may include a processor 1210 of a master control system 1220 and/or processors of sub-systems such as an isolation device retrieval sub-system 1328 and an isolation device delivery sub-system 1340. The configuration of the isolation device 202 may include specifying a target sleeve to be paired with the isolation device 202. In some cases, the configuration may be performed at a storage site of isolation devices, en route to a wellhead 270, in the vicinity of the wellhead 270, or inside the wellhead 270.

With continued reference to FIG. 11, at a step 1104, the one or more processors cause the isolation device 202 to be launched into a wellhead of a well. In some cases, step 1104 may include causing a first pressure barrier device 232 to open to allow loading of the isolation device 202. The first pressure barrier device 232 may be positioned above a pressure equalization chamber 230 at the wellhead 270. Opening the first pressure barrier device 232 allows the isolation device 202 to be dropped or conveyed into the pressure equalization chamber 230. In some cases, after the isolation device 202 enters the pressure equalization chamber 230, the one or more processors may cause the first pressure barrier device 232 to close, thereby sealing the pressure equalization chamber 230. In some cases, step 1104 may further include causing a second pressure barrier device 234 to open to launch the isolation device 202 into a wellbore. The second pressure barrier device 234 may be positioned below the pressure equalization chamber 230. In some cases, before opening the second pressure barrier device 234, a pressure in the pressure equalization chamber 230 may be equalized with a pressure in the wellhead 270 below the second pressure barrier device 234. The pressure equalization may occur via a snubbing loop or a test/equalization pump. After the pressure has been equalized, the second pressure barrier device 234 may be opened and the isolation device 202 may be launched into the wellbore.

As further shown in FIG. 11, at a step 1106, the one or more processors receive real-time data from one or more sensors. The one or more sensors may include a first sensor 209a, a second sensor 209b, a third sensor 209c, a fourth sensor 209d, a fifth sensor 209e, a vertical sensor 211, and a chamber sensor 231. The real-time data may include pressure data, flow rate data, temperature data, or combinations thereof. In some cases, the real-time data may include data regarding conditions within respective stages of a well 204 during hydraulic fracturing operations.

At a step 1108, the one or more processors dynamically determine whether the real-time data fall outside of one or more thresholds. The one or more thresholds may be user-configurable parameters. In some cases, the user-configurable parameters may be related to pressure bands and ramp rates. The pressure bands may define acceptable ranges of pressure during various phases of the hydraulic fracturing operation. The ramp rates may define acceptable rates of increase or decrease in flow rate and/or pressure over time.

With continued reference to FIG. 11, at a step 1110, responsive to determining that the real-time data fall outside of the one or more thresholds, the one or more processors dynamically change a ramp-rate of one or more pumps 262a and 262b. The ramp-rate may represent an amount of increase or decrease over time that the one or more pumps 262a and 262b should modulate rate to reach a new pump rate setpoint. In some cases, the ramp-rate may be specified in units of barrels per minute per second.

As further shown in FIG. 11, the dynamic changing of the ramp-rate in step 1110 may include causing the one or more pumps 262a and 262b to ramp up a flow rate and/or a pressure of a fluid after launching the isolation device 202 in step 1104. The ramping up of the flow rate and/or the pressure after launching may convey the isolation device 202 through a vertical segment of the well 204 at a velocity suitable for traversing the vertical segment.

Referring to FIG. 2A, the dynamic changing of the ramp-rate in step 1110 may include causing the one or more pumps 262a and 262b to ramp down the flow rate and/or the pressure of the fluid after the isolation device 202 approaches a heel 260 of the well 204. The ramping down of the flow rate and/or the pressure after the isolation device 202 approaches the heel 260 may reduce the velocity of the isolation device 202 as the isolation device 202 enters a lateral segment of the well 204.

With continued reference to FIG. 2A, the dynamic changing of the ramp-rate in step 1110 may include causing the one or more pumps 262a and 262b to ramp down the flow rate and/or the pressure of the fluid when the isolation device 202 is in proximity to the target sleeve to facilitate engagement of the isolation device 202 with the target sleeve. The reduction in flow rate and/or pressure when the isolation device 202 approaches the target sleeve may reduce the velocity of the isolation device 202 to facilitate pairing and engagement with the target sleeve.

As further shown in FIG. 2A, the dynamic changing of the ramp-rate in step 1110 may include causing the one or more pumps 262a and 262b to ramp up the flow rate and/or the pressure of the fluid after the isolation device 202 has engaged with the target sleeve. The ramping up of the flow rate and/or the pressure after engagement may facilitate injection of fracturing fluid into the subsurface formation through fracturing ports 604 exposed by the engagement of the isolation device 202 with the target sleeve.

Referring to FIG. 11, the user-configurable thresholds used in step 1108 may allow users to specify parameters related to pressure bands and positive and negative ramp rates. The pressure bands may define upper and lower pressure limits during different phases of the hydraulic fracturing operation. The positive ramp rates may define rates at which the flow rate and/or pressure of the fluid may be increased. The negative ramp rates may define rates at which the flow rate and/or pressure of the fluid may be decreased. In some cases, the user-configurable thresholds may be stored in a memory 1230 of the master control system 1220 and may be adjusted remotely via a user device 1302 communicatively coupled to the master control system 1220 through a network 1304.

With continued reference to FIGS. 6C and 6D, the isolation device 202 engages with the target sleeve upon reaching the target sleeve in the lateral section of the well 204. The engagement of the isolation device 202 with the target sleeve may occur when the isolation device 202 pairs with the target sleeve using a coding device, RFID/RFID reader interaction, radioactive markers/readers, keyed collet, or other electrical, magnetic, or mechanical means. In some cases, the isolation device 202 may count sleeves during transit through the production casing string and may engage with the target sleeve when a registered count reaches a given number corresponding to the target sleeve.

As further shown in FIGS. 6C and 6D, the engagement of the isolation device 202 with the target sleeve causes the target sleeve to shift from a closed position to an open position. The target sleeve includes a shiftable mechanism that shifts position upon engagement with the isolation device 202. Before engagement, the shiftable mechanism is in a first position resulting in fracturing ports 604 on the target sleeve being closed. Once the isolation device 202 engages with the target sleeve, the shiftable mechanism shifts to a second position due to continued force exerted on the isolation device 202 by fluid behind the isolation device 202, thereby exposing and opening the fracturing ports 604 on the target sleeve.

Referring to FIG. 2A, the shifting of the target sleeve from the closed position to the open position exposes an injection port on the target sleeve. The exposed injection port permits fracturing fluid to exit the production casing string and enter the reservoir 250 for hydraulic fracturing operations. The isolation device 202 engaged with the target sleeve forms a sealed plug preventing the fracturing fluid from flowing further downhole along the production casing string, thereby isolating the open sleeve from the production casing string downhole of the open sleeve.

With continued reference to FIG. 13, after the isolation device 202 engages with the target sleeve and the target sleeve shifts to the open position, the master control system 1220 may cause a fracturing fluid to be injected into the subsurface formation via the exposed injection port. The processor 1210 of the master control system 1220 may send a sixth communication to a processor 1348 of the pump management sub-system 1346 to cause the one or more pumps 262a and 262b to pump the fracturing fluid into the designated well.

As further shown in FIG. 13, the sixth communication from the processor 1210 to the processor 1348 may include one or more of: a type of the fracturing fluid, a flow rate and/or pressure of the fracturing fluid, and a ramp rate of the flow rate and/or the pressure of the fracturing fluid. In some cases, the type of the fracturing fluid may include a clean fluid or a slurried fluid. In some cases, the slurried fluid may include proppant particulates such as sand proppant particulates, lightweight proppant (LWP) particulates, or combinations thereof. In some cases, the LWP particulates may include petroleum coke proppant particulates.

In some cases, the sixth communication may include a time to pump at a specified flow rate such that a specific volume of fracturing fluid is pumped into the well. The specified volume may correspond to a designed stage volume or a sub-stage volume. The first processor may track the cumulative volume of fluid pumped and may send commands to adjust the flow rate or terminate pumping when the specified volume has been reached.

Referring to FIG. 2A, the pump management sub-system 1346 may cause the one or more pumps 262a and 262b to pump the fracturing fluid at a fourth flow rate (“Rf-4”) that is greater than a third flow rate (“Rf-3”) used when the isolation device 202 approached the target sleeve. The increase in flow rate from Rf-3 to Rf-4 after engagement may facilitate injection of the fracturing fluid into the subsurface formation through the fracturing ports 604 exposed by the engagement of the isolation device 202 with the target sleeve.

With continued reference to FIG. 2A, the processor 1210 of the master control system 1220 may determine that a fracture has been initiated in the subsurface formation. In some cases, the determination may be based on real-time data received from one or more sensors 209a-209e positioned along the lateral section of the well 204. The real-time data may include pressure data, flow rate data, temperature data, or combinations thereof. Responsive to determining that a fracture has been initiated, the processor 1210 may cause the pump management sub-system 1346 to increase the flow rate of the fracturing fluid at a third ramp rate until Rf-4 is reached.

As further shown in FIG. 2A, the fracturing fluid pumped at the fourth flow rate Rf-4 may exit the production casing string through the exposed fracturing ports 604 on the target sleeve with sufficient pressure to effect hydraulic fracturing of the reservoir 250. The fracturing fluid may create fractures and/or extend or enlarge existing fractures in the reservoir 250. In some cases, the fracturing fluid may include proppant particles that are transported into and settle in the fractures, thereby maintaining the fractures open after the pressure is relieved.

In some cases, a first total time (“TT-1”) for performing all steps of programming, launching, pumping through the vertical segment, pumping through the lateral segment, and engaging the isolation device with the target sleeve may be no more than 60 minutes. In some cases, TT-1 may be no more than 30 minutes. In some cases, a second total time (“TT-2”) for performing all steps including programming, launching, pumping, engaging, shifting the target sleeve, and counting sleeves may be no more than 60 minutes. In some cases, TT-2 may be no more than 30 minutes. The reduced total time may be achieved through the automated coordination of the master control system 1220 with the various sub-systems, eliminating delays associated with manual intervention between steps.

Referring to FIG. 13, during fracturing operations, no more than ten sleeves (e.g., 1, 2, 3, 4, 5, 6, 7, 8, 9, or 10 sleeves) among the plurality of sleeves receiving the fracturing fluid in the designated well may be in an open position, permitting the fracturing fluid to be injected into the subsurface formation through exposed injection ports therein. In some cases, only one sleeve among the plurality of sleeves in the designated well receiving the fracturing fluid may be in an open position, permitting the fracturing fluid to be injected into the subsurface formation through the exposed fracturing port. The single-point fracturing configuration may enable targeted stimulation of specific zones within the reservoir 250.

With continued reference to FIG. 2A, after the designed stage is pumped to completion, the process may repeat. Another isolation device 202 may be launched and pumped to an adjacent, designated sleeve in the production casing string. The process may continue until the fracturing operation of the designated well is completed. In some cases, the hydraulic fracturing system 1306 may perform automated hydraulic fracturing operations to two or more wells simultaneously, with the first processor controlling the automated hydraulic fracturing of the two or more wells.

As further shown in FIG. 13, the master control system 1220 may communicate with a fracturing fluid blending sub-system 1334 to determine a composition of the fracturing fluid. The processor 1210 may send a seventh communication to a processor 1336 of the fracturing fluid blending sub-system 1334 to cause the fracturing fluid having the determined composition to be made in and supplied from the fracturing fluid blending sub-system 1334. The seventh communication may include one or more of: type(s) of proppant particulates, amount(s) and/or concentration(s) of proppant particulates, timing of making the fracturing fluid, and timing of supplying the fracturing fluid.

In some cases, the seventh communication may further include amount(s) and/or concentration(s) of chemical additives to be included in the fracturing fluid. The chemical additives may include, without limitation, a biocide, a scale inhibitor, a viscosity modifier, a friction reducer, a gelling agent, a crosslinker, a breaker, a surfactant, a clay stabilizer, or combinations thereof.

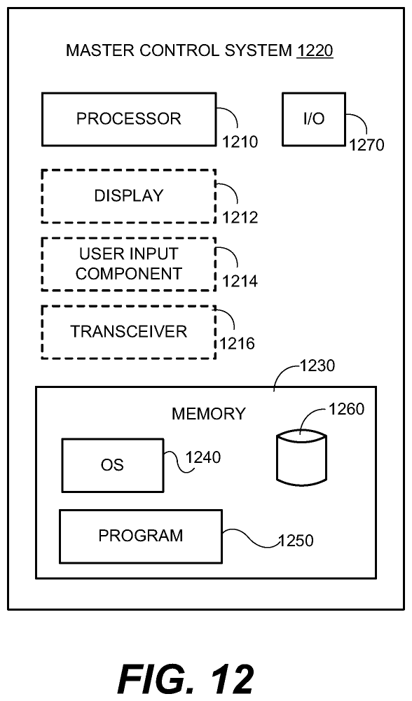

Referring to FIG. 12, a master control system 1220 is shown. The master control system 1220 includes a processor 1210, a display 1212, a user input component 1214, a transceiver 1216, a memory 1230, and an input-output component 1270. The processor 1210 may be configured to execute instructions and manage operations within the master control system 1220. The memory 1230 may include an operating system (“OS”) 1240 and a program 1250, which provide a software environment and executable instructions for the master control system 1220. A storage 1260 may be coupled to the memory 1230 and may provide data storage capabilities for the master control system 1220.

With continued reference to FIG. 12, the display 1212, the user input component 1214 and the transceiver 1216 may be optional components of the master control system 1220. The display 1212 may provide visual output for the master control system 1220. The user input component 1214 may allow for user interaction with the master control system 1220, for example, via a keyboard. The transceiver 1216 may enable communication between the master control system 1220 and external devices or sub-systems.

As further shown in FIG. 12, the input-output component 1270 may facilitate data exchange between the master control system 1220 and external components or sub-systems. In some cases, the input-output component 1270 may include one or more communication interfaces for connecting to sub-systems within a hydraulic fracturing system 1306.

The master control system 1220 may communicate with external devices and sub-systems using various communication methods. In some cases, the transceiver 1216 may employ wireless communication protocols operating at frequencies such as 700 MHz to over 60 GHz such as 2.4 GHz, 5 GHz, 6 GHz, or 915 MHz. For example, wireless communication protocols may include WiFi, Bluetooth, ZigBee, near-field communication (“NFC”), or others. In some cases, the master control system 1220 may communicate with external devices and sub-systems using wired connections such as Ethernet. In some cases, the master control system 1220 may employ a combination of wireless communication protocols and wired connections.

Referring to FIG. 13, the master control system 1220 may coordinate and control various sub-systems within the hydraulic fracturing system 1306. The master control system 1220 may be connected to a local network 1314. The master control system 1220 may instruct and cause sub-systems connected to the local network 1314 to perform functions during hydraulic fracturing operations. In some cases, the master control system 1220 may send commands to a wellhead access sub-system 1322 to control sequencing of pressure barrier devices including a first pressure barrier device 232 and a second pressure barrier device 234. In some cases, the master control system 1220 may send commands to a pump management sub-system 1346 to control flow rates and pressures of fluids pumped into a well 204. In some cases, the master control system 1220 may send commands to an isolation device delivery sub-system 1340 to convey an isolation device 202 to a wellhead 270. In some cases, the master control system 1220 may send commands to a fracturing fluid blending sub-system 1334 to prepare fracturing fluids having specified compositions.

With continued reference to FIG. 13, in some cases, the hydraulic fracturing system 1306 may be fully automated. In fully automated operation, the processor 1210 of the master control system 1220 may execute the program 1250 stored in the memory 1230 to coordinate hydraulic fracturing operations without manual intervention. The processor 1210 may receive real-time data from one or more sensors, dynamically determine whether the real-time data fall outside of one or more thresholds, and dynamically change operational parameters responsive to the real-time data.

In some cases, the master control system 1220 may provide a user interface that allows manual control of operational parameters as an alternative to fully automated operation. The user input component 1214 may allow an operator to manually adjust one or more parameters of various processes. In some cases, the display 1212 may present operational data and status information to the operator. In some cases, the user interface may allow the operator to configure user-configurable thresholds related to pressure bands and ramp rates. In some cases, the master control system 1220 may allow remote adjustments to hydraulic fracturing operations from a location remote from the hydraulic fracturing system 1306 via a user device 1302 communicatively coupled to the master control system 1220 through a network 1304.

Referring to FIG. 13, a system 1300 for performing hydraulic fracturing operations is shown. The system 1300 includes a user device 1302 that is communicatively coupled to a network 1304. The network 1304 provides connectivity between the user device 1302 and a hydraulic fracturing system 1306. The user device 1302 may allow remote monitoring and control of the hydraulic fracturing system 1306 through the network 1304.

With continued reference to FIG. 13, the hydraulic fracturing system 1306 includes a master control system 1220 that is connected to a local network 1314. The master control system 1220 comprises a processor 1210 and a memory 1230. The master control system 1220 may coordinate and control various sub-systems within the hydraulic fracturing system 1306. In some cases, the master control system 1220 may bring control of equipment from multiple vendors on a hydraulic fracturing site into a single system that sends commands and controls equipment related to hydraulic fracturing operations.

As further shown in FIG. 13, a proppant particulate retrieval sub-system 1316 is connected to the local network 1314. The proppant particulate retrieval sub-system 1316 includes a processor 1318 and a memory 1320. The proppant particulate retrieval sub-system 1316 may manage the retrieval and supply of proppant particulates to a fracturing fluid blending sub-system 1334. In some cases, the proppant particulate retrieval sub-system 1316 may supply various types of proppant particulates including sand proppant particulates of various mesh sizes and lightweight proppant (“LWP”) particulates such as petroleum coke proppant particulates.

Referring to FIG. 13, a wellhead access sub-system 1322 is connected to the local network 1314. The wellhead access sub-system 1322 includes a processor 1324 and a memory 1326. The wellhead access sub-system 1322 may control the actuation of pressure barrier devices in the hydraulic fracturing system 1306, including a first pressure barrier device 232 and a second pressure barrier device 234 at a wellhead 270. In some cases, the wellhead access sub-system 1322 may include sensors and actuators for detecting pressure barrier device positions and actuating pressure barrier devices between open and closed positions.

With continued reference to FIG. 13, an isolation device retrieval sub-system 1328 is connected to the local network 1314. The isolation device retrieval sub-system 1328 includes a processor 1330 and a memory 1332. The isolation device retrieval sub-system 1328 may retrieve isolation devices from a storage location and prepare the isolation devices for deployment. In some cases, the isolation device retrieval sub-system 1328 may configure an isolation device 202 to engage with a target sleeve before conveying the isolation device 202 to an isolation device delivery sub-system 1340.

As further shown in FIG. 13, the fracturing fluid blending sub-system 1334 is connected to the local network 1314. The fracturing fluid blending sub-system 1334 includes a processor 1336 and a memory 1338. The fracturing fluid blending sub-system 1334 may prepare fracturing fluids with specified compositions. In some cases, the fracturing fluid blending sub-system 1334 may receive proppant particulates from the proppant particulate retrieval sub-system 1316 and blend the proppant particulates with carrier fluids to form slurried fracturing fluids having specified concentrations.

Referring to FIG. 13, the isolation device delivery sub-system 1340 is connected to the local network 1314. The isolation device delivery sub-system 1340 includes a processor 1342 and a memory 1344. The isolation device delivery sub-system 1340 may convey isolation devices to wellheads. In some cases, the isolation device delivery sub-system 1340 may receive commands from the master control system 1220 specifying when to send an isolation device 202 to a wellhead 270 and what stage to program the isolation device 202 to engage with.

With continued reference to FIG. 13, a pump management sub-system 1346 is connected to the local network 1314. The pump management sub-system 1346 includes a processor 1348 and a memory 1350. The pump management sub-system 1346 may control a pump 262a and a pump 262b to manage flow rates and pressures of fluids pumped into wells. In some cases, the pump management sub-system 1346 may control the pumping rate of the pump 262a and the pump 262b in units of barrels per minute. In some cases, the pump management sub-system 1346 may control a ramp rate representing an amount of increase or decrease over time that the pump 262a and the pump 262b should modulate rate to reach a new pump rate setpoint. Although FIG. 13 shows pumps 262a and 262b as being connected to pump management sub-system 1346 via network 1304 and local network 1314, pumps 262a and 262b may be directly connected to pump management sub-system 1346 or via local network 1314 without network 1304.

As further shown in FIG. 13, the isolation device 202 may be connected or communicate with isolation device retrieval sub-system 1328 in order to program the isolation device 202 for a designated sleeve, which may be conveyed and deployed during hydraulic fracturing operations. The network 1304 is communicatively coupled to the pump 262a and the pump 262b, which are positioned external to the hydraulic fracturing system 1306.

Referring to FIG. 13, the proppant particulate retrieval sub-system 1316, the wellhead access sub-system 1322, the isolation device retrieval sub-system 1328, the fracturing fluid blending sub-system 1334, the isolation device delivery sub-system 1340, and the pump management sub-system 1346 may each have similar components as the master control system 1220. Each sub-system may include a respective processor and a respective memory for executing instructions and storing data related to the functions of the sub-system.

With continued reference to FIG. 13, in some cases, at least two of the proppant particulate retrieval sub-system 1316, the wellhead access sub-system 1322, the isolation device retrieval sub-system 1328, the fracturing fluid blending sub-system 1334, the isolation device delivery sub-system 1340, and the pump management sub-system 1346 may be operated by different service providers. In some cases, at least two of the processor 1210, the processor 1318, the processor 1324, the processor 1330, the processor 1336, the processor 1342, and the processor 1348 may be separate from each other. The processor 1210 of the master control system 1220 may control the processor 1318, the processor 1324, the processor 1330, the processor 1336, the processor 1342, and the processor 1348 of the respective sub-systems.

As further shown in FIG. 13, the master control system 1220 may communicate with each of the sub-systems via the local network 1314 to coordinate hydraulic fracturing operations. The master control system 1220 may send commands to the sub-systems specifying operational parameters and timing for various functions during hydraulic fracturing operations. In some cases, the master control system 1220 may integrate equipment from multiple vendors into a single coordinated system that enables autonomous operation of a hydraulic fracturing site.

Referring to FIG. 13, the hydraulic fracturing system 1306 may include a fracturing fluid blending sub-system 1334 communicatively coupled to the master control system 1220 via the local network 1314. The fracturing fluid blending sub-system 1334 may include a processor 1336 and a memory 1338. The fracturing fluid blending sub-system 1334 may prepare fracturing fluids with specified compositions for injection into the well 204.

With continued reference to FIG. 13, the master control system 1220 may communicate with the fracturing fluid blending sub-system 1334 to determine and control the composition of fracturing fluids. The processor 1210 of the master control system 1220 may send a seventh communication to the processor 1336 of the fracturing fluid blending sub-system 1334 to cause a fracturing fluid having a determined composition to be made in and supplied from the fracturing fluid blending sub-system 1334.

As further shown in FIG. 13, the seventh communication from the processor 1210 to the processor 1336 may include one or more of: type(s) of proppant particulates, amount(s) and/or concentration(s) of proppant particulates, timing of making the fracturing fluid, and timing of supplying the fracturing fluid. In some cases, the concentration of proppant particulates may be specified in units of pounds per gallon (PPG), pounds per thousand gallons (PPT), or pounds added (PPA). The fracturing fluid blending sub-system 1334 may receive the seventh communication and may prepare the fracturing fluid according to the specified parameters.

Referring to FIG. 13, the fracturing fluid blending sub-system 1334 may prepare various types of fracturing fluids. In some cases, the fracturing fluid blending sub-system 1334 may prepare a clean fracturing fluid that is substantially free of proppant particles. The clean fracturing fluid may include water, produced water, treated produced water, slickwater, or combinations thereof. In some cases, the clean fracturing fluid may include additives such as a biocide, a scale inhibitor, a viscosity modifier, a friction reducer, or combinations thereof. In some cases, the fracturing fluid blending sub-system 1334 may prepare a slurried fracturing fluid comprising proppant particles blended with a carrier fluid.

With continued reference to FIG. 13, the hydraulic fracturing system 1306 may include a proppant particulate retrieval sub-system 1316 communicatively coupled to the master control system 1220 via the local network 1314. The proppant particulate retrieval sub-system 1316 may include a processor 1318 and a memory 1320. The proppant particulate retrieval sub-system 1316 may manage the retrieval and supply of proppant particulates to the fracturing fluid blending sub-system 1334.

As further shown in FIG. 13, the master control system 1220 may communicate with the proppant particulate retrieval sub-system 1316 to determine and control the type and quantity of proppant particulates to be supplied to the fracturing fluid blending sub-system 1334. The processor 1210 of the master control system 1220 may send an eighth communication to the processor 1318 of the proppant particulate retrieval sub-system 1316 to cause proppant particulates at a specified quantity to be supplied to the fracturing fluid blending sub-system 1334.

Referring to FIG. 13, the eighth communication from the processor 1210 to the processor 1318 may include one or more of: type of proppant particulates, quantity of proppant particulates, mesh size of proppant particulates, and timing of supplying the proppant particulates to the fracturing fluid blending sub-system 1334. Responsive to the eighth communication, the processor 1318 may cause the proppant particulate retrieval sub-system 1316 to retrieve and supply the specified proppant particulates to the fracturing fluid blending sub-system 1334.

With continued reference to FIG. 13, the proppant particulate retrieval sub-system 1316 may supply various types of proppant particulates. In some cases, the proppant particulates may include sand proppant particulates. The sand proppant particulates may include various mesh sizes such as 40 mesh, 70 mesh, 40/70 mesh, 40/140 mesh, or other mesh sizes. In some cases, the proppant particulates may include lightweight proppant (LWP) particulates. The LWP particulates may have a density lower than sand proppant particulates. In some cases, the LWP particulates may include petroleum coke proppant particulates. In some cases, at least two differing types of proppant particulates may be used in a hydraulic fracturing operation performed via the one or more wells.

As further shown in FIG. 13, the master control system 1220 may cause the proppant particulate retrieval sub-system 1316 to toggle between different proppant types during a hydraulic fracturing operation. The master control system 1220 may send commands specifying a first type of proppant particulates for a first sub-stage and a second type of proppant particulates for a second sub-stage. In some cases, the master control system 1220 may specify a distinct amount of mass of proppant particulates for each sub-stage or stage. The proppant particulate retrieval sub-system 1316 may use weights and metering to supply the specified mass of proppant particulates before transitioning to a next step in a stage design.

Referring to FIGS. 2A, 3A, 3B, 3C, 4A, and 4B, the hydraulic fracturing system 1306 may include one or more fluid cycling conduits. Each fluid cycling conduit may form a fluid supply loop connecting a fluid source outlet to a fluid source inlet. The one or more fluid cycling conduits may continuously circulate one or more fracturing fluids on a suction side of the one or more pumps 262a and 262b. As shown in FIG. 3A, the fracturing fluid supply system 300A may include a third fluid cycling conduit 306A forming an outermost loop connecting to a LWP blender 304A, a second fluid cycling conduit 306B forming a middle loop connecting to a dirty blender 304B, and a first fluid cycling conduit 306C forming an innermost loop connecting to a clean boost tank 304C. Each of the third fluid cycling conduit 306A, the second fluid cycling conduit 306B, and the first fluid cycling conduit 306C may be fluidly connected with pump groups 302A, 302B, 302C, and 302D via piping 308.

With continued reference to FIGS. 2A and 3A, each fluid cycling conduit may be fluidly connected with one or more feed valves switchable between an open position and a closed position. The feed valves may selectively supply the fracturing fluid from the fluid cycling conduit to a pump inlet of a designated pump fluidly connected with the designated well. In some cases, the feed valves may be remotely switchable. The remotely switchable feed valves may be controlled via the master control system 1220 or the wellhead access sub-system 1322. As shown in FIG. 3C, the fracturing fluid supply system 300C may include valves 326 positioned at the piping 308 between the pump groups and the first fluid cycling conduit 306F and the second fluid cycling conduit 306E. The valves 326 may be switchable between an open position and a closed position to selectively supply the fracturing fluids to pump inlets of designated pumps.

As further shown in FIGS. 3A and 3B, a first fluid cycling conduit may supply a first fluid that is substantially free of proppant particles. In the fracturing fluid supply system 300A of FIG. 3A, the first fluid cycling conduit 306C may form an innermost loop connecting to the clean boost tank 304C. In the fracturing fluid supply system 300B of FIG. 3B, a first fluid supply conduit 306D may be positioned in a center portion of the fracturing fluid supply system 300B and may be fluidly connected with the piping 308 to supply the first fluid to the pump groups. The first fluid cycling conduit may include a circular loop of piping that receives fluid from a fracturing water source. The first fluid cycling conduit may continually circulate the first fluid at a prescribed or variable rate, allowing the pump 262a and/or the pump 262b to draw the first fluid from the first fluid cycling conduit for pumping into the well 204. Excess first fluid that is not pumped downhole may return to the first fluid cycling conduit. In some cases, additional fluid may be introduced into the first fluid cycling conduit to supplement losses and maintain a consistent supply of fluid in the first fluid cycling conduit. As shown in FIG. 3C, the first fluid source 304F may receive makeup first fluid 322F via a precursor first fluid inlet 324F.

Referring to FIGS. 3B and 3C, a second fluid cycling conduit may supply a second fluid comprising proppant particles. As shown in FIG. 3B, the fracturing fluid supply system 300B may include a second fluid source 304E in fluid communication with a second fluid cycling conduit 306E via a second fluid inlet 314E and a second fluid outlet 316E. The second fluid inlet 314E and the second fluid outlet 316E may be in fluid communication with the second fluid cycling conduit 306E, forming a second fluid supply loop. The second fluid outlet 316E may supply the second fluid to the second fluid cycling conduit 306E, and the second fluid inlet 314E may receive a returning stream of the second fluid from the second fluid cycling conduit 306E. As shown in FIG. 3C, the fracturing fluid supply system 300C may similarly include the second fluid source 304E in fluid communication with the second fluid cycling conduit 306E via the second fluid inlet 314E and the second fluid outlet 316E. The second fluid source 304E may be connected to an external slurry source 322E via a precursor second fluid inlet 324E.

With continued reference to FIGS. 3B and 3C, the second fluid source 304E may include a blender comprising a vessel and a stirrer inside the vessel. The stirrer may agitate materials inside the vessel to obtain a second fluid with a specified composition and proppant particle distribution. In some cases, the second fluid source 304E may include one or more inlets configured for receiving various components into the vessel, including a precursor fluid, proppant particles, a biocide, a scale inhibitor, a viscosity modifier, a friction reducer, or combinations thereof. As shown in FIG. 3A, the LWP blender 304A may include a pump 305A and the dirty blender 304B may include a pump 305B for supplying the respective fluids into the respective fluid cycling conduits.

As further shown in FIGS. 3A, 3B, and 3C, the hydraulic fracturing system 1306 may include density meters and flow rate meters configured to measure a density or flow rate, or both, of fluids in the fluid cycling conduits. In the fracturing fluid supply system 300A of FIG. 3A, an input densometer 310A may be associated with the third fluid cycling conduit 306A and located in proximity to a fluid inlet of the LWP blender 304A to measure a density of fluids returning to the LWP blender 304A. An input densometer 310B may be associated with the second fluid cycling conduit 306B and located in proximity to a fluid inlet of the dirty blender 304B to measure a density of fluids returning to the dirty blender 304B. An output densometer 312A may be associated with the third fluid cycling conduit 306A and located in proximity to a fluid outlet of the LWP blender 304A. An output densometer 312B may be associated with the second fluid cycling conduit 306B and located in proximity to a fluid outlet of the dirty blender 304B. Pressure regulators 313A and 313B may be positioned upstream of the input densometers 310A and 310B respectively to maintain pressures in the fluid cycling conduits within desirable ranges to feed a suction side of each of the pump groups. In the fracturing fluid supply systems 300B and 300C of FIGS. 3B and 3C, a first density meter 310E may be associated with the second fluid cycling conduit 306E and located in proximity to the second fluid inlet 314E. A second density meter 312E may be associated with the second fluid cycling conduit 306E and located in proximity to the second fluid outlet 316E. A flow meter 318E may be positioned to measure a flow rate of the returning second fluid. A flow rate meter 320E may be positioned to measure a flow rate of the second fluid exiting the second fluid outlet 316E. In some cases, a controller may determine an amount and/or a flow rate of a precursor fluid and/or proppant particles to be received by the second fluid source 304E based at least partly on the density or flow rate measured by the density meters and/or the flow rate meters.

Referring to FIGS. 4A and 4B, the hydraulic fracturing system 1306 may include pipe-valve systems connecting the fluid cycling conduits to pump inlets. As shown in FIG. 4A, a pipe-valve system 400A may connect a first fluid supply conduit 406, a second fluid cycling conduit 402, and a third fluid cycling conduit 404 to a pump inlet 414 of a pump supplying fracturing fluid to a designated well. The pump inlet 414 may be fluidly connected via a valve 408 to a common supply pipe 407 which splits into a branch pipe 407A and a branch pipe 407B. The branch pipe 407A may be fluidly connected to the second fluid cycling conduit 402 via a dirty loop valve 412A and a pipe 410A, and to the first fluid supply conduit 406 via a dirty purge valve 412C and a pipe 410C. The branch pipe 407B may be fluidly connected to the third fluid cycling conduit 404 via a LWP loop valve 412B and a pipe 410B, and to the first fluid supply conduit 406 via a clean loop valve 412D and a pipe 410D. The dirty loop valve 412A may be positioned in close proximity to the second fluid cycling conduit 402, and the LWP loop valve 412B may be positioned in close proximity to the third fluid cycling conduit 404, which may prevent significant settling of proppant particles immediately upstream of the valves. As shown in FIG. 4B, a pipe-valve system 400B may connect the first fluid supply conduit 406, the second fluid cycling conduit 402, and the third fluid cycling conduit 404 to a pump inlet 414 using T-valves. A T-valve 415A may be positioned at a junction between the second fluid cycling conduit 402, the first fluid supply conduit 406, and the branch pipe 407A. A T-valve 415B may be positioned at a junction between the third fluid cycling conduit 404, the first fluid supply conduit 406, and the branch pipe 407B. Each T-valve may be adjusted to allow only the first fluid, only the respective proppant-laden fluid, both fluids, or neither fluid to enter the respective branch pipe. Compared to the pipe-valve system 400A of FIG. 4A, the pipe-valve system 400B of FIG. 4B uses fewer valves by incorporating the T-valve 415A and the T-valve 415B, which may reduce a number of operations and may improve reliability. Referring to FIG. 2A, the continuous circulation of fracturing fluids in the fluid cycling conduits may maintain substantially constant density concentrations of slurries. In some cases, a continuous feedback control system using densometers, flow meters, pressure sensors, and other sensors may be coupled with the master control system 1220 to adjust proppant and fluid additions to establish and maintain densities per design setpoints. The continuous flow of fluids comprising proppant particles may maintain a substantially homogeneous distribution of proppant particles in the fracturing fluid.

Referring to FIG. 13, the hydraulic fracturing system 1306 may employ autonomous stimulation technology to control and optimize hydraulic fracturing operations. The autonomous stimulation technology may include various control methods and algorithms executed by the processor 1210 of the master control system 1220 and/or processors of the sub-systems connected to the local network 1314.

In some cases, the autonomous stimulation technology may include control of pump rates as a function of pressure limitations using a software algorithm. The processor 1210 may monitor pressure data received from one or more sensors 209a-209e and may adjust the pump rate of the pump 262a and/or the pump 262b to maintain pressure within specified limits. The software algorithm may dynamically modulate the pump rate to prevent exceeding pressure thresholds during hydraulic fracturing operations.

With continued reference to FIG. 13, the autonomous stimulation technology may include control of pump rates to follow a designed pump schedule using a software algorithm. The designed pump schedule may specify target flow rates, target pressures, and timing for various phases of the hydraulic fracturing operation. The processor 1210 may cause the pump management sub-system 1346 to adjust the pump 262a and/or the pump 262b to follow the designed pump schedule. In some cases, the designed pump schedule may include target values or target curves that define the desired pump rate profile over time.

As further shown in FIG. 13, the autonomous stimulation technology may include control based on comparison of pre-job predicted execution versus actual execution. The processor 1210 may compare predicted pressure, rate, and volume response to actual values measured during the hydraulic fracturing operation. The pump rates, pressures, and volumes may be modulated in real time based on the comparison to optimize system efficiency and downhole stimulation effectiveness.

Referring to FIG. 2A, the autonomous stimulation technology may include control using subsurface surveillance feedback during stimulation activities. The subsurface surveillance feedback may include fiber-optic response, offset well pressure response, frac-hit detection, or combinations thereof. In some cases, fiber-optic sensors may be deployed in the well 204 or in offset wells to provide real-time data regarding fracture propagation and fluid distribution. In some cases, pressure sensors in offset wells may detect pressure changes indicative of fracture communication between wells. In some cases, frac-hit detection may identify when fractures from the well 204 intersect with offset wells. The processor 1210 may use the subsurface surveillance feedback to optimize the stimulation by adjusting pump rates, pressures, or fluid compositions.

With continued reference to FIG. 2A, the autonomous stimulation technology may include geometry comparison control. The geometry comparison control may compare predicted fracture geometry versus real-time ascertained fracture geometry. In some cases, the predicted fracture geometry may be a pre-execution prediction generated before the hydraulic fracturing operation begins. In some cases, the predicted fracture geometry may be a real-time predictive model that is updated during the hydraulic fracturing operation. The comparison may be performed using physics-based methods, empirical methods, analytical methods, mathematical optimization methods, artificial intelligence (“AI”) methods, or combinations thereof. The processor 1210 may adjust operational parameters based on the comparison to achieve a desired fracture geometry.

As further shown in FIG. 13, the autonomous stimulation technology may include control based on cost optimization. The processor 1210 may compare predicted cost versus real-time ascertained cost during the hydraulic fracturing operation. The cost comparison may include costs associated with fluid consumption, proppant consumption, pump operation, and other operational factors. The processor 1210 may adjust operational parameters to optimize the stimulation based on the cost comparison.

Referring to FIG. 13, the autonomous stimulation technology may include control based on production optimization. The processor 1210 may compare predicted production versus real-time ascertained production. The production comparison may include estimated hydrocarbon recovery rates based on fracture characteristics and reservoir properties. The processor 1210 may adjust operational parameters to optimize the stimulation based on the production comparison.

With continued reference to FIG. 13, the autonomous stimulation technology may include control based on profitability optimization. The processor 1210 may compare predicted well or field profitability versus real-time ascertained profitability. The profitability comparison may account for costs, production rates, and hydrocarbon prices. The processor 1210 may adjust operational parameters to optimize the stimulation based on the profitability comparison.

As further shown in FIG. 13, the autonomous stimulation technology may include control of variable frequency drives (“VFDs”) tied to electric motors using a software algorithm. In some cases, the pump 262a and/or the pump 262b may be driven by electric motors controlled by VFDs. The processor 1210 may send commands to the VFDs to adjust motor speed and torque, thereby controlling the pump rate and pressure output. The VFD control may enable precise modulation of pump performance during hydraulic fracturing operations.

Referring to FIG. 2A, the autonomous stimulation technology may include automation of hydraulic fracturing pumping operations integrating pre-job control inputs with real-time conditions. The pre-job control inputs may include target values or target curves specifying desired pump rates, pressures, and fluid compositions. The real-time conditions may include pressure data, flow rate data, temperature data, and other sensor data received from the sensors 209a-209e, the vertical sensor 211, and the chamber sensor 231, and other sensors not shown. The processor 1210 may integrate the pre-job control inputs with the real-time conditions to eliminate human intervention during the hydraulic fracturing operation.

With continued reference to FIG. 13, the autonomous stimulation technology may include control of proppant slurry and mixing rates using a software algorithm. The processor 1210 may send commands to the fracturing fluid blending sub-system 1334 to control the mixing rate of proppant particulates with carrier fluids. The software algorithm may adjust the mixing rate to maintain a specified proppant concentration in the fracturing fluid. In some cases, the proppant concentration may be specified in units of pounds per gallon (“PPG”), pounds per thousand gallons (“PPT”), or pounds added (“PPA”).

As further shown in FIG. 13, the autonomous stimulation technology may include control of power delivery systems. The power delivery systems may include grid power, pad-generated power, delivered power, or combinations thereof. The processor 1210 may manage power distribution to the pump 262a, the pump 262b, and other equipment in the hydraulic fracturing system 1306. In some cases, the power delivery system control may balance power consumption across multiple pieces of equipment to maintain stable operation.

Referring to FIG. 13, the autonomous stimulation technology may include control using artificial intelligence. In some cases, the artificial intelligence may include machine learning (“ML”) algorithms that learn from historical data and real-time data to improve control decisions. In some cases, the artificial intelligence may include reinforcement learning algorithms that optimize control strategies based on feedback from the hydraulic fracturing operation. The processor 1210 may execute the artificial intelligence algorithms to dynamically adjust operational parameters during the hydraulic fracturing operation.

With continued reference to FIG. 13, the autonomous stimulation technology may make adjustments during the hydraulic fracturing operation without human intervention. The processor 1210 may use machine learning and diagnostics models to enable fracture optimization on a fracture-by-fracture basis. In some cases, the autonomous stimulation technology may allow remote adjustments to stimulation parameters during execution based on real-time surface and subsurface surveillance and predictive modeling.

### Exemplary Use Case—Automated Isolation Device Conveyance and Valve Control

Referring to FIG. 12 and FIG. 13, an exemplary use case for automated isolation device conveyance and valve control is described. A master control system 1220 may coordinate automated fracturing operations for a well 204 in a subsurface formation. The master control system 1220 may include a processor 1210 and a memory 1230. The processor 1210 may execute a program 1250 stored in the memory 1230 to coordinate hydraulic fracturing operations without manual intervention.

With continued reference to FIG. 13, the master control system 1220 may be communicatively coupled to an isolation device delivery sub-system 1340 via a local network 1314. The isolation device delivery sub-system 1340 may include a processor 1342 and a memory 1344. The processor 1210 of the master control system 1220 may send a first communication to the processor 1342 of the isolation device delivery sub-system 1340 specifying when to send an isolation device 202 to a wellhead assembly 290 and what target sleeve among a plurality of sleeves 208a, 208b, 208c, 208d, and 208e the isolation device 202 is designated to engage with.

Referring to FIG. 2A, responsive to the first communication, the processor 1342 may cause the isolation device 202 to be conveyed to the wellhead assembly 290 of the well 204 via an isolation device delivery device 220. In some cases, the isolation device 202 may be configured to engage with the target sleeve before arriving at the wellhead assembly 290, at the wellhead assembly 290, or after entering the wellhead assembly 290. The configuration may include specifying the target sleeve to be paired with the isolation device 202.

With continued reference to FIG. 2A and FIG. 2B, the master control system 1220 may be communicatively coupled to a wellhead access sub-system 1322 via the local network 1314. The wellhead access sub-system 1322 may include a processor 1324 and a memory 1326. After the isolation device 202 arrives at the wellhead assembly 290, the processor 1210 of the master control system 1220 may send a third communication to the processor 1324 of the wellhead access sub-system 1322 to cause a first pressure barrier device 232 to open. The third communication may include timing of opening the first pressure barrier device 232. Responsive to the third communication, the processor 1324 may cause the first pressure barrier device 232 to open to allow loading of the isolation device 202 into a pressure equalization chamber 230 positioned between the first pressure barrier device 232 and a second pressure barrier device 234.

As further shown in FIG. 2A and FIG. 2B, after the isolation device 202 is loaded into the pressure equalization chamber 230, the processor 1210 may cause the first pressure barrier device 232 to close. A chamber sensor 231 associated with the pressure equalization chamber 230 may detect the presence of the isolation device 202 within the pressure equalization chamber 230. In some cases, a pressure in the pressure equalization chamber 230 may be equalized with a pressure in the wellhead assembly 290 below the second pressure barrier device 234 via a snubbing loop, a test/equalization pump, or pressure equalization pipe 276 and associated valves 282 and 284 as shown in FIG. 2B.

Referring to FIG. 2A and FIG. 13, after the pressure has been equalized in the pressure equalization chamber 230, the processor 1210 of the master control system 1220 may send a fourth communication to the processor 1324 of the wellhead access sub-system 1322 to cause the second pressure barrier device 234 to open. The fourth communication may include timing of opening the second pressure barrier device 234. Responsive to the fourth communication, the processor 1324 may cause the second pressure barrier device 234 to open to launch the isolation device 202 into the well 204.

With continued reference to FIG. 2A and FIG. 13, the master control system 1220 may be communicatively coupled to a pump management sub-system 1346 via the local network 1314. The pump management sub-system 1346 may include a processor 1348 and a memory 1350. After the isolation device 202 is launched into the well 204, the processor 1210 of the master control system 1220 may send a fifth communication to the processor 1348 of the pump management sub-system 1346 to cause a pump 262a and/or a pump 262b to pump a fluid into the wellhead assembly 290 after the isolation device 202.

As further shown in FIG. 2A, the pump 262a and/or the pump 262b may pump the fluid at a first flow rate to carry the isolation device 202 downhole through a casing 212 and through a vertical segment of the well 204 between a surface 236 and a heel 260. After the isolation device 202 passes the heel 260, the master control system 1220, via the pump management sub-system 1346, may cause the flow rate of the fluid to reduce to a second flow rate that is less than the first flow rate. The reduction in flow rate may cause the isolation device 202 to traverse at a lower velocity as the isolation device 202 enters a lateral segment of the well 204.

Referring to FIG. 2A, when the isolation device 202 approaches the target sleeve among the plurality of sleeves 208a, 208b, 208c, 208d, and 208e, the master control system 1220, via the pump management sub-system 1346, may cause the flow rate of the fluid to further reduce to a third flow rate that is less than the second flow rate. The reduction in flow rate when the isolation device 202 approaches the target sleeve may reduce the velocity of the isolation device 202 to facilitate engagement of the isolation device 202 with the target sleeve. The isolation device 202 may engage with the target sleeve, causing the target sleeve to shift from a closed position to an open position, thereby exposing a fracturing fluid port 210 for fracturing operations in a reservoir 250.

### Exemplary Use Case-Sensor Detection and Pressure Equalization

Referring to FIG. 2A, FIG. 2B, and FIG. 13, an exemplary use case for sensor-based detection during isolation device loading and pressure equalization is described. A master control system 1220 may coordinate automated fracturing operations for a well 204 in a subsurface formation. The master control system 1220 may include a processor 1210 and a memory 1230. The processor 1210 may execute a program 1250 stored in the memory 1230 to coordinate hydraulic fracturing operations.

With continued reference to FIG. 13, the master control system 1220 may be communicatively coupled to a wellhead access sub-system 1322 via a local network 1314. The wellhead access sub-system 1322 may include a processor 1324 and a memory 1326. The processor 1210 of the master control system 1220 may send a third communication to the processor 1324 of the wellhead access sub-system 1322 to cause a first pressure barrier device 232 to open. Responsive to the third communication, the processor 1324 may cause the first pressure barrier device 232 to open to allow loading of an isolation device 202 into a pressure equalization chamber 230 positioned between the first pressure barrier device 232 and a second pressure barrier device 234.

Referring to FIG. 2A and FIG. 2B, after the first pressure barrier device 232 opens, the isolation device 202 may be dropped or conveyed into the pressure equalization chamber 230. A chamber sensor 231 associated with the pressure equalization chamber 230 may detect the presence of the isolation device 202 within the pressure equalization chamber 230. The chamber sensor 231 may employ various sensor technologies to detect the presence of the isolation device 202.

With continued reference to FIG. 2A, in some cases, the chamber sensor 231 may employ magnetic sensor technology. Magnetic sensor technology may detect a magnetic signature or magnetic field associated with the isolation device 202 as the isolation device 202 enters the pressure equalization chamber 230. In some cases, the chamber sensor 231 may employ laser adapted sensor technology. Laser adapted sensor technology may use laser beams to detect the presence, position, or movement of the isolation device 202 within the pressure equalization chamber 230.

As further shown in FIG. 2A, in some cases, the chamber sensor 231 may employ radioactive marker technology. Radioactive marker technology may detect a radioactive marker associated with the isolation device 202. In some cases, the radioactive marker may include a Pipeline Inspection Point (PIP) tag. In some cases, the chamber sensor 231 may employ mechanical technology. Mechanical technology may use physical contact or displacement mechanisms to detect the presence of the isolation device 202.

Referring to FIG. 2A and FIG. 13, in some cases, the chamber sensor 231 may employ acoustic sensor technology. Acoustic sensor technology may detect acoustic signals or vibrations associated with the isolation device 202 entering or residing in the pressure equalization chamber 230. In some cases, the chamber sensor 231 may employ one or combinations of magnetic sensor technology, laser adapted sensor technology, radioactive marker technology, mechanical technology, acoustic sensor technology, radio frequency sensor(s), and optical sensor(s).

With continued reference to FIG. 2A and FIG. 13, the detection result from the chamber sensor 231 may be transmitted to the processor 1210 of the master control system 1220 and/or the processor 1324 of the wellhead access sub-system 1322. The processor 1210 may use the detection result to confirm that the isolation device 202 has been properly loaded into the pressure equalization chamber 230 before proceeding with subsequent operations.

As further shown in FIG. 2A and FIG. 2B, after the chamber sensor 231 detects the presence of the isolation device 202 in the pressure equalization chamber 230, the processor 1210 of the master control system 1220 may cause the first pressure barrier device 232 to close. The closing of the first pressure barrier device 232 seals the pressure equalization chamber 230 with the isolation device 202 inside. In some cases, the processor 1210 may send a communication to the processor 1324 of the wellhead access sub-system 1322 to cause the first pressure barrier device 232 to close while maintaining the second pressure barrier device 234 in a closed position.

Referring to FIG. 2A and FIG. 2B, after the first pressure barrier device 232 closes, a pressure in the pressure equalization chamber 230 may be equalized with a pressure in the wellhead assembly 290 below the second pressure barrier device 234. In some cases, the pressure equalization may occur via a snubbing loop, a test/equalization pump, or pressure equalization pipe 276 and associated valves 282 and 284 as shown in FIG. 2B. The pressure equalization chamber 230 may be equalized to a treating pressure that the well 204 is exposed to. The pressure equalization allows the isolation device 202 to be safely launched into the pressurized wellbore without a sudden pressure differential that could damage the isolation device 202 or cause uncontrolled movement of the isolation device 202.

With continued reference to FIG. 2A and FIG. 13, after the pressure has been equalized in the pressure equalization chamber 230 to the same pressure below the second pressure barrier device 234 and in the wellbore, the processor 1210 of the master control system 1220 may send a fourth communication to the processor 1324 of the wellhead access sub-system 1322 to cause the second pressure barrier device 234 to open. The fourth communication may include timing of opening the second pressure barrier device 234. Responsive to the fourth communication, the processor 1324 may cause the second pressure barrier device 234 to open to launch the isolation device 202 into the well 204.

As further shown in FIG. 2A, after the second pressure barrier device 234 opens, the isolation device 202 may be launched into the wellbore. The isolation device 202 may then be pumped downhole through a casing 212, past a heel 260, and through a lateral section toward a target sleeve where the isolation device 202 engages with a designated sleeve to open a corresponding fracturing fluid port 210 for fracturing operations in a reservoir 250.

### Exemplary Use Case—Variable Flow Rate Control During Transit

Referring to FIG. 2A and FIG. 13, an exemplary use case for variable flow rate control during isolation device transit through a well is described. A master control system 1220 may coordinate automated fracturing operations for a well 204 in a subsurface formation. The master control system 1220 may include a processor 1210 and a memory 1230. The processor 1210 may execute a program 1250 stored in the memory 1230 to coordinate hydraulic fracturing operations.

With continued reference to FIG. 13, the master control system 1220 may be communicatively coupled to a pump management sub-system 1346 via a local network 1314. The pump management sub-system 1346 may include a processor 1348 and a memory 1350. The pump management sub-system 1346 may control a pump 262a and a pump 262b to manage flow rates and pressures of fluids pumped into the well 204.

Referring to FIG. 2A, after an isolation device 202 is launched into a wellhead assembly 290 of the well 204, the processor 1210 of the master control system 1220 may send a communication to the processor 1348 of the pump management sub-system 1346 to cause the pump 262a and/or the pump 262b to pump a fluid into the wellhead assembly 290 at a first flow rate (“Rf-1”). The first flow rate Rf-1 may be selected to carry the isolation device 202 downhole through a vertical segment of the well 204 between a surface 236 and a heel 260. The first flow rate Rf-1 may convey the isolation device 202 through the vertical segment at a velocity suitable for traversing the vertical segment.

With continued reference to FIG. 2A, the processor 1210 may determine a first timing (“T1”) of the isolation device 202 passing the heel 260. In some cases, the first timing T1 may be determined based on a known distance from the wellhead assembly 290 to the heel 260 and the velocity of the isolation device 202 at the first flow rate Rf-1. In some cases, the first timing T1 may be determined based on real-time data received from a vertical sensor 211 positioned in the vertical segment of the well 204.

As further shown in FIG. 2A, after the isolation device 202 passes the heel 260, the pump management sub-system 1346 may cause the pump 262a and/or the pump 262b to reduce the flow rate of the fluid pumped into the wellhead assembly 290 to a second flow rate (“Rf-2”). The second flow rate Rf-2 may be less than the first flow rate Rf-1. The processor 1210 may cause the pump management sub-system 1346 to reduce the flow rate of the fluid prior to T1 at a first ramp rate until Rf-2 is reached at about T1. The reduction in flow rate from Rf-1 to Rf-2 may cause the isolation device 202 to traverse at a lower velocity than before passing the heel 260 as the isolation device 202 enters a lateral segment of the well 204. Having a Rf-2 less than or equal to Rf-1 can allow the isolation device to traverse the lateral section of the wellbore at a lower velocity than in the vertical section, permitting the isolation device to communicate effectively and reliably with each sleeve it passes en route to the target sleeve. Such effective and reliable communication enables the isolation device to count the sleeves properly, and therefore activate at the right time when approaching the target sleeve.

Referring to FIG. 2A, the processor 1210 may determine a second timing (“T2”) of the isolation device 202 approaching a target sleeve among a plurality of sleeves 208a, 208b, 208c, 208d, and 208e positioned along the lateral segment of the well 204. In the exemplary use case, the target sleeve may be a third sleeve 208c. In some cases, the second timing T2 may be determined based on a known distance from the heel 260 to the third sleeve 208c and the velocity of the isolation device 202 at the second flow rate Rf-2. In some cases, the second timing T2 may be determined based on real-time data received from one or more sensors 209a, 209b, 209c, 209d, and 209e positioned along the lateral segment of the well 204.

With continued reference to FIG. 2A, when the isolation device 202 approaches the third sleeve 208c, the pump management sub-system 1346 may cause the pump 262a and/or the pump 262b to further reduce the flow rate of the fluid pumped into the wellhead assembly 290 to a third flow rate (“Rf-3”). The third flow rate Rf-3 may be less than or equal to the second flow rate Rf-2. The processor 1210 may cause the pump management sub-system 1346 to reduce the flow rate of the fluid prior to T2 at a second ramp rate until Rf-3 is reached at T2. The reduction in flow rate from Rf-2 to Rf-3 when the isolation device 202 approaches the third sleeve 208c may reduce the velocity of the isolation device 202 to facilitate engagement of the isolation device 202 with the third sleeve 208c. The reduced velocity of the isolation device when engaging with the sleeve can reduce hard impact and water hammer effect at the engagement, which can cause damage to the structure and function of the isolation device and the sleeve, compromising the plugging effect of the isolation device and subsequent hydraulic fracturing operation.

As further shown in FIG. 2A, the isolation device 202 may engage with the third sleeve 208c upon reaching the third sleeve 208c. The engagement of the isolation device 202 with the third sleeve 208c may cause the third sleeve 208c to shift from a closed position to an open position. The shifting of the third sleeve 208c from the closed position to the open position may expose a fracturing fluid port 210 on the third sleeve 208c. The exposed fracturing fluid port 210 may permit fracturing fluid to exit a casing 212 and enter a reservoir 250 for hydraulic fracturing operations.

Referring to FIG. 2A and FIG. 13, after the isolation device 202 engages with the third sleeve 208c and the third sleeve 208c shifts to the open position, the processor 1210 of the master control system 1220 may cause the pump management sub-system 1346 to increase the flow rate of a fracturing fluid pumped into the wellhead assembly 290. The pump management sub-system 1346 may cause the pump 262a and/or the pump 262b to pump the fracturing fluid at a fourth flow rate (“Rf-4”) that is greater than the third flow rate Rf-3. The increase in flow rate from Rf-3 to Rf-4 after engagement may facilitate injection of the fracturing fluid into the reservoir 250 through the exposed fracturing fluid port 210 on the third sleeve 208c.

With continued reference to FIG. 2A, the isolation device 202 engaged with the third sleeve 208c may form a sealed plug preventing the fracturing fluid from flowing further downhole along the casing 212 past the third sleeve 208c. The fracturing fluid pumped at the fourth flow rate Rf-4 may exit the casing 212 through the exposed fracturing fluid port 210 on the third sleeve 208c with sufficient pressure to effect hydraulic fracturing of the reservoir 250. The fracturing fluid may create fractures and/or extend or enlarge existing fractures in the reservoir 250.

### Exemplary Use Case—Autonomous Fracturing with Dynamic Threshold Monitoring

Referring to FIG. 12 and FIG. 13, an exemplary use case for autonomous hydraulic fracturing with dynamic threshold monitoring is described. A master control system 1220 may coordinate automated fracturing operations for a well 204 in a subsurface formation. The master control system 1220 may include a processor 1210 and a memory 1230. The processor 1210 may execute a program 1250 stored in the memory 1230 to coordinate hydraulic fracturing operations without manual intervention.

With continued reference to FIG. 13, the master control system 1220 may be communicatively coupled to an isolation device retrieval sub-system 1328 via a local network 1314. The isolation device retrieval sub-system 1328 may include a processor 1330 and a memory 1332. The processor 1210 of the master control system 1220 may send a communication to the processor 1330 of the isolation device retrieval sub-system 1328 to cause an isolation device 202 to be retrieved from a storage location.

As further shown in FIG. 13, responsive to the communication from the processor 1210, the processor 1330 of the isolation device retrieval sub-system 1328 may cause the isolation device 202 to be retrieved and configured for a designated sleeve among a plurality of sleeves 208a, 208b, 208c, 208d, and 208e positioned along a lateral segment of the well 204. The configuration of the isolation device 202 may include specifying a target sleeve to be paired with the isolation device 202. In some cases, the configuration may be performed at the storage location before the isolation device 202 is conveyed to a wellhead assembly 290.

Referring to FIG. 2A, FIG. 2B, and FIG. 13, after the isolation device 202 is retrieved and configured, the master control system 1220 may cause the isolation device 202 to be conveyed to the wellhead assembly 290 via an isolation device delivery sub-system 1340. The master control system 1220 may be communicatively coupled to a wellhead access sub-system 1322 via the local network 1314. The wellhead access sub-system 1322 may include a processor 1324 and a memory 1326.

With continued reference to FIG. 2A and FIG. 2B, the processor 1210 of the master control system 1220 may send a communication to the processor 1324 of the wellhead access sub-system 1322 to cause a first pressure barrier device 232 to open. Responsive to the communication, the processor 1324 may cause the first pressure barrier device 232 to open to allow loading of the isolation device 202 into a pressure equalization chamber 230 positioned between the first pressure barrier device 232 and a second pressure barrier device 234.

As further shown in FIG. 2A and FIG. 2B, after the isolation device 202 is loaded into the pressure equalization chamber 230, the processor 1210 may cause the first pressure barrier device 232 to close. A chamber sensor 231 associated with the pressure equalization chamber 230 may detect the presence of the isolation device 202 within the pressure equalization chamber 230. In some cases, a pressure in the pressure equalization chamber 230 may be equalized with a pressure in the wellhead assembly 290 below the second pressure barrier device 234 via a snubbing loop, a test/equalization pump, or pressure equalization pipe 276 and associated valves 282 and 284 as shown in FIG. 2B.

Referring to FIG. 2A and FIG. 13, after the pressure has been equalized in the pressure equalization chamber 230, the processor 1210 of the master control system 1220 may send a communication to the processor 1324 of the wellhead access sub-system 1322 to cause the second pressure barrier device 234 to open. Responsive to the communication, the processor 1324 may cause the second pressure barrier device 234 to open to launch the isolation device 202 into the well 204.

With continued reference to FIG. 2A, after the isolation device 202 is launched into the well 204, the master control system 1220 may receive real-time data from one or more sensors positioned along the well 204. A first sensor 209a associated with a first stage 206a, a second sensor 209b associated with a second stage 206b, a third sensor 209c associated with a third stage 206c, a fourth sensor 209d associated with a fourth stage 206d, and a fifth sensor 209e associated with a fifth stage 206e or other sensors may provide real-time data to the master control system 1220. The real-time data may include pressure data, flow rate data, temperature data, or combinations thereof.

As further shown in FIG. 13, the processor 1210 of the master control system 1220 may dynamically determine whether the real-time data received from the sensors 209a, 209b, 209c, 209d, and 209e fall outside of one or more thresholds. The one or more thresholds may be user-configurable parameters stored in the memory 1230 of the master control system 1220. In some cases, the user-configurable parameters may be related to pressure bands and ramp rates. The pressure bands may define acceptable ranges of pressure during various phases of the hydraulic fracturing operation. The ramp rates may define acceptable rates of increase or decrease in flow rate and/or pressure over time.

Referring to FIG. 2A and FIG. 13, responsive to determining that the real-time data fall outside of the one or more thresholds, the processor 1210 of the master control system 1220 may dynamically change a ramp-rate of one or more pumps 262a and 262b. The master control system 1220 may be communicatively coupled to a pump management sub-system 1346 via the local network 1314. The pump management sub-system 1346 may include a processor 1348 and a memory 1350. The processor 1210 may send a communication to the processor 1348 of the pump management sub-system 1346 to cause the pump 262a and/or the pump 262b to adjust the ramp-rate.

With continued reference to FIG. 2A, the dynamic changing of the ramp-rate may include causing the pump 262a and/or the pump 262b to ramp up a flow rate and/or a pressure of a fluid after launching the isolation device 202. The ramping up of the flow rate and/or the pressure after launching may convey the isolation device 202 through a vertical segment of the well 204 between a surface 236 and a heel 260 at a velocity suitable for traversing the vertical segment.

As further shown in FIG. 2A, the dynamic changing of the ramp-rate may include causing the pump 262a and/or the pump 262b to ramp down the flow rate and/or the pressure of the fluid after the isolation device 202 approaches the heel 260. The ramping down of the flow rate and/or the pressure after the isolation device 202 approaches the heel 260 may reduce the velocity of the isolation device 202 as the isolation device 202 enters the lateral segment of the well 204.

Referring to FIG. 2A, the dynamic changing of the ramp-rate may include causing the pump 262a and/or the pump 262b to ramp down the flow rate and/or the pressure of the fluid when the isolation device 202 is in proximity to the target sleeve. The reduction in flow rate and/or pressure when the isolation device 202 approaches the target sleeve may reduce the velocity of the isolation device 202 to facilitate engagement of the isolation device 202 with the target sleeve.

With continued reference to FIG. 2A, the isolation device 202 may engage with the target sleeve upon reaching the target sleeve. The engagement of the isolation device 202 with the target sleeve may cause the target sleeve to shift from a closed position to an open position, thereby exposing a fracturing fluid port 210 on the target sleeve. The exposed fracturing fluid port 210 may permit fracturing fluid to exit a casing 212 and enter a reservoir 250 for hydraulic fracturing operations.

As further shown in FIG. 2A and FIG. 13, after the isolation device 202 engages with the target sleeve, the processor 1210 of the master control system 1220 may continue to receive real-time data from the sensors 209a, 209b, 209c, 209d, and 209e or other sensors. The processor 1210 may dynamically determine whether the real-time data fall outside of the one or more thresholds during fracturing operations. Responsive to determining that the real-time data fall outside of the one or more thresholds, the processor 1210 may cause the pump management sub-system 1346 to dynamically change the ramp-rate of the pump 262a and/or the pump 262b to optimize fracturing operations in the reservoir 250.

Referring to FIG. 13, the dynamic changing of the ramp-rate may include causing the pump 262a and/or the pump 262b to ramp up the flow rate and/or the pressure of a fracturing fluid after the isolation device 202 has engaged with the target sleeve. The ramping up of the flow rate and/or the pressure after engagement may facilitate injection of the fracturing fluid into the reservoir 250 through the exposed fracturing fluid port 210. In some cases, the user-configurable thresholds may be adjusted remotely via a user device 1302 communicatively coupled to the master control system 1220 through a network 1304.

### Embodiments of This Disclosure

In one or more embodiments, this disclosure may be susceptible to various modifications and alternative forms, such as the following embodiments:
E1. A method for performing automated hydraulic fracturing operation to a subsurface formation, the method comprising: (I) providing one or more wells in the subsurface formation, each well comprising a plurality of sleeves; (II) providing a hydraulic fracturing system (“HFS”) comprising a first processor; (III) providing an isolation device designated for a target sleeve among the plurality of sleeves in a designated well among the one or more wells to a launch location in proximity to a wellhead of the designated well; (IV) after step (III), causing, by the first processor and/or a third processor, delivery of the isolation device into the designated well; and (V) after step (IV), pumping a fluid into the well after the isolation device, thereby conveying the isolation device to the designated sleeve in the designated well.
E2. The method of E1, wherein step (III) comprises causing, by the first processor and/or a second processor, the isolation device to be conveyed to the launch location.
E3. The method of E1 or E2, wherein step (V) comprises causing, by the first processor and/or a fourth processor, one or more pumps to pump the fluid into the well.
E4. The method of any of E1 to E3, wherein the isolation device is programmed to engage with the target sleeve.
E5. The method of any of E1 to E4, wherein the HFS comprises an automated isolation device delivery sub-system (“IDDS”), the IDDS comprises the second processor, and step (III) comprises: (IIIa) sending, by the first processor, a first communication to the second processor; and (IIIb) causing, by the second processor, the isolation device to be conveyed to the launch location of the designated well responsive to the first communication.
E6. The method of E5, wherein the first communication comprises timing of the arrival of the isolation device at the launch location.
E7. The method of E5 or E6, wherein the HFS comprises an automated isolation device retrieval sub-system (“IDRS”), the IDRS comprises a fifth processor, and step (III) further comprises: (IIIc) sending, by the first processor, a second communication to the fifth processor; and (IIId) causing, by the fifth processor, the isolation device to be retrieved and conveyed to the IDDS responsive to the second communication.
E8. The method of E7, wherein the second communication comprises timing of the arrival of the isolation device at the IDDS.
E9. The method of E7 or E8, wherein step (IIId) further comprises: (IIId.1) causing, by the fifth processor, the isolation device to be configured to engage with the target sleeve.
E10. The method of any of E7 to E9, wherein the second processor and the fifth processor are one and the same.
E11. The method of any of E1 to E10, wherein: the HFS comprises a well access sub-system (“WASS”); step (IV) is performed using the WASS; and the WASS comprises a first pressure barrier device.
E12. The method of E11, wherein the WASS further comprises a second pressure barrier device.
E13. The method of E12, wherein the WASS further comprises a pressure equalization chamber between the first pressure barrier device and the second pressure barrier device.
E14. The method of any of E11 to E13, wherein the first pressure barrier device and/or the second barrier device comprises: (i) a gate valve; or (ii) a ball valve; or (iii) a flapper valve; or (iv) a blind ram barrier; or (v) a shear ram barrier; or (vi) a pressure barrier component inside an isolation conveyor apparatus used to inject the isolation device into the well; or (vii) a sealable and un-sealable pressure barrier chamber enclosure; or (viii) any combination of two or more of (i), (ii), (iii), (iv), (v), (vi), and (vii).
E15. The method of any of E11 to E14, wherein at least one of the first pressure barrier device and the second pressure barrier device is actuated by an actuator.
E16. The method of E15, wherein the actuator is remotely controllable electrically and/or hydraulically.
E17. The method of any of E11 to E16, wherein the WASS comprises the wellhead of the designated well.
E18. The method of any of E11 to E17, wherein at least one of the first pressure barrier device and the second pressure barrier device is a flapper valve.
E19. The method of any of E11 to E18, wherein the WASS comprises a lubricator which is optionally pressurizable.
E20. The method of any of E11 to E17, wherein the WASS comprises an isolation device conveyor apparatus used to inject the isolation device into the well.
E21. The method of any of E11 to E20, wherein at least one of the first pressure barrier device and the second pressure barrier device is free of an actuator, and opens with force from a passing isolation device and closes via spring tension and/or well pressure/flow.
E22. The method of any of E11 to E21, wherein step (IVb) comprises: the WASS comprises the third processor; step (IV) comprises: (IVc) sending, by the first processor, a third communication to the third processor; and (IVd) causing, by the third processor, the isolation device to be launched into the well responsive to the third communication.
E23. The method of any of E13 to E22, wherein step (IV) comprises: (IVa) causing, by the first processor and/or a third processor, the first pressure barrier device associated with the designated well to open to allow loading of the isolation device into the pressure equalization chamber associated with the designated well; and (IVb) after step (IVa), causing, by the first processor and/or the third processor, the second pressure barrier device associated with the designated well to open to launch the isolation device into the designated well.
E24. The method of E23, wherein: the WASS comprises the third processor; step (IVa) comprises: (IVa.1) sending, by the first processor, a third communication to the third processor; and (IVa.2) causing, by the third processor, the first pressure barrier device to open responsive to the third communication; and step (IVb) comprises: (IVb.1) sending, by the first processor, a fourth communication to the third processor; and (IVb.2) causing, by the third processor, the second pressure barrier device to open responsive to the fourth communication.
E25. The method of E24, wherein: the third communication comprises timing of opening the first pressure barrier device; and the fourth communication comprises timing of opening the second pressure barrier device.
E26. The method of E23 or E25, wherein the method further comprises, after step (IVa) and before step (IVb): (IV.1) causing, by the first processor and/or the third processor, the first pressure barrier device to close.
E27. The method of E23 or E26, wherein the method further comprises, after step (IVa) and before step (IVb): (IV.2) detecting, by a sensor associated with the pressure equalization chamber, the presence of the isolation device in the pressure equalization chamber; and (IV.3) optionally transmitting the detection result to the first processor and/or the third processor.
E28. The method of E26 or E27, wherein the method further comprises, after step (IVa) and before step (IVb): (V) equalizing a pressure in the pressure equalization chamber with a pressure in the wellhead below the second pressure barrier device.
E29. The method of any of E1 to E28, wherein in step (V), the fluid is pumped into the well an inlet pipe having an inlet axis, and the inlet axis intersects with a wellhead pipe axis below the second pressure barrier device to form an angle theta in a range from 15° to 75°.
E30. The method of E29, wherein theta ranges from 30° to 60°.
E31. The method of E30, wherein theta is about 45°.
E32. The method of any of E1 to E31, wherein: the HFS comprises a pump management sub-system (“PMSS”), the PMSS comprises the fourth processor and the one or more pumps; and step (V) comprises: (Va) sending, by the first processor, a fifth communication to the fourth processor; and (Vb) causing, by the fourth processor, a flow rate and/or pressure of the fluid pumped into the wellhead to change responsive to the fifth communication.
E33. The method of E32, wherein the fifth communication comprises: (i) a target flow rate and/or target pressure of the fluid; or (ii) a timing of the reaching the target flow rate and/or target pressure; or (iii) a ramp rate of the flow rate and/or pressure of the fluid; or (iv) any combination of two or more of (i), (ii), and (iii).
E34. The method of E32 or E33, wherein step (Vb) comprises one or more of the following: (Vb.1) causing the flow rate and/or the pressure of the fluid pumped into the wellhead to reduce before the isolation device passes a heel of the well such that the isolation device traverses at a lower velocity than before passing the heel; (Vb.2) causing the flow rate and/or the pressure of the fluid pumped into the wellhead to reduce when the isolation device approaches the target sleeve to reduce the velocity of the isolation device when engaging with the target sleeve; and (Vb.3) causing the flow rate and/or the pressure of a fracturing fluid pumped into the wellhead to increase after fractures have been initiated in the subsurface formation.
E35. The method of any of E32 to E34, wherein the method further comprises: (VII) receiving, by the first processor, real-time data from one or more sensors in the hydraulic fracturing system and/or the one or more wells; (VIII) dynamically determining, by the first processor, whether the real-time data fall outside of one or more thresholds; and (IX) responsive to determining that the real-time data fall outside of the one or more thresholds, changing, by the first processor, a ramp-rate of the one or more pumps.
E36. The method of E35, wherein step (IX) comprises causing, by the first processor, the one or more pumps to: (IXa) ramp up a flow rate and/or a pressure of the fluid after launching the isolation device in step (IV); (IXb) ramp down the flow rate and/or the pressure of the fluid after the isolation device approaches a heel of the well; (IXc) ramp down the flow rate and/or the pressure of the fluid when the isolation device is in proximity to the target sleeve to facilitate engagement of the isolation device with the target sleeve; and (IXd) ramp up the flow rate and/or the pressure of the fluid after the isolation device has engaged with the target sleeve.
E37. The method of any of E32 to E36, further comprising: (X) engaging the isolation device with the target sleeve; (XI) after step (X), shifting the target sleeve from a closed position to an open position to expose an injection port on the sleeve; and (XII) after step (XI), causing, by the first processor, a fracturing fluid to be injected into the subsurface formation via the exposed injection port.
E38. The method of E37, wherein step (XII) comprises: (XIIa) sending, by the first processor, a sixth communication to the fourth processor; and (XIIb) causing, by the fourth processor, the one or more pumps to pump the fracturing fluid into the designated well.
E39. The method of E38, wherein the sixth communication comprises: (i) type of the fracturing fluid; or (ii) flow rate and/or pressure of the fracturing fluid; or (iii) ramp rate of the flow rate and/or the pressure of the fracturing fluid; or (iv) the time to pump at a specified flow rate such that a specific volume is pumped into the well; or (v) any combination of two or more of (i), (ii), (iii), and (iv).
E40. The method of any of E1 to E39, wherein the HFS further comprises a fracturing fluid blending sub-system (“FFBS”), the FFBS comprises a sixth processor, and the method further comprises: (XIII) determining, by the first processor, a composition of the fracturing fluid; (XIV) causing, by the first processor and/or the sixth processor, the fracturing fluid having the composition to be made in and supplied from the FFBS.
E41. The method of E40, wherein step (XIV) comprises: (XIVa) sending, by the first processor, a seventh communication to the sixth processor; (XIVb) causing, by the sixth processor, the fracturing fluid having the composition to be made in and supplied from the FFBS.
E42. The method of E41, wherein the seventh communication comprises one or more of: type(s) of proppant particulates; amount(s) and/or concentration(s) of proppant particulates; amount(s) and/or concentration(s) of chemical additives; timing of making the fracturing fluid; and timing of supplying the fracturing fluid.
E43. The method of E42, wherein at least two differing types of proppant particulates are used in the hydraulic fracturing operation performed via the one or more wells.
E44. The method of E43, wherein both sand proppant particulates and LWP particulates are used.
E45. The method of E44, wherein the LWP particulates comprises petroleum coke proppant particulates.
E46. The method of any of E41 to E45, wherein the HFS further comprises a proppant particulate retrieval sub-system (“PPRS”), and the method further comprises: (XV) determining, by the first processor, a type and quantity of proppant particulates to be supplied to the FFBS; and (XVI) causing, by the first processor, the PPRS to supply the proppant particulates at the quantity to the FFBS.
E47. The method of E46, wherein the PPRS comprises a seventh processor, and step (XVI) comprises: (XVIa) sending, by the first processor, an eighth communication to the seventh processor; (XVIb) causing, by the seventh processor, the proppant particulates at the quantity to be supplied to the FFBS.
E48. The method of any of E1 to E47, wherein the HFS further comprises one or more fluid cycling conduits each cycling and supplying a fluid to the one or more pumps.
E49. The method of any of E37 to E48, wherein during step (XII), no more than ten sleeves among the plurality of sleeves receiving the fracturing fluid in the designated well are in open position, permitting the fracturing fluid to be injected into the subsurface formation through exposed injection ports therein.
E50. The method of E49, wherein only one sleeve among the plurality of sleeves in the designated well receiving the fracturing fluid is in open position, permitting the fracturing fluid to be injected into the subsurface formation through the exposed injection port.
E51. The method of any of E1 to E50, wherein in step (I), two or more wells are provided, and the automated hydraulic fracturing is performed to the two or more wells simultaneously.
E52. The method of E51, wherein the first processor in step (II) controls the automated hydraulic fracturing of the two or more wells.
E53. The method of any of E1 to E52, wherein at least two of the IDDS, the IDRS, the WASS, the PMSS, the FFBS, and the PPRS are operated by different service providers.
E54. The method of E53, wherein at least two of the first processor, the second processor, the third processor, the fourth processor, the fifth processor, the sixth processor, and the seventh processor are separate from each other.
E55. The method of E54, wherein the first processor controls the second processor, the third processor, the fourth processor, the fifth processor, the sixth processor, and the seventh processor.
E56. A method for performing automated hydraulic fracturing operation(s) to a subsurface formation, the method comprising: (I) providing one or more wells in the subsurface formation, each well comprising a plurality of sleeves; (II) providing a hydraulic fracturing system (“HFS”) comprising a first processor; (III) after step (II), causing, by the first processor, a first pressure barrier device associated with a designated well among the one or more wells to open to allow loading of an isolation device into a pressure equalization chamber associated with the designated well; (III.2) after step (III), detecting, by a sensor associated with the pressure equalization chamber, the presence of the isolation device; and (IV) after step (III.2), causing, by the first processor, a second pressure barrier device associated with the designated well to open to launch the isolation device into the designated well.
E57. The method of E56, wherein the sensor associated with the pressure equalization chamber employs magnetic sensor technology, laser adapted sensor technology, radioactive marker technology, mechanical technology, acoustic sensor technology, radio frequency sensor, optical sensor, or combinations thereof to detect the presence of the isolation device.
E58. The method of E56 or E57, further comprising, after step (III) and before step (III.2), causing, by the first processor, the first pressure barrier device to close and sealing the pressure equalization chamber.
E59. The method of any of E56 to E58, further comprising, after step (III.2) and before step (IV), equalizing a pressure in the pressure equalization chamber with a pressure in the wellhead below the second pressure barrier device.
E60. A method for performing automated hydraulic fracturing operation(s) to a subsurface formation, the method comprising: (I) providing one or more wells in the subsurface formation, each well comprising a plurality of sleeves; (II) providing a hydraulic fracturing system (“HFS”) comprising a first processor; (III) providing an isolation device designated for a target sleeve among the plurality of sleeves in a designated well among the one or more wells to a launch location in proximity to a wellhead of the designated well; (IV) after step (III), causing, by the first processor, a first pressure barrier device associated with the designated well to open to allow loading of the isolation device into a pressure equalization chamber associated with the designated well; (IV.1) after step (IV), causing, by the first processor, the first pressure barrier device associated with the designated well to close, while maintaining a second pressure barrier device downhole of the pressure equalization chamber in closed position; (IV.2) equalizing a pressure in the pressure equalization chamber with a pressure in the wellhead below the second pressure barrier device; (V) after step (IV.2), causing, by the first processor, the second pressure barrier device in the wellhead associated with the designated well to open to launch the isolation device into the designated well.
E61. The method of E60, further comprising: (VI) after step (V), causing, by the first processor, one or more pumps to pump a fluid into the wellhead after the isolation device, thereby conveying the isolation device to the target sleeve in the designated well, and temporarily decreasing a flow rate and/or a pressure of the fluid when the isolation device is in proximity to the target sleeve to facilitate engagement of the isolation device with the target sleeve.
E62. The method of E60 or E61, further comprising, after step (IV.1) and before step (IV.2), detecting, by a sensor associated with the pressure equalization chamber, the presence of the isolation device in the pressure equalization chamber, wherein the sensor employs magnetic sensor technology, laser adapted sensor technology, radioactive marker technology, mechanical technology, acoustic sensor technology, radio frequency sensor, optical sensor, or combinations thereof.
E63. The method of any of E60 to E62, wherein the isolation device is programmed to pair with the target sleeve before arriving at the wellhead, at the wellhead, or after entering the wellhead, and wherein the programming comprises specifying the target sleeve to be paired with the isolation device.
E64. A method for performing hydraulic fracturing operation(s) to a subsurface formation via a well comprising a vertical segment, a heel downhole of the vertical segment, and a lateral segment downhole of the heel, the lateral segment comprising a plurality of sleeves, the method comprising: (A) launching an isolation device into a wellhead of the well; (B) after step (A), pumping a fluid into the wellhead at a first flow rate (“Rf-1”), thereby carrying the isolation device downhole through the vertical segment; (C) after the isolation device passes the heel, pumping the fluid into the wellhead at a second flow rate (“Rf-2”); (D) when the isolation device approaches a target sleeve among the plurality of sleeves, pumping the fluid into the wellhead at a third flow rate (“Rf-3”), wherein Rf-3≤Rf-2; and (E) engaging the isolation device with the target sleeve.
E65. The method of E64, wherein Rf-2≤Rf-1.
E66. The method of E65, further comprising, between step (B) and step (C): (Ba) determining, by a first processor, a first timing (“T1”) of the isolation device passing the heel; and (Bb) causing, by the first processor, a pump management sub-system (“PMSS”) to reduce a flow rate of the fluid prior to T1 at a first ramp rate until Rf-2 is reached at about T1.
E67. The method of any of E64 to E66, further comprising between step (C) and step (D): (Ca) determining a second timing (“T2”), by the first processor, of the isolation device approaching the target sleeve; and (Cb) causing, by the first processor, the pump management sub-system to reduce a flow rate of the fluid prior to T2 at a second ramp rate until Rf-3 is reached at T2.
E68. The method of any of E64 to E67, further comprising: (A-1) before step (A), programming the isolation device for engaging with the target sleeve.
E69. The method of E68, wherein programming the isolation device in step (A-1) is caused by a processor.
E70. The method of any of E64 to E69, further comprising: (F) counting the sleeves the isolation device passes, by the isolation device, as the isolation device traverses through the lateral segment.
E71. The method of any of E64 to E70, further comprising: (G) shifting the target sleeve from a closed position to an open position, thereby exposing an injection port in the target sleeve; (H) pumping a fracturing fluid into the wellhead through the well and through the injection port into the subsurface formation, thereby creating fractures in the subsurface formation.
E72. The method of E71, wherein (H) comprises pumping the fracturing fluid at a fourth flow rate (“Rf-4”), wherein Rf-4>Rf-3.
E73. The method of E71 or E72, wherein the method further comprises, between step (G) and step (H): (Ga) determining, by a processor, a fracture has been initiated in the subsurface formation; and (Gb) after step (Ga), causing, by the processor, a pump management sub-system to increase a flow rate of the fracturing fluid at a third ramp rate until Rf-4 is reached.
E74. The method of any of E64 to E73, further comprising: (I) during the course of step (A), pumping the fluid into the wellhead at a fifth flow rate (“Rf-5”), wherein Rf-5≤Rf-1.
E75. The method of E74, further comprising, before step (A): (Za) determining a fifth timing (“T5”), by a processor, of the isolation device entering into the wellhead; (Zb) causing, by the processor, a pump management sub-system (“PMSS”) to decrease a flow rate of the fluid at a fourth ramp rate until Rf-5 is reached.
E76. The method of E68 or E69, wherein a first total time (“TT-1”) for performing all steps (A-1), (A), (B), (C), (D), and (E) is no more than 60 minutes.
E77. The method of E76, wherein TT-1 is no more than 30 minutes.

E78. The method of any of E71 to E73, wherein a second total time (“TT-2”) for performing all steps (A-1), (A), (B), (C), (D), (E), (F), and (G) is no more than 60 minutes.
E79. The method of E78, wherein TT-2 is no more than 30 minutes.
E80. A method for autonomously hydraulically fracturing a subsurface formation, comprising: causing, by one or more processors, an isolation device to be retrieved and to be configured for a designated sleeve; causing, by the one or more processors, the isolation device to be launched into a well; receiving, by the one or more processors, real-time data from one or more sensors; dynamically determining, by the one or more processors, whether the real-time data fall outside of one or more thresholds; and responsive to determining that the real-time data fall outside of the one or more thresholds, dynamically changing, by the one or more processors, a ramp-rate of one or more pumps.

Although embodiments herein are described with respect to the unconventional hydrocarbon-containing product extraction, one skilled in the art will readily recognize that the methods, systems and equipment described herein are also suitable for application in other areas. For example, such applications may comprise recovery from conventional wells, among other applications within hydrocarbon management.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of this disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, this disclosure comprises all alternatives, modifications, and equivalents falling within the true spirit and scope of the appended claims.

What is claimed is:

1. A method for performing automated hydraulic fracturing operation to a subsurface formation, the method comprising:
(I) providing one or more wells in the subsurface formation, each well comprising a plurality of sleeves;
(II) providing a hydraulic fracturing system (“HFS”) comprising a first processor;
(III) providing an isolation device designated for a target sleeve among the plurality of sleeves in a designated well among the one or more wells to a launch location in proximity to a wellhead of the designated well;
(IV) after step (III), causing, by the first processor and/or a third processor, delivery of the isolation device into the designated well; and
(V) after step (IV), pumping a fluid into the well after the isolation device, thereby conveying the isolation device to the designated sleeve in the designated well.

2. The method of claim 1, wherein step (III) comprises causing, by the first processor and/or a second processor, the isolation device to be conveyed to the launch location.

3. The method of claim 1, wherein step (V) comprises causing, by the first processor and/or a fourth processor, one or more pumps to pump the fluid into the well.

4. The method of claim 1, wherein the isolation device is programmed to engage with the target sleeve.

5. The method of claim 2, wherein the HFS comprises an automated isolation device delivery sub-system (“IDDS”), the IDDS comprises the second processor, and step (III) comprises:
(IIIa) sending, by the first processor, a first communication to the second processor; and
(IIIb) causing, by the second processor, the isolation device to be conveyed to the launch location of the designated well responsive to the first communication.

6. The method of claim 5, wherein the first communication comprises timing of the arrival of the isolation device at the launch location.

7. The method of claim 5, wherein the HFS comprises an automated isolation device retrieval sub-system (“IDRS”), the IDRS comprises a fifth processor, and step (III) further comprises:
(IIIc) sending, by the first processor, a second communication to the fifth processor; and
(IIId) causing, by the fifth processor, the isolation device to be retrieved and conveyed to the IDDS responsive to the second communication.

8. The method of claim 7, wherein the second communication comprises timing of the arrival of the isolation device at the IDDS.

9. The method of claim 7, wherein step (IIId) further comprises:
(IIId.1) causing, by the fifth processor, the isolation device to be configured to engage with the target sleeve.

10. The method of claim 7, wherein the second processor and the fifth processor are one and the same.

11. The method of claim 7, wherein:
the HFS comprises a well access sub-system (“WASS”);
step (IV) is performed using the WASS; and
the WASS comprises a first pressure barrier device.

12. The method of claim 11, wherein the WASS further comprises a second pressure barrier device.

13. The method of claim 12, wherein the WASS further comprises a pressure equalization chamber between the first pressure barrier device and the second pressure barrier device.

14. The method of claim 11, wherein the first pressure barrier device and/or the second barrier device comprises:
(i) a gate valve; or
(ii) a ball valve; or
(iii) a flapper valve; or
(iv) a blind ram barrier; or
(v) a shear ram barrier; or
(vi) a pressure barrier component inside an isolation conveyor apparatus used to inject the isolation device into the well; or
(vii) a sealable and un-sealable pressure barrier chamber enclosure; or
(viii) any combination of two or more of (i), (ii), (iii), (iv), (v), (vi), and (vii).

15. The method of claim 11, wherein at least one of the first pressure barrier device and the second pressure barrier device is actuated by an actuator.

16. The method of claim 15, wherein the actuator is remotely controllable electrically and/or hydraulically.

17. The method of claim 11, wherein the WASS comprises the wellhead of the designated well.

18. The method of claim 11, wherein at least one of the first pressure barrier device and the second pressure barrier device is a flapper valve.

19. The method of claim 11, wherein the WASS comprises a lubricator which is optionally pressurizable.

20. The method of claim 11, wherein the WASS comprises an isolation device conveyor apparatus used to inject the isolation device into the well.

21. The method of claim 11, wherein at least one of the first pressure barrier device and the second pressure barrier device is free of an actuator, and opens with force from a passing isolation device and closes via spring tension and/or well pressure/flow.

22. The method of claim 11, wherein:
the WASS comprises the third processor;
step (IV) comprises:
(IVc) sending, by the first processor, a third communication to the third processor; and
(IVd) causing, by the third processor, the isolation device to be launched into the well responsive to the third communication.

23. The method of claim 22, wherein step (IV) comprises:
(IVa) causing, by the first processor and/or a third processor, the first pressure barrier device associated with the designated well to open to allow loading of the isolation device into the pressure equalization chamber associated with the designated well; and
(IVb) after step (IVa), causing, by the first processor and/or the third processor, the second pressure barrier device associated with the designated well to open to launch the isolation device into the designated well.

24. The method of claim 22, wherein:
the WASS comprises the third processor;
step (IVa) comprises:
(IVa.1) sending, by the first processor, a third communication to the third processor; and
(IVa.2) causing, by the third processor, the first pressure barrier device to open responsive to the third communication; and
step (IVb) comprises:
(IVb.1) sending, by the first processor, a fourth communication to the third processor; and
(IVb.2) causing, by the third processor, the second pressure barrier device to open responsive to the fourth communication.

25. The method of claim 24, wherein:
the third communication comprises timing of opening the first pressure barrier device; and
the fourth communication comprises timing of opening the second pressure barrier device.

26. The method of claim 22, wherein the method further comprises, after step (IVa) and before step (IVb):
(IV.1) causing, by the first processor and/or the third processor, the first pressure barrier device to close.

27. The method of claim 22, wherein the method further comprises, after step (IVa) and before step (IVb):
(IV.2) detecting, by a sensor associated with the pressure equalization chamber, the presence of the isolation device in the pressure equalization chamber; and
(IV.3) optionally transmitting the detection result to the first processor and/or the third processor.

28. The method of claim 26, wherein the method further comprises, after step (IVa) and before step (IVb):
(V) equalizing a pressure in the pressure equalization chamber with a pressure in the wellhead below the second pressure barrier device.

29. The method of claim 12, wherein in step (V), the fluid is pumped into the well via an inlet pipe having an inlet axis, and the inlet axis intersects with a wellhead pipe axis below the second pressure barrier device to form an angle theta in a range from 15° to 75°.

30. The method of claim 29, wherein theta ranges from 30° to 60°.

31. The method of claim 30, wherein theta is about 45°.

32. The method of claim 11, wherein:
the HFS comprises a pump management sub-system (“PMSS”), the PMSS comprises a fourth processor and one or more pumps; and
step (V) comprises:
(Va) sending, by the first processor, a fifth communication to the fourth processor; and
(Vb) causing, by the fourth processor, a flow rate and/or pressure of the fluid pumped into the wellhead to change responsive to the fifth communication.

33. The method of claim 32, wherein the fifth communication comprises:
(i) a target flow rate and/or target pressure of the fluid; or
(ii) a timing of the reaching the target flow rate and/or target pressure; or
(iii) a ramp rate of the flow rate and/or pressure of the fluid; or
(iv) any combination of two or more of (i), (ii), and (iii).

34. The method of claim 32, wherein step (Vb) comprises one or more of the following:
(Vb.1) causing the flow rate and/or the pressure of the fluid pumped into the wellhead to reduce before the isolation device passes a heel of the well such that the isolation device traverses at a lower velocity than before passing the heel;
(Vb.2) causing the flow rate and/or the pressure of the fluid pumped into the wellhead to reduce when the isolation device approaches the target sleeve to reduce the velocity of the isolation device when engaging with the target sleeve; and
(Vb.3) causing the flow rate and/or the pressure of a fracturing fluid pumped into the wellhead to increase after fractures have been initiated in the subsurface formation.

35. The method of claim 32, wherein the method further comprises:
(VII) receiving, by the first processor, real-time data from one or more sensors in the hydraulic fracturing system and/or the one or more wells;
(VIII) dynamically determining, by the first processor, whether the real-time data fall outside of one or more thresholds; and
(IX) responsive to determining that the real-time data fall outside of the one or more thresholds, changing, by the first processor, a ramp-rate of the one or more pumps.

36. The method of claim 35, wherein step (IX) comprises causing, by the first processor, the one or more pumps to:
(IXa) ramp up a flow rate and/or a pressure of the fluid after launching the isolation device in step (IV);
(IXb) ramp down the flow rate and/or the pressure of the fluid after the isolation device approaches a heel of the well;
(IXc) ramp down the flow rate and/or the pressure of the fluid when the isolation device is in proximity to the target sleeve to facilitate engagement of the isolation device with the target sleeve; and
(IXd) ramp up the flow rate and/or the pressure of the fluid after the isolation device has engaged with the target sleeve.

37. The method of claim 32, further comprising:
(X) engaging the isolation device with the target sleeve;
(XI) after step (X), shifting the target sleeve from a closed position to an open position to expose an injection port on the sleeve; and
(XII) after step (XI), causing, by the first processor, a fracturing fluid to be injected into the subsurface formation via the exposed injection port.

38. The method of claim 37, wherein step (XII) comprises:
(XIIa) sending, by the first processor, a sixth communication to the fourth processor; and
(XIIb) causing, by the fourth processor, the one or more pumps to pump the fracturing fluid into the designated well.

39. The method of claim 38, wherein the sixth communication comprises:
(i) type of the fracturing fluid; or
(ii) flow rate and/or pressure of the fracturing fluid; or
(iii) ramp rate of the flow rate and/or the pressure of the fracturing fluid; or
(iv) the time to pump at a specified flow rate such that a specific volume is pumped into the well; or
(v) any combination of two or more of (i), (ii), (iii), and (iv).

40. The method of claim 32, wherein the HFS further comprises a fracturing fluid blending sub-system (“FFBS”), the FFBS comprises a sixth processor, and the method further comprises:
(XIII) determining, by the first processor, a composition of the fracturing fluid;
(XIV) causing, by the first processor and/or the sixth processor, the fracturing fluid having the composition to be made in and supplied from the FFBS.

41. The method of claim 40, wherein step (XIV) comprises:
(XIVa) sending, by the first processor, a seventh communication to the sixth processor;
(XIVb) causing, by the sixth processor, the fracturing fluid having the composition to be made in and supplied from the FFBS.

42. The method of claim 41, wherein the seventh communication comprises one or more of:
type(s) of proppant particulates;
amount(s) and/or concentration(s) of proppant particulates;
amount(s) and/or concentration(s) of chemical additives;
timing of making the fracturing fluid; and
timing of supplying the fracturing fluid.

43. The method of claim 42, wherein at least two differing types of proppant particulates are used in the hydraulic fracturing operation performed via the one or more wells.

44. The method of claim 43, wherein both sand proppant particulates and LWP particulates are used.

45. The method of claim 44, wherein the LWP particulates comprises petroleum coke proppant particulates.

46. The method of claim 41, wherein the HFS further comprises a proppant particulate retrieval sub-system (“PPRS”), and the method further comprises:
(XV) determining, by the first processor, a type and quantity of proppant particulates to be supplied to the FFBS; and
(XVI) causing, by the first processor, the PPRS to supply the proppant particulates at the quantity to the FFBS.

47. The method of claim 46, wherein the PPRS comprises a seventh processor, and step (XVI) comprises:
(XVIa) sending, by the first processor, an eighth communication to the seventh processor;
(XVIb) causing, by the seventh processor, the proppant particulates at the quantity to be supplied to the FFBS.

48. The method of claim 3, wherein the HFS further comprises one or more fluid cycling conduits each cycling and supplying a fluid to the one or more pumps.

49. The method of claim 37, wherein during step (XII), no more than ten sleeves among the plurality of sleeves receiving the fracturing fluid in the designated well are in open position, permitting the fracturing fluid to be injected into the subsurface formation through exposed injection ports therein.

50. The method of claim 49, wherein only one sleeve among the plurality of sleeves in the designated well receiving the fracturing fluid is in open position, permitting the fracturing fluid to be injected into the subsurface formation through the exposed injection port.

51. The method of claim 1, wherein in step (I), two or more wells are provided, and the automated hydraulic fracturing is performed to the two or more wells simultaneously.

52. The method of claim 51, wherein the first processor in step (II) controls the automated hydraulic fracturing of the two or more wells.

53. The method of claim 47, wherein at least two of the IDDS, the IDRS, the WASS, the PMSS, the FFBS, and the PPRS are operated by different service providers.

54. The method of claim 53, wherein at least two of the first processor, the second processor, the third processor, the fourth processor, the fifth processor, the sixth processor, and the seventh processor are separate from each other.

55. The method of claim 54, wherein the first processor controls the second processor, the third processor, the fourth processor, the fifth processor, the sixth processor, and the seventh processor.

56. A method for performing automated hydraulic fracturing operation(s) to a subsurface formation, the method comprising:
(I) providing one or more wells in the subsurface formation, each well comprising a plurality of sleeves;
(II) providing a hydraulic fracturing system (“HFS”) comprising a first processor;
(III) after step (II), causing, by the first processor, a first pressure barrier device associated with a designated well among the one or more wells to open to allow loading of an isolation device into a pressure equalization chamber associated with the designated well;
(III.2) after step (III), detecting, by a sensor associated with the pressure equalization chamber, the presence of the isolation device; and
(IV) after step (III.2), causing, by the first processor, a second pressure barrier device associated with the designated well to open to launch the isolation device into the designated well.

57. The method of claim 56, wherein the sensor associated with the pressure equalization chamber employs magnetic sensor technology, laser adapted sensor technology, radioactive marker technology, mechanical technology, acoustic sensor technology, radio frequency sensor, optical sensor, or combinations thereof to detect the presence of the isolation device.

58. The method of claim 56, further comprising, after step (III) and before step (III.2), causing, by the first processor, the first pressure barrier device to close and sealing the pressure equalization chamber.

59. The method of claim 56, further comprising, after step (III.2) and before step (IV), equalizing a pressure in the pressure equalization chamber with a pressure in the wellhead below the second pressure barrier device.

60. A method for performing automated hydraulic fracturing operation(s) to a subsurface formation, the method comprising:
(I) providing one or more wells in the subsurface formation, each well comprising a plurality of sleeves;
(II) providing a hydraulic fracturing system (“HFS”) comprising a first processor;
(III) providing an isolation device designated for a target sleeve among the plurality of sleeves in a designated well among the one or more wells to a launch location in proximity to a wellhead of the designated well;
(IV) after step (III), causing, by the first processor, a first pressure barrier device associated with the designated well to open to allow loading of the isolation device into a pressure equalization chamber associated with the designated well;
(IV.1) after step (IV), causing, by the first processor, the first pressure barrier device associated with the designated well to close, while maintaining a second pressure barrier device downhole of the pressure equalization chamber in closed position;
(IV.2) equalizing a pressure in the pressure equalization chamber with a pressure in the wellhead below the second pressure barrier device;
(V) after step (IV.2), causing, by the first processor, the second pressure barrier device in the wellhead associated with the designated well to open to launch the isolation device into the designated well.

61. The method of claim 60, further comprising:
(VI) after step (V), causing, by the first processor, one or more pumps to pump a fluid into the wellhead after the isolation device, thereby conveying the isolation device to the target sleeve in the designated well, and temporarily decreasing a flow rate and/or a pressure of the fluid when the isolation device is in proximity to the target sleeve to facilitate engagement of the isolation device with the target sleeve.

62. The method of claim 60, further comprising, after step (IV.1) and before step (IV.2), detecting, by a sensor associated with the pressure equalization chamber, the presence of the isolation device in the pressure equalization chamber, wherein the sensor employs magnetic sensor technology, laser adapted sensor technology, radioactive marker technology, mechanical technology, acoustic sensor technology, radio frequency sensor, optical sensor, or combinations thereof.

63. The method of claim 60, wherein the isolation device is programmed to pair with the target sleeve before arriving at the wellhead, at the wellhead, or after entering the wellhead, and wherein the programming comprises specifying the target sleeve to be paired with the isolation device.

64. A method for performing hydraulic fracturing operation(s) to a subsurface formation via a well comprising a vertical segment, a heel downhole of the vertical segment, and a lateral segment downhole of the heel, the lateral segment comprising a plurality of sleeves, the method comprising:
(A) launching an isolation device into a wellhead of the well;
(B) after step (A), pumping a fluid into the wellhead at a first flow rate (“Rf-1”), thereby carrying the isolation device downhole through the vertical segment;
(C) after the isolation device passes the heel, pumping the fluid into the wellhead at a second flow rate (“Rf-2”);
(D) when the isolation device approaches a target sleeve among the plurality of sleeves, pumping the fluid into the wellhead at a third flow rate (“Rf-3”), wherein Rf-3≤Rf-2; and
(E) engaging the isolation device with the target sleeve.

65. The method of claim 64, wherein Rf-2≤Rf-1.

66. The method of claim 65, further comprising, between step (B) and step (C):
(Ba) determining, by a first processor, a first timing (“T1”) of the isolation device passing the heel; and
(Bb) causing, by the first processor, a pump management sub-system (“PMSS”) to reduce a flow rate of the fluid prior to T1 at a first ramp rate until Rf-2 is reached at about T1.

67. The method of claim 66, further comprising between step (C) and step (D):
(Ca) determining a second timing (“T2”), by the first processor, of the isolation device approaching the target sleeve; and
(Cb) causing, by the first processor, the pump management sub-system to reduce a flow rate of the fluid prior to T2 at a second ramp rate until Rf-3 is reached at T2.

68. The method of claim 64, further comprising:
(A-1) before step (A), programming the isolation device for engaging with the target sleeve.

69. The method of claim 68, wherein programming the isolation device in step (A-1) is caused by a processor.

70. The method of claim 68, further comprising:
(F) counting the sleeves the isolation device passes, by the isolation device, as the isolation device traverses through the lateral segment.

71. The method of claim 70, further comprising:
(G) shifting the target sleeve from a closed position to an open position, thereby exposing an injection port in the target sleeve; and
(H) pumping a fracturing fluid into the wellhead through the well and through the injection port into the subsurface formation, thereby creating fractures in the subsurface formation.

72. The method of claim 71, wherein (H) comprises pumping the fracturing fluid at a fourth flow rate (“Rf-4”), wherein Rf-4>Rf-3.

73. The method of claim 71, wherein the method further comprises, between step (G) and step (H):
(Ga) determining, by a processor, a fracture has been initiated in the subsurface formation; and
(Gb) after step (Ga), causing, by the processor, a pump management sub-system to increase a flow rate of the fracturing fluid at a third ramp rate until Rf-4 is reached.

74. The method of claim 64, further comprising:
(I) during the course of step (A), pumping the fluid into the wellhead at a fifth flow rate (“Rf-5”), wherein Rf-5≤Rf-1.

75. The method of claim 74, further comprising, before step (A):
(Za) determining a fifth timing (“T5”), by a processor, of the isolation device entering into the wellhead;
(Zb) causing, by the processor, a pump management sub-system (“PMSS”) to decrease a flow rate of the fluid at a fourth ramp rate until Rf-5 is reached.

76. The method of claim 68, wherein a first total time (“TT-1”) for performing all steps (A-1), (A), (B), (C), (D), and (E) is no more than 60 minutes.

77. The method of claim 76, wherein TT-1 is no more than 30 minutes.

78. The method of claim 71, wherein a second total time (“TT-2”) for performing all steps (A-1), (A), (B), (C), (D), (E), (F) and (G) is no more than 60 minutes.

79. The method of claim 78, wherein TT-2 is no more than 30 minutes.

80. A method for autonomously hydraulically fracturing a subsurface formation, comprising:
causing, by one or more processors, an isolation device to be retrieved and to be configured for a designated sleeve;
causing, by the one or more processors, the isolation device to be launched into a well;
receiving, by the one or more processors, real-time data from one or more sensors;
dynamically determining, by the one or more processors, whether the real-time data fall outside of one or more thresholds; and
responsive to determining that the real-time data fall outside of the one or more thresholds, dynamically changing, by the one or more processors, a ramp-rate of one or more pumps.
